(19) United States
(12) Patent Application Publication
(10) Pub. No.: US 2013/0259254 A1
(43) Pub. Date: Oct. 3, 2013

(54) SYSTEMS, METHODS, AND APPARATUS FOR PRODUCING A DIRECTIONAL SOUND FIELD

(71) Applicant: QUALCOMM INCORPORATED, San Diego, CA (US)

(72) Inventors: Pei Xiang, San Diego, CA (US); Lae-Hoon Kim, San Diego, CA (US); Erik Visser, San Diego, CA (US)

(73) Assignee: Qualcomm Incorporated, San Diego, CA (US)

(21) Appl. No.: 13/740,658

(22) Filed: Jan. 14, 2013

Related U.S. Application Data
(60) Provisional application No. 61/616,836, filed on Mar. 28, 2012.
(60) Provisional application No. 61/619,202, filed on Apr. 2, 2012.
(60) Provisional application No. 61/666,196, filed on Jun. 29, 2012.
(60) Provisional application No. 61/741,782, filed on Oct. 31, 2012.
(60) Provisional application No. 61/733,696, filed on Dec. 5, 2012.

(51) Int. Cl. G10K 11/175

(52) U.S. Cl. CPC G10K 11/175
USPC 381/73.1

(57) ABSTRACT

A system may be used to drive an array of loudspeakers to produce a sound field that includes a source component, whose energy is concentrated along a first direction relative to the array, and a masking component that is based on an estimated intensity of the source component in a second direction that is different from the first direction.

### CLAIM OF PRIORITY UNDER 35 U.S.C. §119

The present application for patent claims priority to Provisional Application No. 61/616,836, entitled “SYSTEMS, METHODS, AND APPARATUS FOR PRODUCING A DIRECTIONAL SOUND FIELD,” filed Mar. 28, 2012, and assigned to the assignee hereof. The present application for patent claims priority to Provisional Application No. 61/619,202, entitled “SYSTEMS, METHODS, APPARATUS, AND COMPUTER-READABLE MEDIA FOR GESTURAL MANIPULATION OF A SOUND FIELD,” filed Apr. 2, 2012, and assigned to the assignee hereof. The present application for patent claims priority to Provisional Application No. 61/666,196, entitled “SYSTEMS, METHODS, APPARATUS, AND COMPUTER-READABLE MEDIA FOR GENERATING CORRELATED MASKING SIGNAL,” filed Jun. 29, 2012, and assigned to the assignee hereof. The present application for patent claims priority to Provisional Application No. 61/741,782, entitled “SYSTEMS, METHODS, AND APPARATUS FOR PRODUCING A DIRECTIONAL SOUND FIELD,” filed Oct. 31, 2012, and assigned to the assignee hereof. The present application for patent claims priority to Provisional Application No. 61/733,696, entitled “SYSTEMS, METHODS, AND APPARATUS FOR PRODUCING A DIRECTIONAL SOUND FIELD,” filed Dec. 5, 2012, and assigned to the assignee hereof.

### BACKGROUND

1. Field

This disclosure is related to audio signal processing.

2. Background

An existing approach to audio masking applies the fundamental concept that a tone can mask other tones that are at nearby frequencies and are below a certain relative level. With a high enough level, a white noise signal may be used to mask speech, and such a sound masking design may be used to support secure conversations in offices.

Other approaches to restricting the area within which a sound may be heard include ultrasonic loudspeakers, which require different fundamental hardware designs; headphones, which provide no freedom if the user desires ventilation at his or her head, and general sound maskers as may be used in a national security office, which typically involve large-scale fixed construction.

### SUMMARY

A method of signal processing according to a general configuration includes determining a frequency profile of a source signal. This method also includes, based on said frequency profile of the source signal, producing a masking signal according to a masking frequency profile, wherein the masking frequency profile is different than the frequency profile of the source signal. This method also includes producing a sound field comprising (A) a source component that is based on the source signal and (B) a masking component that is based on the masking signal. Computer-readable storage media (e.g., non-transitory media) having tangible features that cause a machine reading the features to perform such a method are also disclosed.

An apparatus for signal processing according to a general configuration includes means for determining a frequency profile of a source signal. This apparatus also includes means for producing a masking signal, based on said frequency profile of the source signal, according to a masking frequency profile, wherein the masking frequency profile is different than the frequency profile of the source signal. This apparatus also includes means for producing the sound field comprising (A) a source component that is based on the source signal and (B) a masking component that is based on the masking signal.

An apparatus for signal processing according to another general configuration includes a signal analyzer configured to determine a frequency profile of a source signal. This apparatus also includes a signal generator configured to produce a masking signal, based on said frequency profile of the source signal, according to a masking frequency profile, wherein the masking frequency profile is different than the frequency profile of the source signal. This apparatus also includes an audio output stage configured to drive an array of loudspeakers to produce the sound field, wherein the sound field comprises (A) a source component that is based on the source signal and (B) a masking component that is based on the masking signal.

### BRIEF DESCRIPTION OF THE DRAWINGS

FIG. 1 shows an example of a privacy zone generated by a device having a loudspeaker array.

FIG. 2 shows an example of an excessive masking level.

FIG. 3 shows an example of an insufficient masking level.

FIG. 4 shows an example of an appropriate level of the masking field.

FIG. 5A shows a flowchart of a method of signal processing M100 according to a general configuration.

FIG. 5B shows an application of method M100.

FIG. 6 illustrates an application of an implementation M102 of method M100.

FIG. 7 shows a flowchart of an implementation T110 of task T102.

FIGS. 8A, 8B, 9A, and 9B show examples of a beam pattern of a DSB filter for a four-element array for four different orientation angles.

FIGS. 10A and 10B show examples of beam patterns for weighted modifications of the DSB filters of FIGS. 9A and 9B, respectively.

FIGS. 11A and 11B show examples of a beam pattern of a DSB filter for an eight-element array, in which the orientation angle of the filter is thirty and sixty degrees, respectively.

FIGS. 12A and 12B show examples of beam patterns for weighted modifications of the DSB filters of FIGS. 11A and 11B, respectively.

FIGS. 13A and 13B show examples of schemes having three and five selectable fixed spatial sectors, respectively.

FIG. 13C shows a flowchart of an implementation M110 of method M100.

FIG. 13D shows a flowchart of an implementation M120 of method M100.

FIG. 14 shows a flowchart of an implementation T214 of tasks T202 and T210.

FIG. 15A shows examples of beam patterns of DSB filters for driving a four-element array to produce a source component and a masking component.

FIG. 15B shows examples of beam patterns of DSB filters for driving a four-element array to produce a source component and a masking component.

FIGS. 16A and 16B show results of subtracting the beam patterns of FIG. 15A from each other.

FIGS. 17A and 17B show results of subtracting the beam patterns of FIG. 15B from each other.

FIG. 18A shows examples of beam patterns of DSB filters for driving a four-element array to produce a source component and a masking component.

FIG. 18B shows examples of beam patterns of DSB filters for driving a four-element array to produce a source component and a masking component.

FIG. 19A shows a flowchart of an implementation T220A of tasks T210 and T220.

FIG. 19B shows a flowchart of an implementation T220B of task T220A.

FIG. 19C shows a flowchart of an implementation T220C of task T220B.

FIG. 20A shows a flowchart of an implementation TA200A of task TA200.

FIG. 20B shows an example of a procedure of direct measurement of intensity of a source component.

FIG. 21 shows a flowchart of an implementation M130 of method M100, and an application of method M130.

FIG. 22 shows a normalized frequency response for one example of a set of seven biquad filters.

FIG. 23A shows a flowchart of an implementation T230A of tasks T210 and T230.

FIG. 23B shows a flowchart of an implementation TC200A of task T200.

FIG. 23C shows a flowchart of an implementation T230B of task T230A.

FIG. 24 shows an example of a plot of estimated intensity of the source component in a non-source direction with respect to frequency.

FIGS. 25 and 26 show two examples of modified masking target levels for a four-subband configuration.

FIG. 27 shows an example of a cascade of three biquad peaking filters.

FIG. 28A shows an example of a map of estimated intensity.

FIG. 28B shows one example of a table of masking target levels.

FIG. 29 shows an example of a plot of estimated intensity of the source component for a subband.

FIG. 30 shows a use case in which a loudspeaker array provides several programs to different listeners simultaneously.

FIG. 31 shows a spatial distribution of beam patterns for two different users and for a masking signal.

FIG. 32 shows an example of a combination of beam patterns for two different users with a pattern for the masking signal.

FIG. 33A shows a top view of a misaligned arrangement of a sensing array of microphones and an emitting array of loudspeakers.

FIG. 33B shows a flowchart of an implementation M140 of method M100.

FIG. 33C shows an example of a multi-sensory reciprocal arrangement of transducers.

FIG. 34A shows an example of a 1-D beamforming-nullforming system that is based on 1-D direction-of-arrival estimation.

FIG. 34B shows a normalization of the example of FIG. 34A.

FIG. 35A shows a nonlinear array of three microphones.

FIG. 35B shows an example of a pair-wise normalized minimum-variance distortionless-response beamformer/nullformer.

FIG. 36 shows another example of a 1-D beamforming-nullforming system.

FIG. 37 shows a typical use scenario.

FIGS. 38 and 39 show use scenarios of a system for generating privacy zones for two and three users, respectively.

FIG. 40A shows a block diagram of an apparatus for signal processing MF100 according to a general configuration.

FIG. 40B shows a block diagram of an implementation MF102 of apparatus MF100.

FIG. 40C shows a block diagram of an implementation MF130 of apparatus MF100.

FIG. 40D shows a block diagram of an implementation MF140 of apparatus MF100.

FIG. 41A shows a block diagram of an apparatus for signal processing A100 according to a general configuration.

FIG. 41B shows a block diagram of an implementation A102 of apparatus A100.

FIG. 41C shows a block diagram of an implementation A130 of apparatus A100.

FIG. 41D shows a block diagram of an implementation A140 of apparatus A100.

FIG. 42A shows a block diagram of an implementation A130A of apparatus A130.

FIG. 42B shows a block diagram of an implementation 230B of masking signal generator 230.

FIG. 42C shows a block diagram of an implementation A130B of apparatus A130A.

FIG. 43A shows an audio preprocessing stage AP10.

FIG. 43B shows a block diagram of an implementation AP20 of audio preprocessing stage AP10.

FIG. 44A shows an example of a cone-type loudspeaker.

FIG. 44B shows an example of a rectangular loudspeaker.

FIG. 44C shows an example of an array of twelve loudspeakers.

FIG. 44D shows an example of an array of twelve loudspeakers.

FIGS. 45A-45D show examples of loudspeaker arrays.

FIG. 46A shows a display device TV10.

FIG. 46B shows a display device TV20.

FIG. 46C shows a front view of a laptop computer D710.

FIGS. 47A and 47B show top views of examples of loudspeaker arrays for directional masking in left-right and front-back directions.

FIGS. 47C and 48 show front views of examples of loudspeaker arrays for directional masking in left-right and up-down directions.

FIG. 49 shows an example of a frequency spectrum of a music signal before and after PBE processing.

### DETAILED DESCRIPTION

In monophonic signal masking, a single-channel masking signal drives a loudspeaker to produce the masking field. Descriptions of such masking may be found, for example, in U.S. patent application Ser. No. 13/155,187, filed Jun. 7, 2011, entitled “GENERATING A MASKING SIGNAL ON AN ELECTRONIC DEVICE.” When the intensity of such a masking field is high enough to effectively interfere with a potential eavesdropper, the masking field may also be distracting to the user and/or may be unnecessarily loud to bystanders.

When more than one loudspeaker is available to produce the masking field, the spatial pattern of the emitted sound can be designed and controlled. A loudspeaker array may be used to steer beams with different characteristics in various directions of emission and/or to create a personal surround-sound bubble. By combining different audio contents that are beamed in different directions, we can create a private listening zone, in which the communication channel beam is targeted towards the user, and target noise or masking beams to other directions to mask and obscure the communication channel.

While such a method may be used to preserve the user's privacy, the masking signals are usually unwanted sound pollution with respect to bystanders in the surrounding environment. Masking principles may be applied as disclosed herein to generate a masker having the most efficient and minimum level needed, according to spatial location and source signal contents. Such principles may be used to implement an automatically controlled system that uses information about the spatial environment to generate masking signals with a reduced level of sound pollution to the environment.

Unless expressly limited by its context, the term “signal” is used herein to indicate any of its ordinary meanings, including a state of a memory location (or set of memory locations) as expressed on a wire, bus, or other transmission medium. Unless expressly limited by its context, the term “generating” is used herein to indicate any of its ordinary meanings, such as computing or otherwise producing. Unless expressly limited by its context, the term “calculating” is used herein to indicate any of its ordinary meanings, such as computing, evaluating, estimating, and/or selecting from a plurality of values. Unless expressly limited by its context, the term “obtaining” is used to indicate any of its ordinary meanings, such as calculating, deriving, receiving (e.g., from an external device), and/or retrieving (e.g., from an array of storage elements). Unless expressly limited by its context, the term “selecting” is used to indicate any of its ordinary meanings, such as identifying, indicating, applying, and/or using at least one, and fewer than all, of a set of two or more. Unless expressly limited by its context, the term “determining” is used to indicate any of its ordinary meanings, such as deciding, establishing, concluding, calculating, selecting, and/or evaluating. Where the term “comprising” is used in the present description and claims, it does not exclude other elements or operations. The term “based on” (as in “A is based on B”) is used to indicate any of its ordinary meanings, including the cases (i) “derived from” (e.g., “B is a precursor of A”), (ii) “based on at least” (e.g., “A is based on at least B”) and, if appropriate in the particular context, (iii) “equal to” (e.g., “A is equal to B”). Similarly, the term “in response to” is used to indicate any of its ordinary meanings, including “in response to at least.”

References to a “location” of a microphone of a multi-microphone audio sensing device indicate the location of the center of an acoustically sensitive face of the microphone, unless otherwise indicated by the context. The term “channel” is used at times to indicate a signal path and at other times to indicate a signal carried by such a path, according to the particular context. Unless otherwise indicated, the term “series” is used to indicate a sequence of two or more items. The term “logarithm” is used to indicate the base-ten logarithm, although extensions of such an operation to other bases are within the scope of this disclosure. The term “frequency component” is used to indicate one among a set of frequencies or frequency bands of a signal, such as a sample of a frequency domain representation of the signal (e.g., as produced by a fast Fourier transform) or a subband of the signal (e.g., a Bark scale or mel scale subband).

Unless indicated otherwise, any disclosure of an operation of an apparatus having a particular feature is also expressly intended to disclose a method having an analogous feature (and vice versa), and any disclosure of an operation of an apparatus according to a particular configuration is also expressly intended to disclose a method according to an analogous configuration (and vice versa). The term “configuration” may be used in reference to a method, apparatus, and/or system as indicated by its particular context. The terms “method,” “process,” “procedure,” and “technique” are used generically and interchangeably unless otherwise indicated by the particular context. A “task” having multiple subtasks is also a method. The terms “apparatus” and “device” are also used generically and interchangeably unless otherwise indicated by the particular context. The terms “element” and “module” are typically used to indicate a portion of a greater configuration. Unless expressly limited by its context, the term “system” is used herein to indicate any of its ordinary meanings, including “a group of elements that interact to serve a common purpose.” The term “plurality” means “two or more.” Any incorporation by reference of a portion of a document shall also be understood to incorporate definitions of terms or variables that are referenced within the portion, where such definitions appear elsewhere in the document, as well as any figures referenced in the incorporated portion.

It may be assumed that in the near-field and far-field regions of an emitted sound field, the wavefronts are spherical and planar, respectively. The near-field may be defined as that region of space which is less than one wavelength away from a sound emitter (e.g., a loudspeaker array). Under this definition, the distance to the boundary of the region varies inversely with frequency. At frequencies of two hundred, seven hundred, and two thousand hertz, for example, the distance to a one-wavelength boundary is about 170, forty-nine, and seventeen centimeters, respectively. It may be useful instead to consider the near-field/far-field boundary to be at a particular distance from the sound emitter (e.g., fifty centimeters from a loudspeaker of the array or from the centroid of the array, or one meter or 1.5 meters from a loudspeaker of the array or from the centroid of the array). Unless otherwise indicated by the particular context, a far-field approximation is assumed herein.

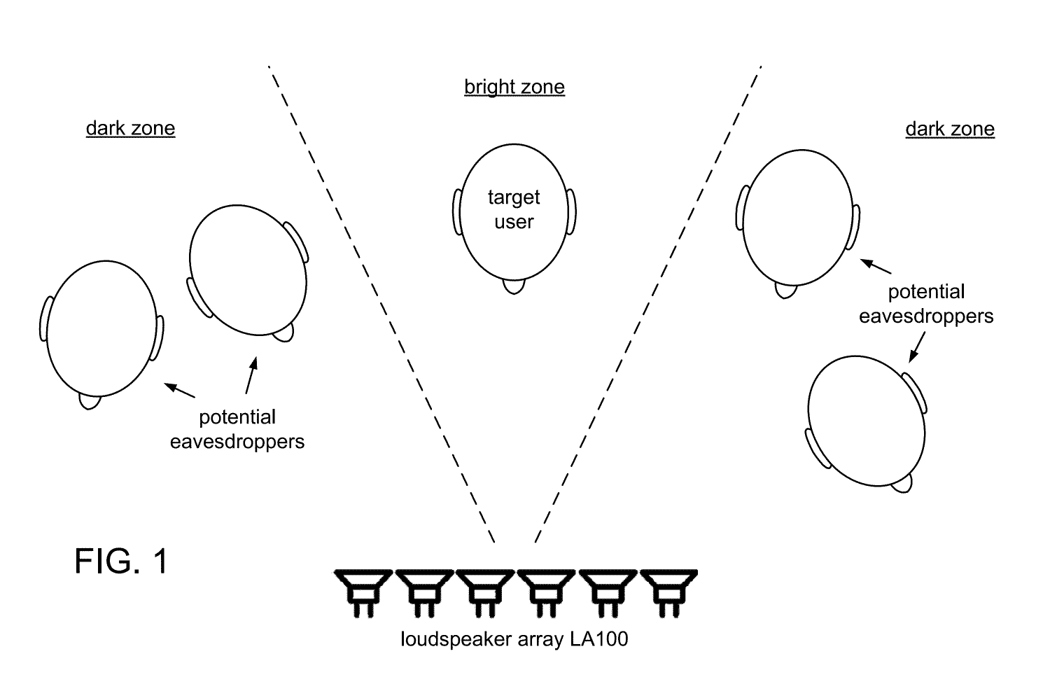

FIG. 1 shows an example of multichannel signal masking in which a device having a loudspeaker array (i.e., an array of two or more loudspeakers) generates a sound field that includes a privacy zone. This example shows the privacy zone as a “bright zone” around the target user where the main communication channel sound (the “source component” of the sound field) is readily audible, while other people (e.g., potential eavesdroppers) are in the “dark zone” where the communication channel sound is weak and is accompanied by a masking component of the sound field. Examples of such a device include a television set, computer monitor, or other video display device coupled with or even incorporating a loudspeaker array; a computer system configured for multimedia playback; and a portable computer (e.g., a laptop or tablet).

A problem may arise when the loudspeaker array is used in a public area, where people in the dark zone may not be eavesdroppers, but rather normal bystanders who do not wish to experience unwanted sound pollution. It may be desirable to provide a system that can achieve good privacy protection for the user and minimal sound pollution to the public at the same time.

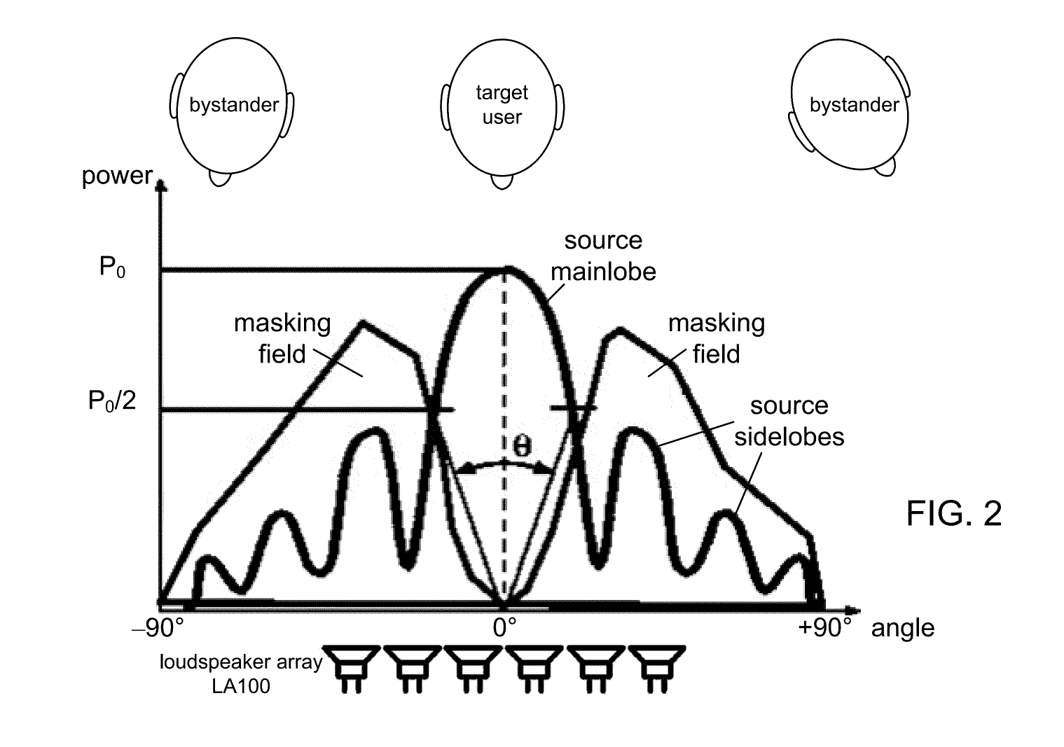

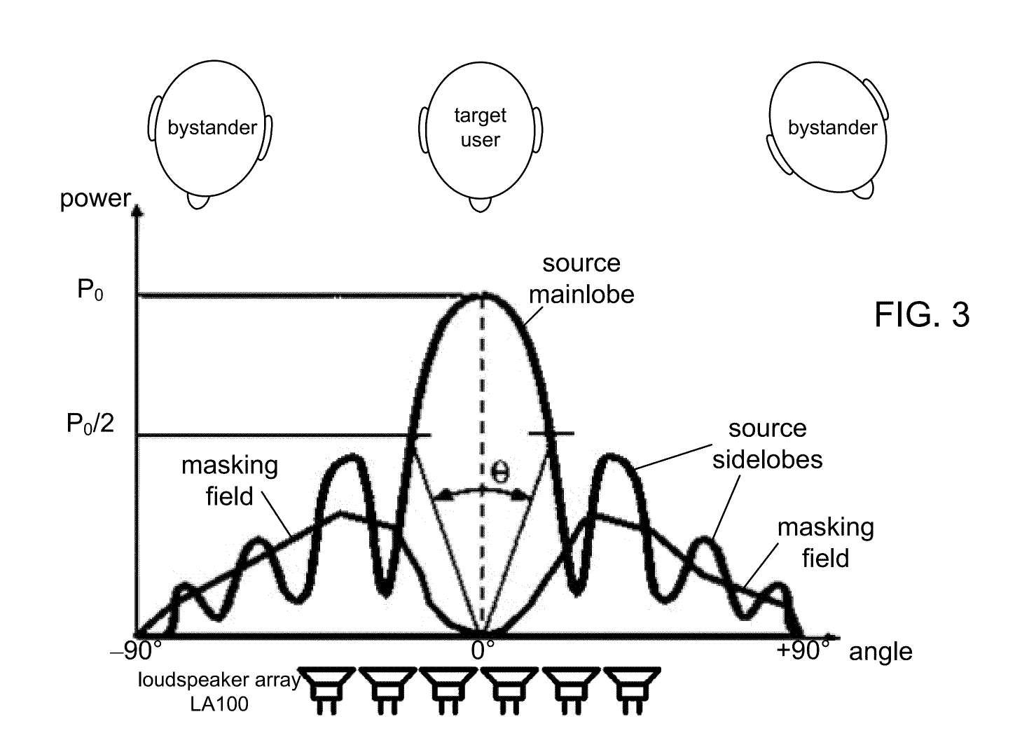

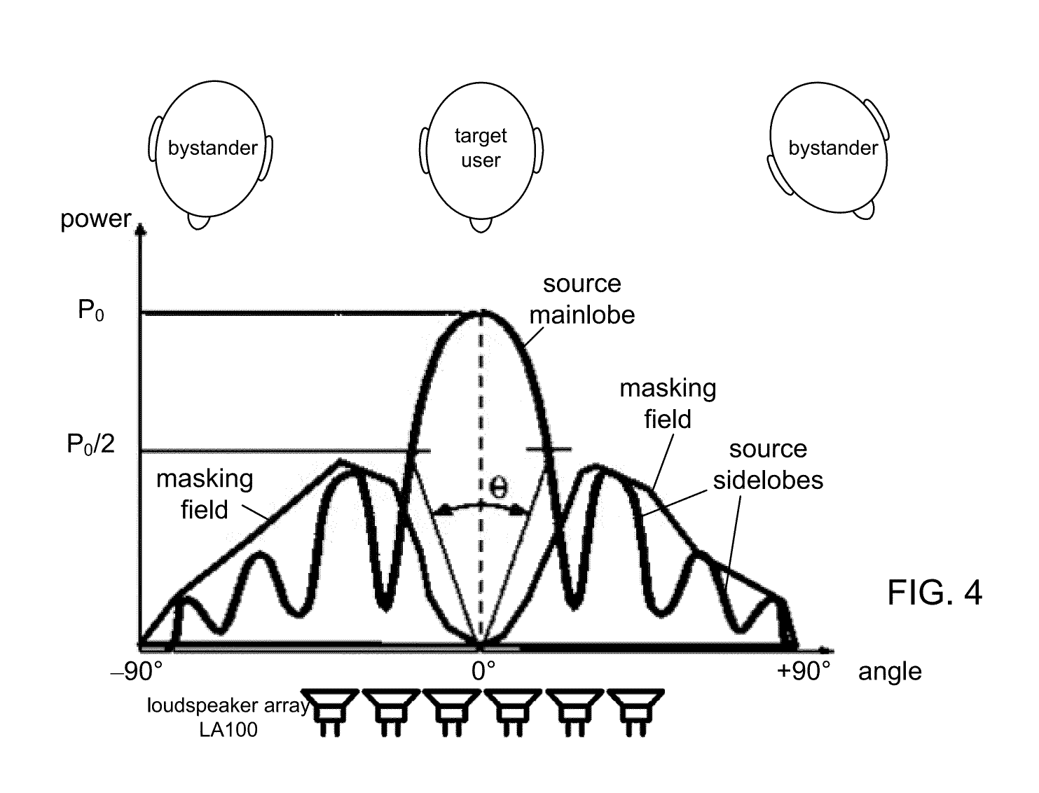

FIG. 2 shows an example of an excessive masking level, in which the power level of the masking component is greater than the power level of the sidelobes of the source component. Such an imbalance may cause unnecessary sound pollution to nearby people. FIG. 3 shows an example of an insufficient masking power level, in which the power level of the masking component is lower than the power level of the sidelobes of the source component. Such an imbalance may cause the main signal to be intelligible to nearby persons. FIG. 4 shows an example of an appropriate power level of the masking component, in which the power level of the masking signal is matched to the power level of the sidelobes of the source component. Such level matching effectively masks the sidelobes of the source component without causing excessive sound pollution.

The effectiveness of an audio masking signal may be dependent on factors such as signal intensity, frequency, and/or content as well as psychoacoustic factors. A critical masking condition is typically a function of several (and possibly all) of these factors. For simplicity in explanation, FIGS. 2-4 use matched power between source and masker to indicate critical masking, less masker power than source power to indicate insufficient masking, and more masker power than source power to indicate excessive masking. In practice, it may be desirable to consider additional factors with respect to the source and masker signals as well, rather than just power.

As noted above, it may be desirable to operate an apparatus to create a privacy zone using spatial patterns of components of a sound field. Such an apparatus may be implemented to include systems for design and control of a masking component of a combined sound field. Design procedures for such a masker are described herein, as well as combinations of reciprocal beam-and-nullforming and masker design for an interactive in-situ privacy zone. Extensions to multiple-user cases are also disclosed. Such principles may be applied to obtain a new system design that advances data fusion capabilities, provides better performance than a single-loudspeaker version of a masking system, and/or takes into consideration both signal contents and spatial response.

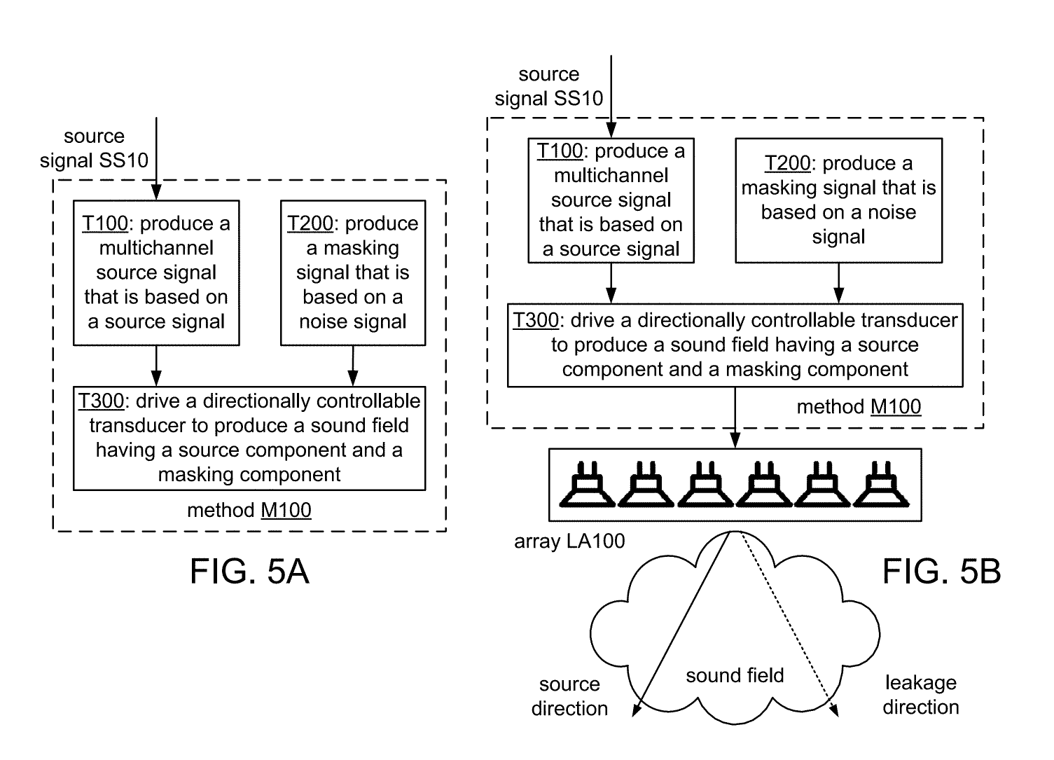

FIG. 5A shows a flowchart of a method of signal processing M100 according to a general configuration that includes tasks T100, T200, and T300. Task T100 produces a first multichannel signal (a “multichannel source signal”) that is based on a source signal. Task T200 produces a second multichannel signal (a “masking signal”) that is based on a noise signal. Task T300 drives a directionally controllable transducer to produce a sound field to include a source component that is based on the multichannel source signal and a masking component that is based on the masking signal. The source component has an intensity (e.g., magnitude or energy) which is higher in a source direction relative to the array than in a leakage direction relative to the array that is different than the source direction. A directionally controllable transducer is defined as an element or array of elements (e.g., an array of loudspeakers) that is configured to produce a sound field whose intensity with respect to direction is controllable. Task T200 produces the masking signal based on an estimated intensity of the source component in the leakage direction. FIG. 5B illustrates an application of method M100 to produce the sound field by driving a loudspeaker array LA100.

Directed source components may be combined with masker design for interactive in-situ privacy zone creation. If only one privacy zone is needed (e.g., for a single-user case), then method M100 may be configured to combine beamforming of the source signal with a spatial masker. If more than one privacy zone is desired (e.g., for a multiple-user case), then method M100 may be configured to combine beamforming and nullforming of each source signal with a spatial masker.

It is typical for each channel of the multichannel source signal to be associated with a corresponding particular loudspeaker of the array. Likewise, it is typical for each channel of the masking signal to be associated with a corresponding particular loudspeaker of the array.

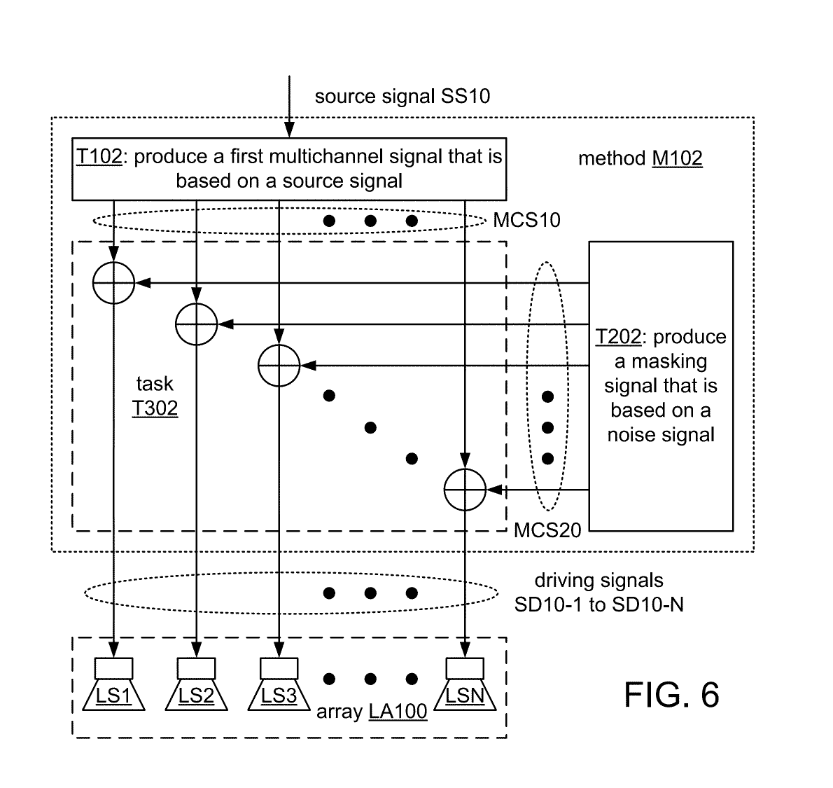

FIG. 6 illustrates an application of such an implementation M102 of method M100. In this example, an implementation T102 of task T100 produces an N-channel multichannel source signal MCS10 that is based on source signal SS10, and an implementation T202 of task T200 produces an N-channel masking signal MCS20 that is based on a noise signal. An implementation T302 of task T300 mixes respective pairs of channels of the two multichannel signals to produce a corresponding one of N driving signals SD10-1 to SD10-N for each loudspeaker LS1 to LSN of array LA100. It is also possible for signal MCS10 and/or signal MCS20 to have less than N channels. It is expressly noted that any of the implementations of method M100 described herein may be realized as implementations of M102 as well (i.e., such that task T100 is implemented to have at least the properties of task T102, and such that task T200 is implemented to have at least the properties of task T202).

It may be desirable to implement method M100 to produce the source component by inducing constructive interference in a desired direction of the produced sound field (e.g., in the first direction) while inducing destructive interference in other directions of the produced sound field (e.g., in the second direction). Such a technique may include implementing task T100 to produce the multichannel source signal by steering a beam in a desired source direction while creating a null (implicitly or explicitly) in another direction. A beam is defined as a concentration of energy along a particular direction relative to the emitter (e.g., the loudspeaker array), and a null is defined as a valley, along a particular direction relative to the emitter, in a spatial distribution of energy.

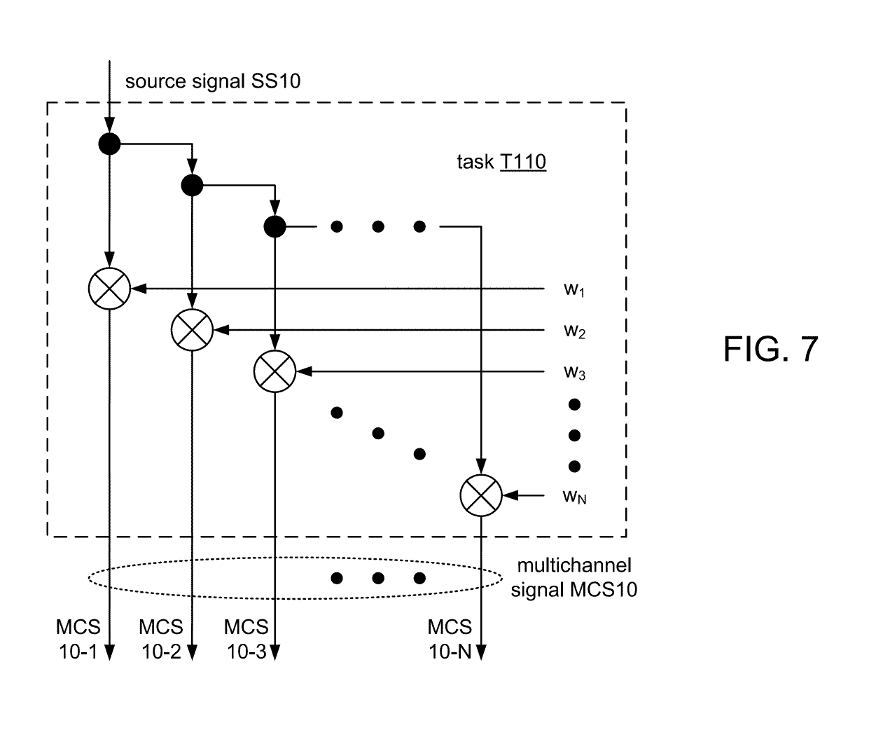

Task T100 may be implemented, for example, to produce the multichannel source signal by applying a spatially directive filter (the “source spatially directive filter”) to the source signal. By appropriately weighting and/or delaying the source signal to generate each channel of the multichannel source signal, such an implementation of task T100 may be used to obtain a desired spatial distribution of the source component within the produced sound field. FIG. 7 shows a diagram of a frequency-domain implementation T110 of task T102 that is configured to produce each channel MCS10-1 to MCS10-N of multichannel source signal MCS10 as a product of source signal SS10 and a corresponding one of the channels w₁ to w_{N} of the source spatially directive filter. Such multiplications may be performed serially (i.e., one after another) and/or in parallel (i.e., two or more at one time). In an equivalent time-domain implementation of task T102, the multipliers shown in FIG. 7 are implemented instead by convolution blocks.

Task T100 may be implemented according to a phased-array technique such that each channel of the multichannel source signal has a respective phase (i.e., time) delay. One example of such a technique is a delay-sum beamforming (DSB) filter. Task T100 may be implemented to perform a DSB filtering operation to direct the source component in a desired source direction by applying a respective time delay to the source signal to produce each channel of signal MCS10. For a case in which task T300 drives a uniformly spaced linear loudspeaker array, for example, task T110 may be implemented to perform a DSB filtering operation in the frequency domain by calculating the coefficients of channels w₁ to w_{N} of the source spatially directive filter according to the following expression:

$${w}_{n} ( f ) = exp ( - j \frac{2 π f}{c} ( n - 1 ) d cos {ϕ}_{s} ) \qquad ( 1 )$$

for 1≦n≦N, where d is the spacing between the centers of the radiating surfaces of adjacent loudspeakers in the array, N is the number of loudspeakers to be driven (which may be less than or equal to the number of loudspeakers in the array), f is a frequency bin index, c is the velocity of sound, and φₛ is the desired angle of the beam relative to the axis of the array (e.g., the desired source direction, or the desired direction of the main lobe of the source component). Equivalent time-domain implementations of channels w₁ to w_{N} may be implemented as corresponding delays. In either domain, task T100 may also include normalization of signal MCS10 by scaling each channel of signal MCS10 by a factor of 1/N (or, equivalently, scaling source signal SS10 by 1/N).

For a frequency f₁ at which the spacing d is equal to half of the wavelength λ (where λ=c/f₁), expression (1) reduces to the following expression:

wₙ(f₁)=exp(−jπ(n−1)cos φₛ). (2)

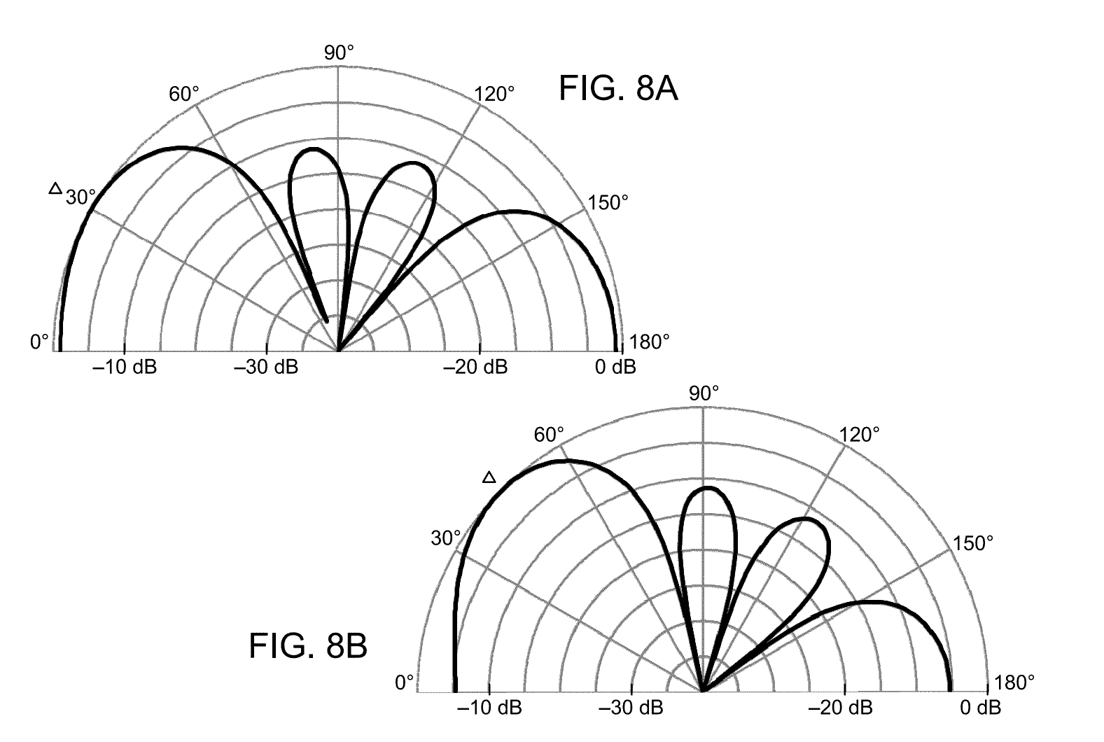

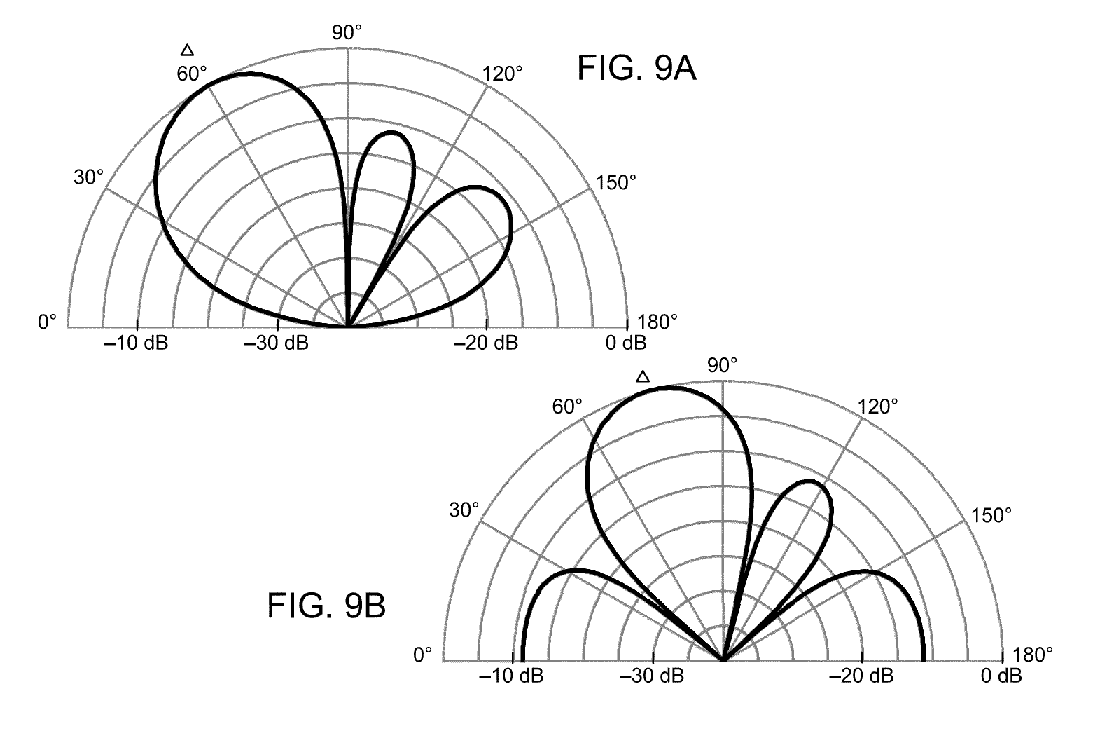

FIGS. 8A, 8B, 9A, and 9B show examples of the magnitude response with respect to direction (also called a beam pattern) of such a DSB filter at frequency f₁ for a four-element array, in which the orientation angle of the filter (i.e., angle φₛ, as indicated by the triangle in each figure) is thirty, forty-five, sixty, and seventy-five degrees, respectively.

It is noted that the filter beam patterns shown in FIGS. 8A, 8B, 9A, and 9B may differ at frequencies other than c/2d. To avoid spatial aliasing, it may be desirable to limit the maximum frequency of the source signal to c/2d (i.e., so that the spacing d is not more than half of the shortest wavelength of the signal). To direct a source component that includes high frequencies, it may be desirable to use a more closely spaced array.

It is also possible to implement method M100 to include multiple instances of task T100 such that subarrays of array LA100 are driven differently for different frequency ranges. Such an implementation may provide better directivity for wideband reproduction. In one example, a second instance of task T102 is implemented to produce an N/2-channel multichannel signal (e.g., using alternate ones of the filters w₁ to w_{N}) from a frequency band of the source signal that is limited to a maximum frequency of c/4d, and this multichannel signal is used to drive alternate loudspeakers of the array (i.e., a subarray that has an effective spacing of 2d).

It may be desirable to implement task T100 to apply different respective weights to channels of the multichannel source signal. For example, it may be desirable to implement task T100 to apply a spatial windowing function to the filter coefficients. Examples of such a windowing function include, without limitation, triangular and raised cosine (e.g., Hann or Hamming) windows. Use of a spatial windowing function tends to reduce both sidelobe magnitude and angular resolution (e.g., by widening the mainlobe).

In one example, task T100 is implemented such that the coefficients of each channel wₙ of the source spatially directive filter include a respective factor sₙ of a spatial windowing function. In such case, expressions (1) and (2) may be modified to the following expressions, respectively:

$$\begin{matrix}{w}_{n} ( f ) = {s}_{n} exp ( - j \frac{2 π f}{c} ( n - 1 ) d cos {ϕ}_{s} ) ; & ( 3 a ) \\ {w}_{n} ( {f}_{1} ) = {s}_{n} exp ( - j π ( n - 1 ) cos {ϕ}_{s} ) . & ( 3 b )\end{matrix}$$

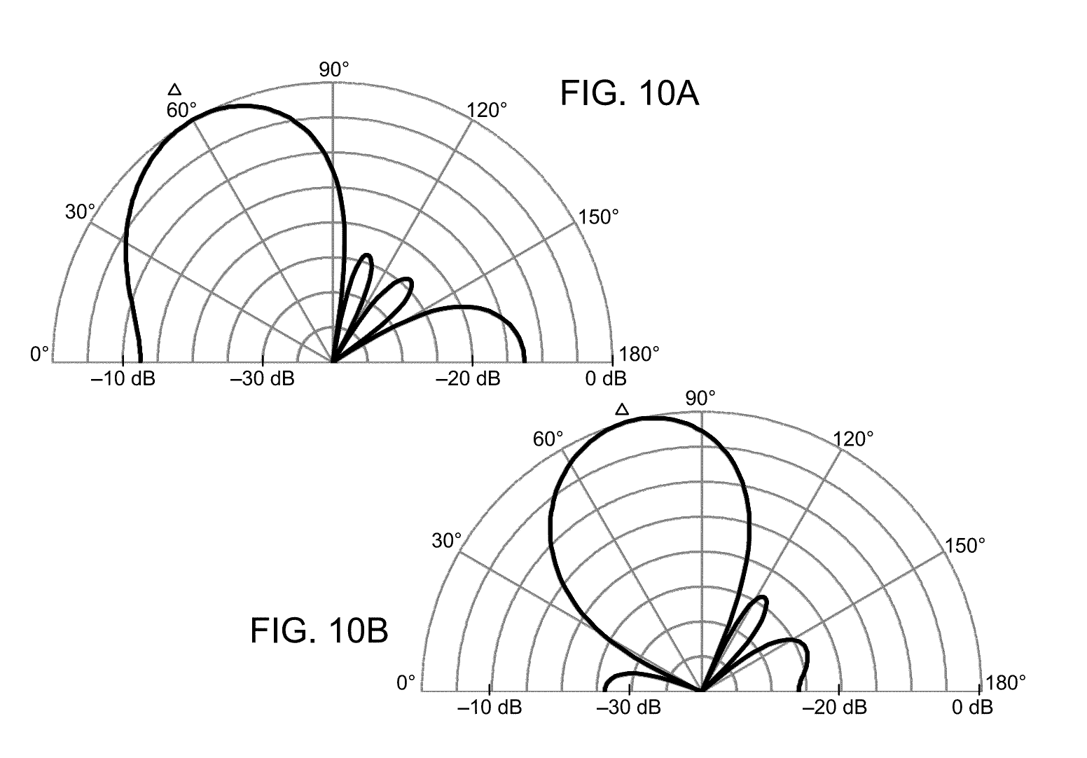

FIGS. 10A and 10B show examples of beam patterns at frequency f₁ for the four-element DSB filters of FIGS. 9A and 9B, respectively, according to such a modification in which the weights s₁ to s₄ have the values (2/3, 4/3, 4/3, 2/3), respectively.

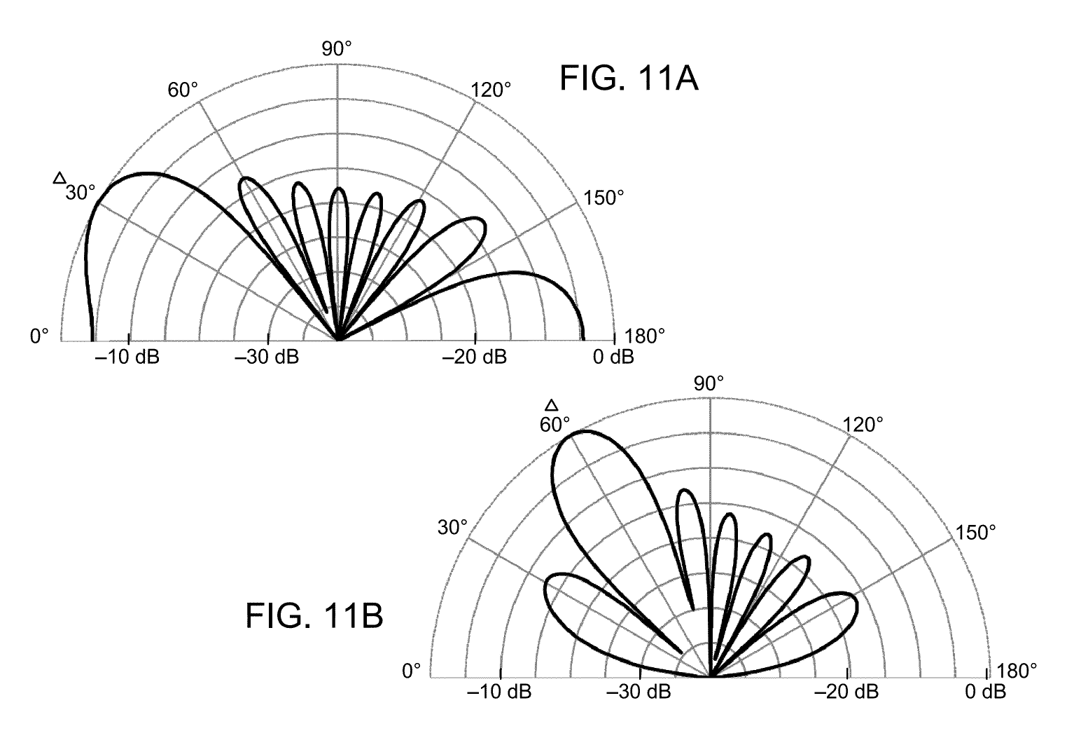

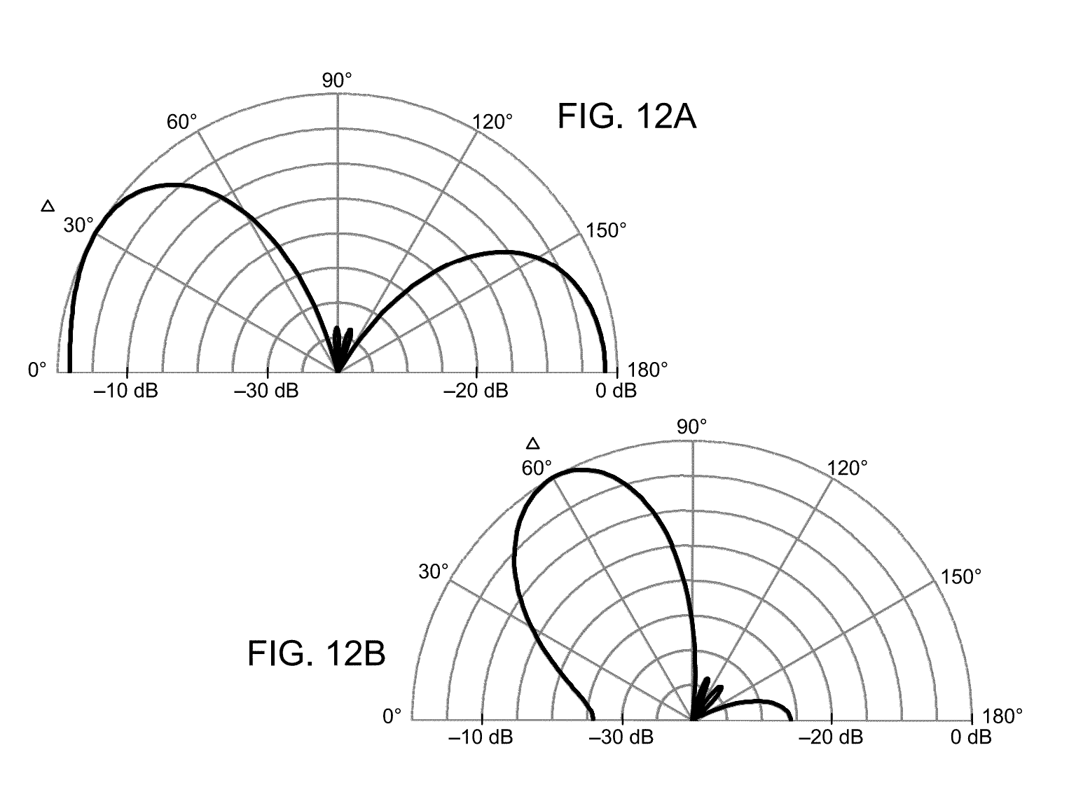

An array having more loudspeakers allows for more degrees of freedom and may typically be used to obtain a narrower mainlobe. FIGS. 11A and 11B show examples of a beam pattern of a DSB filter for an eight-element array, in which the orientation angle of the filter is thirty and sixty degrees, respectively. FIGS. 12A and 12B show examples of beam patterns for the eight-element DSB filters of FIGS. 11A and 11B, respectively, in which weights s₁ to s₈ as defined by the following Hamming windowing function are applied to the coefficients of the corresponding channels of the source spatially directive filter:

$${s}_{n} = 0.54 - 0.46 cos ( \frac{2 π ( n - 1 )}{N - 1} ) . \qquad ( 4 )$$

It may be desirable to implement task T100 and/or task T200 to apply a superdirective beamformer, which maximizes gain in a desired direction while minimizing the average gain over all other directions. Examples of superdirective beamformers include the minimum variance distortionless response (MVDR) beamformer (cross-covariance matrix), and the linearly constrained minimum variance (LCMV) beamformer. Other fixed or adaptive beamforming techniques, such as generalized sidelobe canceller (GSC) techniques, may also be used.

The design goal of an MVDR beamformer is to minimize the output signal power with the constraint min_{w} W^{H}Φ_{XX}W subject to W^{H}d=1, where W denotes the filter coefficient matrix, Φ_{XX} denotes the normalized cross-power spectral density matrix of the loudspeaker signals, and d denotes the steering vector. Such a beam design may be expressed as

$$W = \frac{{( {Γ}_{VV} + μ I )}^{- 1} d}{{{d}^{H} ( {Γ}_{VV} + μ I )}^{- 1} d} ,$$

where d^{T} is a farfield model for linear arrays that may be expressed as

d^{T}=[1,exp(−jΩfₛc⁻¹ cos(θ₀)),exp(−jΩfₛc⁻¹2l cos(θ₀)), . . . ,exp(−jΩfₛc⁻¹(N−1)cos(θ₀))],

and Γᵥ_{ₙ}ᵥ_{ₘ} is a coherence matrix whose diagonal elements are 1 and which may be expressed as

$${Γ}_{{V}_{n} {V}_{m}} = \frac{sin c ( \frac{Ω {f}_{s} {l}_{n m}}{c} )}{1 + \frac{{σ}^{2}}{{Φ}_{VV}}} ∀ n \neq m .$$

In these equations, μ denotes a regularization parameter (e.g., a stability factor), θ₀ denotes the beam direction, fₛ denotes the sampling rate, Ω denotes angular frequency of the signal, c denotes the speed of sound, l denotes the distance between the centers of the radiating surfaces of adjacent loudspeakers, lₙₘ denotes the distance between the centers of the radiating surfaces of loudspeakers n and m, Φ_{VV} denotes the normalized cross-power spectral density matrix of the noise, and σ² denotes transducer noise power.

Task T200 may be implemented to drive a linear loudspeaker array with uniform spacing, a linear loudspeaker array with nonuniform spacing, or a nonlinear (e.g., shaped) array, such as an array having more than one axis. In one example, task T200 is implemented to drive an array having more than one axis by using a pairwise beamforming-nullforming (BFNF) configuration as described herein with reference to a microphone array. Such an application may include a loudspeaker that is shared among two or more of the axes. Task T200 may also be performed using other directional field generation principles, such as a wave field synthesis (WFS) technique based on, e.g., the Huygens principle of wavefront propagation.

Task T300 drives the loudspeaker array, in response to the multichannel source and masking signals, to produce the sound field. Typically the produced sound field is a superposition of a source component based on the multichannel source signal and a masking component based on the masking signal. In such case, task T300 may be implemented to produce the source component of the sound field by driving the array in response to the multichannel source signal to create a corresponding beam of acoustic energy that is concentrated in the direction of the user and to create a valley in the beam response at other locations.

Task T300 may be configured to amplify, apply a gain to, and/or control a gain of the multichannel source signal, and/or to filter the multichannel source and/or masking signals. As shown in FIG. 6, task T300 may be implemented to mix each channel of the multichannel source signal with a corresponding channel of the masking signal to produce a corresponding one of a plurality N of driving signals SD10-1 to SD10-N. Task T300 may be implemented to mix the multichannel source and masking signals in the digital domain or in the analog domain. For example, task T300 may be configured to produce a driving signal for each loudspeaker by converting digital source and masking signals to analog, or by converting a digital mixed signal to analog. Such an implementation of task T300 may also apply each of the N driving signals to a corresponding loudspeaker of array LA100.

Additionally or in the alternative to mixing corresponding channels of the multichannel source and masking signals, task T300 may be implemented to drive different loudspeakers of the array to produce the source and masking components of the field. For example, task T300 may be implemented to drive a first plurality (i.e., at least two) of the loudspeakers of the array to produce the source component and to drive a second plurality (i.e., at least two) of the loudspeakers of the array to produce the masking component, where the first and second pluralities may be separate, overlapping, or the same.

Task T300 may also be implemented to perform one or more other audio processing operations on the mixed channels to produce the driving signals. Such operations may include amplifying and/or filtering one or more (possibly all) of the mixed channels. For example, it may be desirable to implement task T300 to apply an inverse filter to compensate for differences in the array response at different frequencies and/or to implement task T300 to compensate for differences between the responses of the various loudspeakers of the array. Alternatively or additionally, it may be desirable to implement task T300 to provide impedance matching to the loudspeakers of the array (and/or to an audio-frequency transmission path that leads to the loudspeaker array).

Task T100 may be implemented to produce the multichannel source signal according to a desired direction. As described above, for example, task T100 may be implemented to produce the multichannel source signal such that the resulting source component is oriented in a desired source direction. Examples of such source direction control include, without limitation, the following:

In a first example, task T100 is implemented such that the source component is oriented in a fixed direction (e.g., center zone). For example, task T110 may be implemented such that the coefficients of channels w₁ to w_{N} of the source spatially directive filter are calculated offline (e.g., during design and/or manufacture) and applied to the source signal at run-time. Such a configuration may be suitable for applications such as media viewing, web surfing, and browse-talk (i.e., web surfing while on a telephone call). Typical use scenarios include on an airplane, in a transportation hub (e.g., an airport or rail station), and at a coffee shop or café. Such an implementation of task T100 may be configured to allow selection (e.g., automatically according to a detected use mode, or by the user) among different source beam widths to balance privacy (which may be important for a telephone call) against sound pollution generation (which may be a problem for media viewing in close public areas).

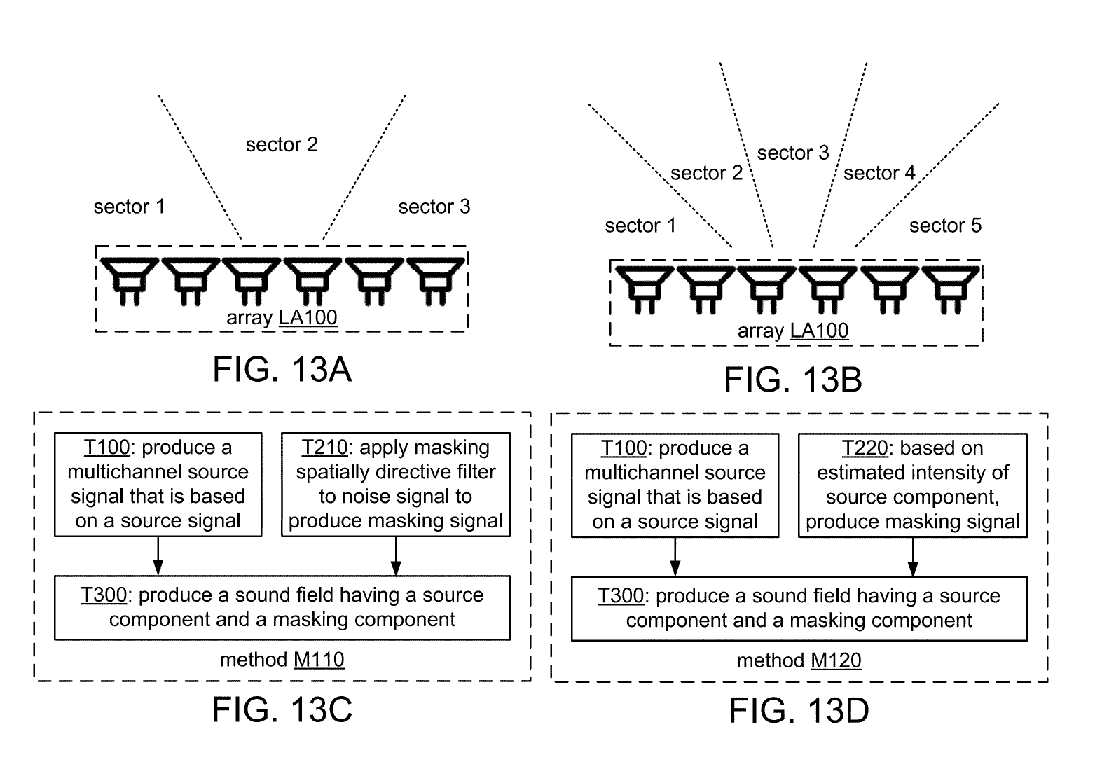

In a second example, task T100 is implemented such that the source component is oriented in a direction that is selected by the user from among two or more fixed options. For example, task T100 may be implemented such that the source component is oriented in a direction that corresponds to the user's selection from among a left zone, a center zone, and a right zone. In such case, task T110 may be implemented such that, for each direction to be selected, a corresponding set of coefficients for the channels w₁ to w_{N} of the source spatially directive filter is calculated offline (e.g., during design and/or manufacture) for selection and application to the source signal at run-time. One example of corresponding respective directions for the left, center, and right zones (or sectors) in such a case is (45, 90, 135) degrees. Other examples include, without limitation, (30, 90, 150) and (60, 90, 120) degrees. FIGS. 13A and 13B show examples of schemes having three and five selectable fixed spatial sectors, respectively.

In a third example, task T100 is implemented such that the source component is oriented in a direction that is automatically selected from among two or more fixed options according to an estimated user position. For example, task T100 may be implemented such that the source component is oriented in a direction that corresponds to the user's estimated position from among a left zone, a center zone, and a right zone. In such case, task T110 may be implemented such that, for each direction to be selected, a corresponding set of coefficients for the channels w₁ to w_{N} of the source spatially directive filter is calculated offline (e.g., during design and/or manufacture) for selection and application to the source signal at run-time. One example of corresponding respective directions for the left, center, and right zones in such a case is (45, 90, 135) degrees. Other examples include, without limitation, (30, 90, 150) and (60, 90, 120) degrees. It is also possible for such an implementation of task T100 to select among different source beam widths for the selected direction according to an estimated user range. For example, a more narrow beam may be selected when the user is more distant from the array (e.g., to obtain a similar beam width at the user's position at different ranges).

In a fourth example, task T100 is implemented such that the source component is oriented in a direction that may vary over time in response to changes in an estimated direction of the user. In such case, task T110 may be implemented to calculate the coefficients of the channels w₁ to w_{N} of the source spatially directive filter at run-time such that the orientation angle of the filter (i.e., angle φₛ) corresponds to the estimated direction of the user. Such an implementation of task T110 may be configured to perform an adaptive beamforming operation.

In a fifth example, task T100 is implemented such that the source component is oriented in a direction that is initially selected from among two or more fixed options according to an estimated user position (e.g., as in the third example above) and then adapted over time according to changes in the estimated user position (e.g., changes in direction and/or distance). In such case, task T110 may also be implemented to switch to (and then adapt) another of the fixed options in response to a determination that the current estimated direction of the user is within a zone corresponding to the new fixed option.

Task T200 may be implemented to generate the masking signal based on a noise signal, such as a white noise or pink noise signal. The noise signal may also be a signal whose frequency characteristics vary over time, such as a music signal, a street noise signal, or a babble noise signal. Babble noise is the sound of many speakers (actual or simulated) talking simultaneously such that their speech is not individually intelligible. In practice, use of low-level pink or white noise or another stationary noise signal, such as a constant stream or waterfall sound, may be less annoying to bystanders and/or less distracting to the user than babble noise.

In a further example, the noise signal is an ambient noise signal as detected from the current acoustic environment by one or more microphones of the device. In such case, it may be desirable to implement task T200 to perform echo cancellation and/or nonstationary noise cancellation on the ambient noise signal before using it to produce the masking signal.

Generation of the multichannel source signal by task T100 leads to a concentration of energy of the source component in a source direction relative to an axis of the array (e.g., in the direction of angle φₛ). As shown in FIGS. 8A to 12B, lesser but potentially significant concentrations of energy of the source component may arise in other directions relative to the axis as well (“leakage directions”). These concentrations are typically caused by sidelobes in the response of the source spatially directive filter.

It may be desirable to implement task T200 to direct the masking component such that its intensity is higher in one direction than another. For example, task T200 may be implemented to produce the masking signal such that an intensity of the masking component is higher in the leakage direction than in the source direction. The source direction is typically the direction of a main lobe of the source component, and the leakage direction may be the direction of a sidelobe of the source component. A sidelobe is an energy concentration of the component that is not within the main lobe.

In one example, the leakage direction is determined as the direction of a sidelobe of the source component that is adjacent to the main lobe. In another example, the leakage direction is the direction of a sidelobe of the source component whose peak intensity is not less than (e.g., is greater than) the peak intensities of all other sidelobes of the source component.

In a further alternative, the leakage direction may be based on directions of two or more sidelobes of the source component. For example, these sidelobes may be the highest sidelobes of the source component, the sidelobes having estimated intensities not less than (alternatively, greater than) a threshold value, and/or the sidelobes that are closest in direction to the same side of the main lobe of the source component. In such case, the leakage direction may be calculated as an average direction of the sidelobes, such as a weighted average among two or more directions (e.g., each weighted by intensity of the corresponding sidelobe).

Selection of the leakage direction may be performed during a design phase, based on a calculated response of the source spatially directive filter and/or from observation of a sound field produced using such a filter. Alternatively, task T200 may be implemented to select the leakage direction at run-time, similarly based on such a calculation and/or observation.

It may be desirable to implement task T200 to produce the masking component by inducing constructive interference in a desired direction of the produced sound field (e.g., in a leakage direction) while inducing destructive interference in other directions of the produced sound field (e.g., in the source direction). Such a technique may include implementing task T200 to produce the masking signal by steering a beam in a desired masking direction (i.e., in a leakage direction) while creating a null (implicitly or explicitly) in another direction.

Task T200 may be implemented, for example, to produce the masking signal by applying a second spatially directive filter (the “masking spatially directive filter”) to the noise signal. FIG. 13C shows a flowchart of an implementation M110 of method M100 that includes such an implementation T210 of task T200. By appropriately weighting and/or delaying the noise signal to generate each channel of the masking signal (e.g., as described above with reference to the multichannel source signal and the source component in task T100), task T210 produces a masking signal that may be used to obtain a desired spatial distribution of the masking component within the produced sound field.

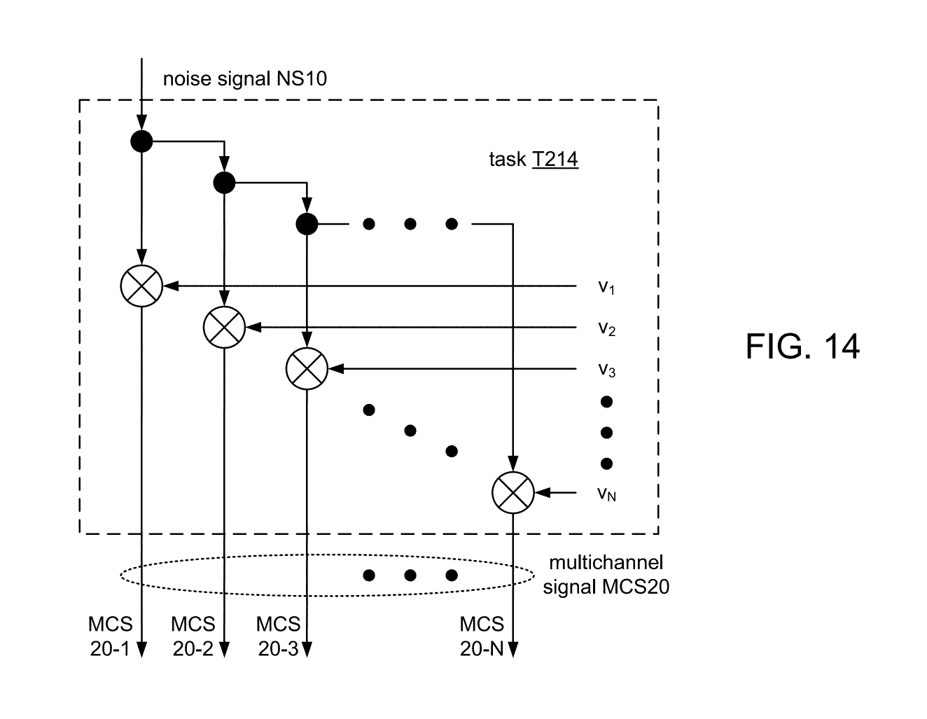

FIG. 14 shows a diagram of a frequency-domain implementation T214 of tasks T202 and T210 that is configured to produce each channel MCS20-1 to MCS20-N of masking signal MCS20 as a product of noise signal NS10 and a corresponding one of filters v₁ to v_{N}. Such multiplications may be performed serially (i.e., one after another) and/or in parallel (i.e., two or more at one time). In an equivalent time-domain implementation, the multipliers shown in FIG. 14 are implemented instead by convolution blocks.

Task T200 may be implemented according to a phased-array technique such that each channel of the masking signal has a respective phase (i.e., time) delay. For example, task T200 may be implemented to perform a DSB filtering operation to direct the masking component in the leakage direction by applying a respective time delay to the noise signal to produce each channel of signal MCS20. For a case in which task T300 drives a uniformly spaced linear loudspeaker array, for example, task T210 may be implemented to perform a DSB filtering operation by calculating the coefficients of filters v₁ to v_{N} according to an expression such as expression (1) or (3a) above, where the angle φₛ is replaced by the desired angle φₘ of the beam relative to the axis of the array (e.g., the leakage direction).

To avoid spatial aliasing, it may be desirable to limit the maximum frequency of the noise signal to c/2d. It is also possible to implement method M100 to include multiple instances of task T200 such that subarrays of array LA100 are driven differently for different frequency ranges.

The masking component may include more than one subcomponent. For example, the masking spatially directive filter may be configured such that the masking component includes a first masking subcomponent whose energy is concentrated in a beam on one side of the main lobe of source component, and a second masking subcomponent whose energy is concentrated in a beam on the other side of the main lobe of the source component. The masking component typically has a null in the source direction.

Examples of masking direction control that may be performed by respective implementations of task T200 include, without limitation, the following:

1) For a case in which the direction of the source component is fixed (e.g., determined during a design phase), it may be desirable also to fix (i.e., to precalculate) the masking direction.

2) For cases in which the direction of the source component is selected (e.g., by the user or automatically) from among several fixed options, it may be desirable for each of such fixed options to also indicate a corresponding masking direction. It may also be desirable to allow for multiple masking options for a single source direction (to allow selection among different respective masking component patterns, for example, for a case in which source beam width is selectable).

3) For a case in which the source component is adapted according to a direction that may vary over time, it may be desirable to select a corresponding masking direction from among several preset options and/or to adapt the masking direction according to the changes in the source direction.

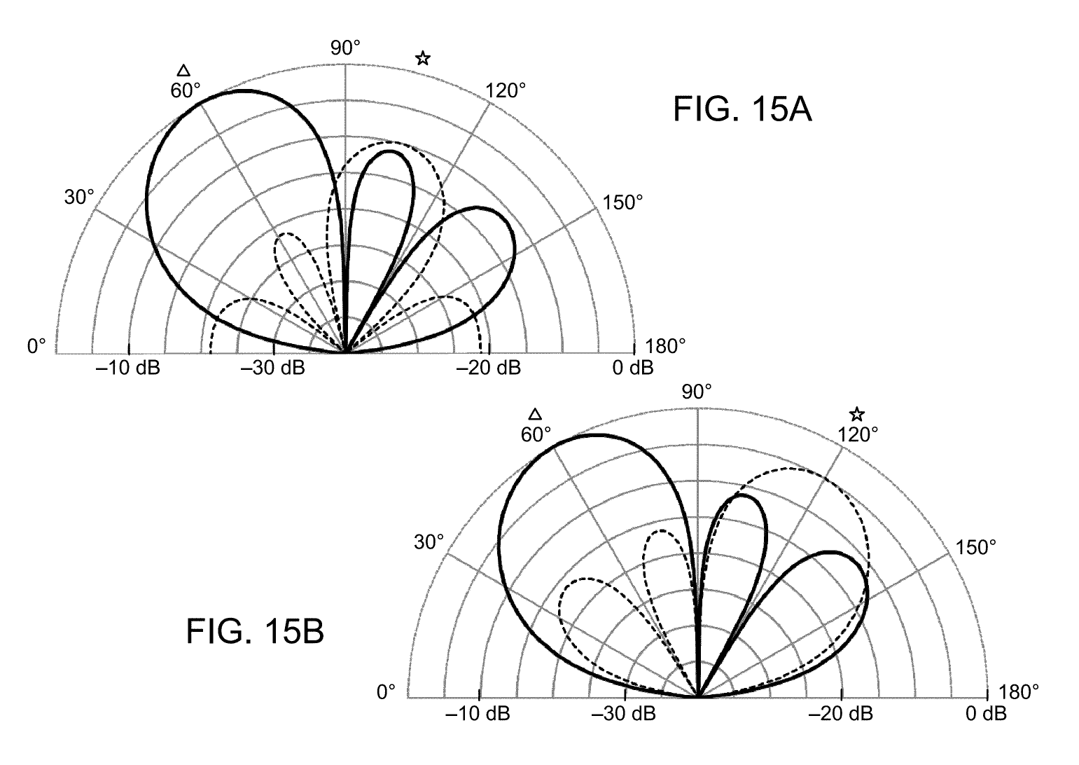

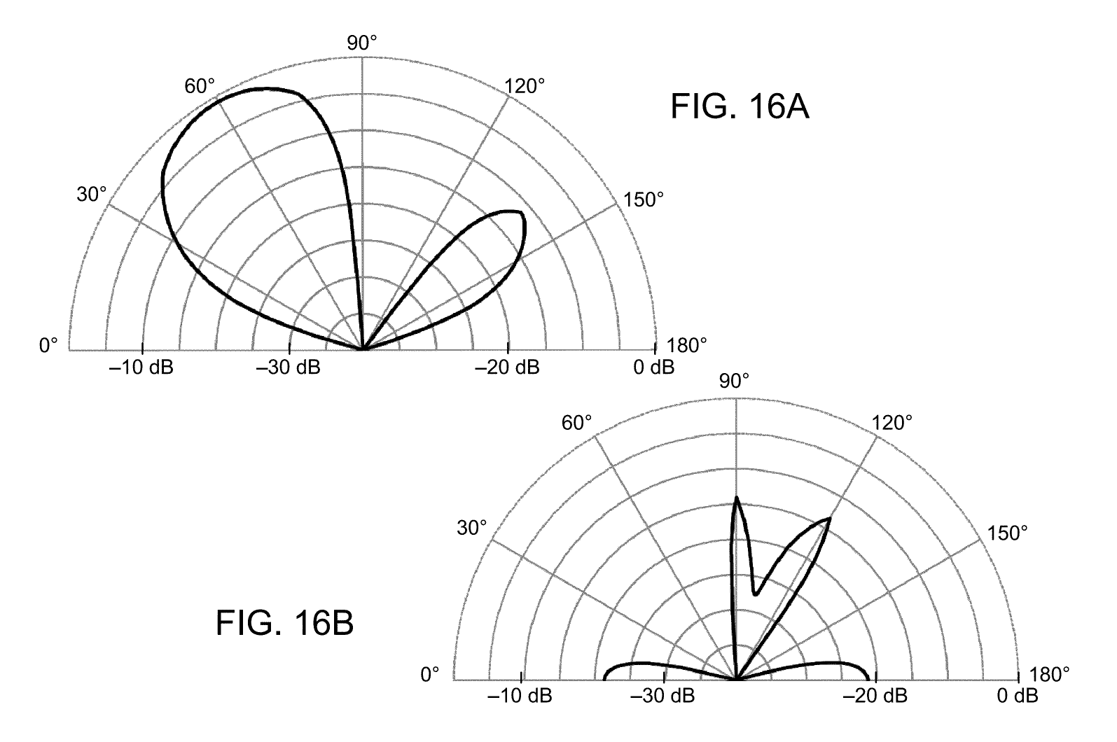

It may be desirable to design the masking spatially directive filter to have a response that is similar to the response of the source spatially selective filter in one or more leakage directions and has a null in the source direction. FIG. 15A shows an example of a beam pattern of a DSB filter (solid line, at frequency f₁) for driving a four-element array to produce a source component. In this example, the orientation angle of the filter (i.e., angle φₛ, as indicated by the triangle) is sixty degrees. FIG. 15A also shows an example of a beam pattern of a DSB filter (dashed line, also at frequency f₁) for driving the four-element array to produce a masking component. In this example, the orientation angle of the filter (i.e., angle φₘ, as indicated by the star) is 105 degrees, and the peak level of the masking component is ten decibels less than the peak level of the source component. FIGS. 16A and 16B show results of subtracting each beam pattern from the other, such that FIG. 16A shows the unmasked portion of the source component in the resulting sound field, and FIG. 16B shows the excess portion of the masking component in the resulting sound field.

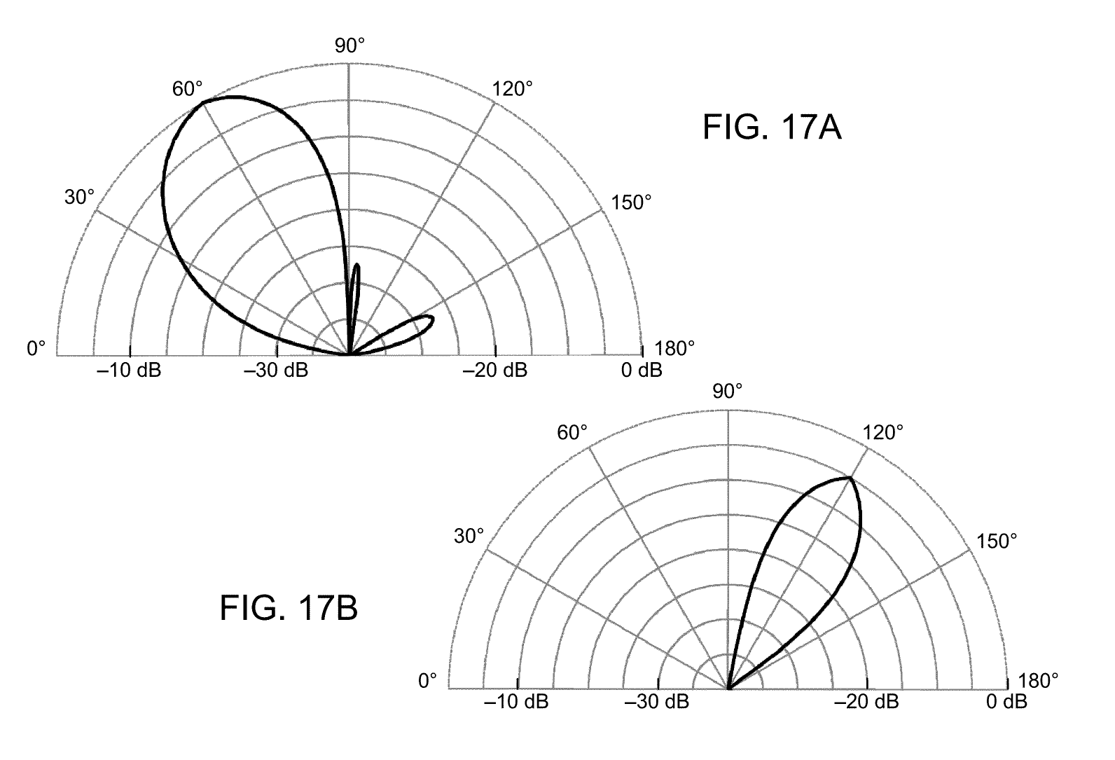

FIG. 15B shows an example of a beam pattern of a DSB filter (solid line, at frequency f₁) for driving a four-element array to produce a source component. In this example, the orientation angle of the filter (i.e., angle φₛ, as indicated by the triangle) is sixty degrees. FIG. 15B also shows an example of a beam pattern of a DSB filter (dashed line, also at frequency f₁) for driving the four-element array to produce a masking component. In this example, the orientation angle of the filter (i.e., angle φₘ, as indicated by the star) is 120 degrees, and the peak level of the masking component is five decibels less than the peak level of the source component. FIGS. 17A and 17B show results of subtracting each beam pattern from the other, such that FIG. 17A shows the unmasked portion of the source component in the resulting sound field, and FIG. 17B shows the excess portion of the masking component in the resulting sound field.

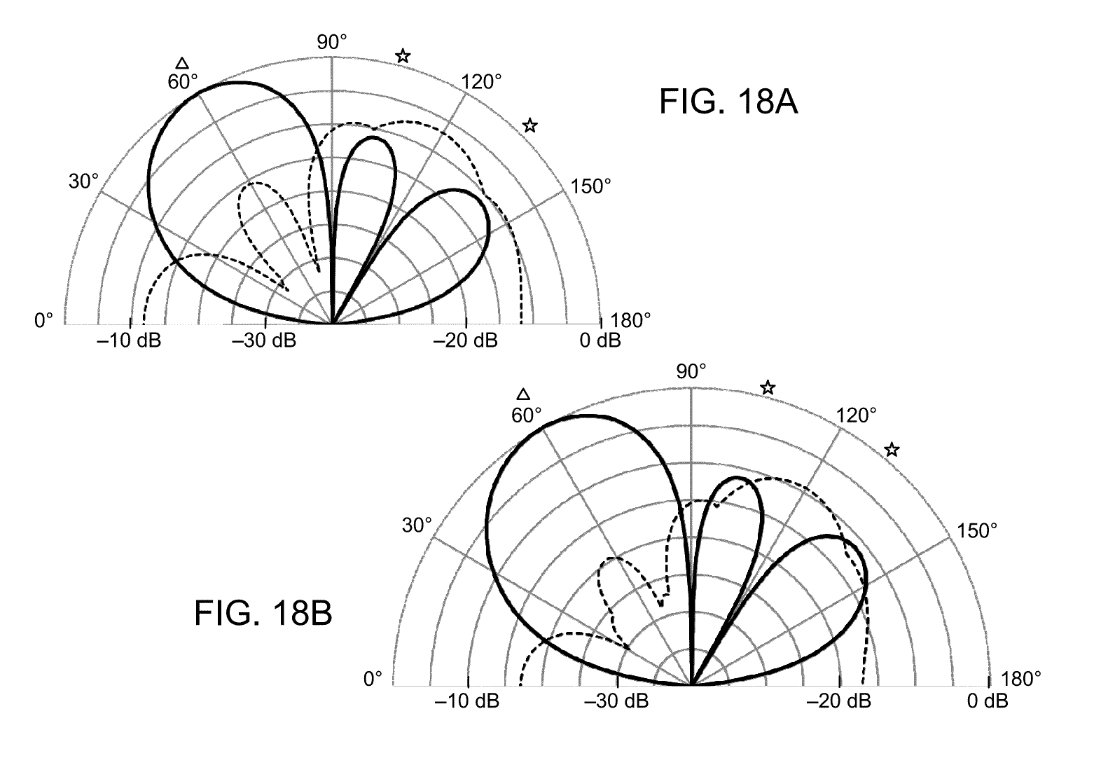

FIG. 18A shows an example of a beam pattern of a DSB filter (solid line, at frequency f₁) for driving a four-element array to produce a source component. In this example, the orientation angle of the filter (i.e., angle φₛ, indicated by the triangle) is sixty degrees. FIG. 18A also shows an example of a composite beam pattern (dashed line, also at frequency f₁) that is a sum of two DSB filters for driving the four-element array to produce a masking component. In this example, the orientation angle of the first masking subcomponent (i.e., angle φₘ₁, as indicated by a star) is 105 degrees, and the peak level of this component is ten decibels less than the peak level of the source component. The orientation angle of the second masking subcomponent (i.e., angle φₘ₂, as indicated by a star) is 135 degrees, and the peak level of this component is also ten decibels less than the peak level of the source component. FIG. 18B shows a similar example in which the first masking subcomponent is oriented at 105 degrees with a peak level that is fifteen dB below the source peak, and the second masking subcomponent is oriented at 130 degrees with a peak level that is twelve dB below the source peak.

As illustrated in FIGS. 2-4, it may be desirable to produce a masking component whose intensity is related to a degree of leakage of the source component. For example, it may be desirable to implement task T200 to produce the masking signal based on an estimated intensity of the source component. FIG. 13D shows a flowchart of an implementation M120 of method M100 that includes such an implementation T220 of task T200.

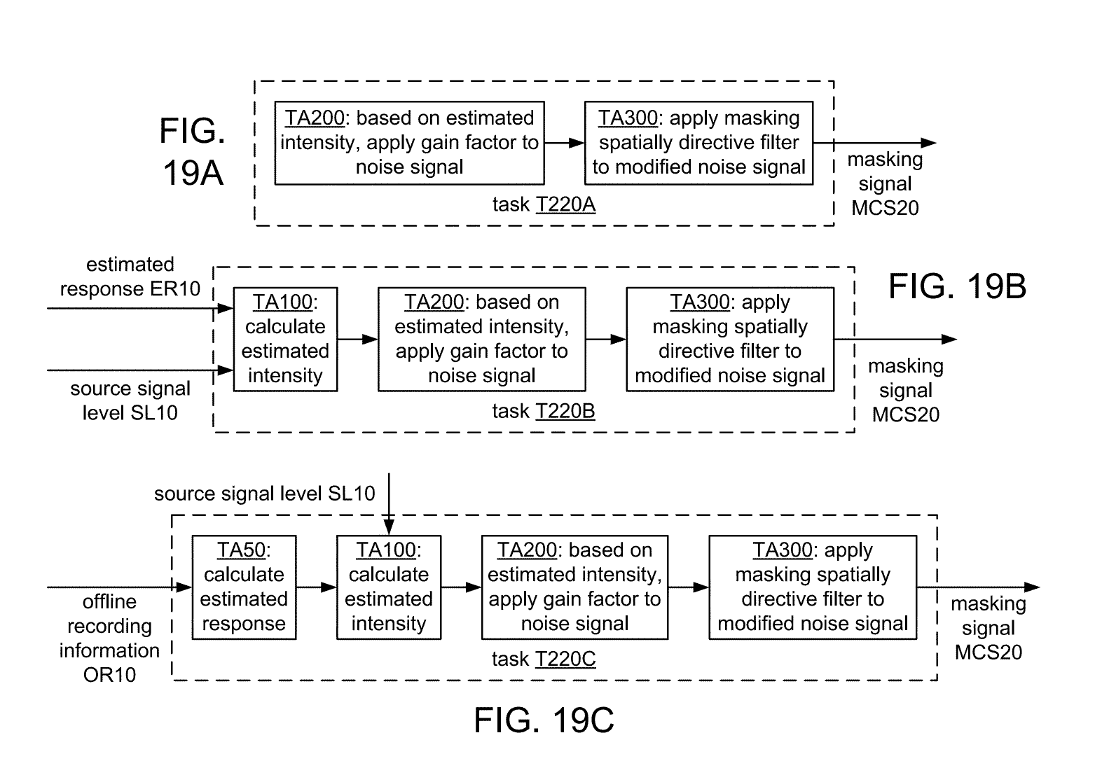

As noted above, task T200 may be implemented (e.g., as task T210) to produce the masking signal by applying a masking spatially directive filter to a noise signal. In such case, it may be desirable to modify the noise signal to achieve a desired masking effect. FIG. 19A shows a flowchart of such an implementation T220A of tasks T210 and T220 that includes subtasks TA200 and TA300. Task TA200 applies a gain factor to the noise signal to produce a modified noise signal, where the value of the gain factor is based on an estimated intensity of the source component. Task TA300 applies a masking spatially directive filter (e.g., as described above) to the modified noise signal to produce the masking signal.

The intensity of the source component in a particular direction is dependent on the response of the source spatially directive filter with respect to that direction. The intensity of the source component is also determined by the level of the source signal, which may be expected to change over time. FIG. 19B shows a flowchart of an implementation T220B of task T220A that includes a subtask TA100. Task TA100 calculates an estimated intensity of the source component, based on an estimated response ER10 of the source spatially directive filter and on a level SL10 of the source signal. For example, task TA100 may be implemented to calculate the estimated intensity as a product of the estimated response and level in the linear domain, or as a sum of the estimated response and level in the decibel domain.

The estimated intensity of the source component in a given direction φ may be based on an estimated response of the source spatially directive filter in that direction, which is typically expressed relative to an estimated peak response of the filter (e.g., the estimated response of the filter in the source direction). Task TA200 may be implemented to apply a gain factor value to the noise signal that is based on a local maximum of an estimated response of the source spatially directive filter in a direction other than the source direction (e.g., in the leakage direction). For example, task TA200 may be implemented to apply a gain factor value that is based on the maximum sidelobe peak intensity of the filter response. In another example, the value of the gain factor is based on a maximum of the estimated filter response in a direction that is at least a minimum angular distance (e.g., ten or twenty degrees) from the source direction.

For a case in which a source spatially directive filter of task T100 comprises channels w₁ to w_{N} as in expression (1) above, the response H_{φs}(φ,f) of the filter, at angle φ and frequency f and relative to the response at source direction angle φₛ, may be estimated as a magnitude of a sum of the relative responses of the channels w₁ to w_{N}. Such an estimated response may be expressed in decibels as:

$${H}_{ϕ s} ( ϕ , f ) = 20 {log}_{10} \vert \frac{1}{N} {\sum }_{n = 1}^{N} exp ( - j \frac{2 π fd}{c} ( n - 1 ) ( cos ϕ - cos {ϕ}_{s} ) ) \vert . \qquad ( 5 )$$

Similar application of the principle of this example to calculate an estimated response for a spatially directive filter that is otherwise expressed will be easily understood.

Such calculation of a filter response may be performed according to a desired resolution of angle φ and frequency f. Alternatively, it may be decided for some applications that calculation of the response at a single value of frequency f (e.g., frequency f₁) is sufficient. Such calculation may also be performed for each of a plurality of source spatially selective filters, each oriented in a different corresponding source direction (e.g., for each of a set of fixed options as described above with reference to examples 1, 2, 3, and 5 of task T100), such that task TA100 selects the estimated response corresponding to the current source direction at run-time.

Calculating a filter response as defined by the values of its coefficients (e.g., as described above with reference to expression (5)) produces a theoretical result that may differ from the actual response of the device with respect to direction (and frequency) as observed in service. It may be expected that in-service masking performance may be improved by compensating for such difference. For example, the response of the source spatially directive filter with respect to direction (and frequency, if desired) may be estimated by measuring the intensity distribution of an actual sound field that is produced using a copy of the filter. Such direct measurement of the estimated intensity may also be expected to account for other effects that may be observed in service, such as a response of the loudspeaker array.

In this case, an instance of task T100 is performed on a second source signal (e.g., white or pink noise) to produce a second multichannel source signal, based on the source direction. The second multichannel source signal is used to drive a second array of loudspeakers to produce a second sound field that has a source component in the source direction (in this case, relative to an axis of the second array). The intensity of the second sound field is observed at each of a plurality of angles (and, if desired, at each of one or more frequency subbands), and the observed intensities are recorded to obtain an offline recording.

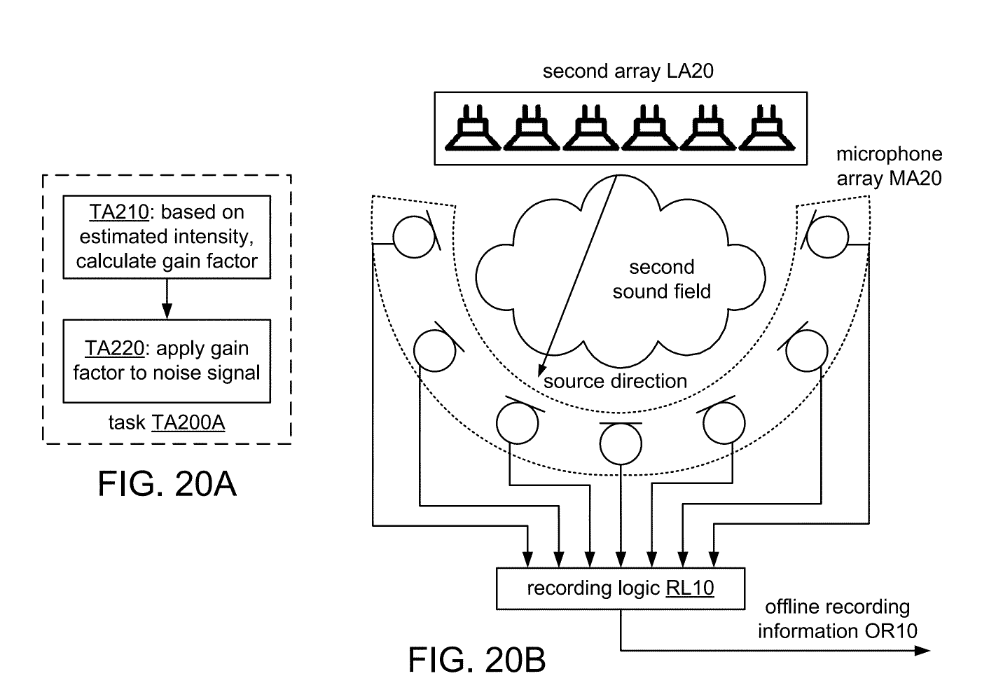

FIG. 20B shows an example of such a procedure of direct measurement using an arrangement that includes a copy of the source spatially directive filter (not shown), a second array of loudspeakers LA20, a microphone array MA20, and recording logic (e.g., a processor and memory) RL10. In this example, each microphone of the array MA20 is positioned at a known observation angle with respect to the axis of loudspeaker array LA20 to produce an observation of the second sound field at the respective angle. In another example, one microphone may be used to obtain two or more (possibly all) of the observations at different times by moving the microphone and/or the array between observations to obtain the desired relative positioning. During each observation, it may be desirable for the respective microphone to be positioned at a desired distance from the array (e.g., in the far field and at a typical bystander-to-array distance expected to be encountered in service, such as a distance in the range of from one to two or one to four meters). In any case, it may be desirable to perform the observations in an anechoic chamber.

It may be desirable to minimize effects that may cause the second sound field to differ from the source component and thereby reduce the accuracy of the estimated response. For example, it may be desirable for loudspeaker array LA20 to be similar as possible to loudspeaker array LA10 (e.g., for each array to have the same number of the same type of loudspeakers, and for the positioning of the loudspeakers relative to one another to be the same in each array). Physical characteristics of the device (e.g., acoustic reflectance of the surfaces, resonances of the housing) may also affect the intensity distribution of the sound field, and it may be desirable to include the effects of such characteristics in the observed results as recorded. For example, it may also be desirable for array LA20 to be mounted and/or enclosed, during the measurement, in a housing that is as similar as possible to the housing in which array LA10 is to be mounted and/or enclosed during service. Similarly, it may be desirable for the electronics used to drive each array in response to the corresponding multichannel signal to be as similar as possible, or at least to have similar frequency responses.

Recording logic RL10 receives a signal produced by each microphone of array MA20 in response to the second sound field and calculates a corresponding intensity (e.g., as the energy over a frame or other interval of the captured signal). Recording logic RL10 may be implemented to calculate the intensity of the second source field with respect to direction (e.g., in decibels) relative to a level of the second source signal or, alternatively, relative to an intensity of the second sound field in the source direction. If desired, recording logic RL10 may also be implemented to calculate the intensity at each observation direction per frequency component or subband.

Such sound field production, measurement, and intensity calculation may be repeated for each of a plurality of source directions. For example, a corresponding instance of the measurement procedure may be performed for each of a set of fixed options as described above with reference to examples 1, 2, 3, and 5 of task T100. The calculated intensities are stored before run-time (e.g., during manufacture, during provisioning, and/or as part of a software or firmware update) as offline recording information OR10.

Calculation of a response of the source spatially directive filter may be based on an estimated response that is calculated from the filter coefficients as described above (e.g., with reference to expression (5)), on an estimated response from offline recording information OR10, on or a combination of both. In one example of such a combination, the estimated response is calculated as an average of corresponding values from the filter coefficients and from information OR10.

In another example of such a combination, the estimated response is calculated by adjusting an estimated response at angle φ, as calculated from the filter coefficients, according to one or more estimated responses from observations at nearby angles from information OR10. It may be desirable, for example, to collect and/or store offline recording information OR10 using a coarse angular resolution (e.g., five, ten, twenty, 22.5, thirty, or forty-five degrees) and to calculate the intensity from the filter coefficients using a finer angular resolution (e.g., one, five, or ten degrees). In such case, the estimated response may be calculated by compensating a response as calculated from the filter coefficients (e.g., as described above with reference to expression (5)) with a compensation factor that is based on information OR10. The compensation factor may be calculated, for example, from a difference between an observed response at a nearby angle, from information OR10, and a response as calculated from the filter coefficients for the nearby angle. In a similar manner, a compensation factor with respect to source direction and/or frequency may also be calculated from an observed response from information OR10 at a nearby source direction and/or a nearby frequency.

The response of the source spatially directive filter may be estimated and stored before run-time, such as during design and/or manufacture, to be accessed by task T220 (e.g., by task TA100) at run-time. Such precalculation may be appropriate for a case in which the source component is oriented in a fixed direction or in a selected one of a few (e.g., ten or fewer) fixed directions (e.g. as described above with reference to examples 1, 2, 3, and 5 of task T100). Alternatively, task T220 may be implemented to estimate the filter response at run-time. FIG. 19C shows a flowchart for such an implementation T220C of task T220B that includes a subtask TA50, which is configured to calculate the estimated response based on offline recording information OR10. In either case, task T220 may be implemented to update the value of the gain factor in response to a change in the source direction.

FIG. 20A shows a flowchart for an implementation TA200A of task TA200 that includes subtasks TA210 and TA220. Based on the estimated intensity of the source component, task TA210 calculates a value of the gain factor. Task TA210 may be implemented, for example, to calculate the gain factor such that the masking component has the same intensity in the leakage direction as the source component, or to obtain a different relation between these intensities (e.g., as described below). Task TA210 may be implemented to compensate for a difference between the levels of the source and noise signals and/or to compensate for a difference between the responses of the source and masking spatially directive filters. Task TA220 applies the gain factor value to the noise signal to produce the modified noise signal. For example, task TA220 may be implemented to multiply the noise signal by the gain factor value (e.g., in a linear domain), or to add the gain factor value to a gain of the noise signal (e.g., in a decibel domain). Such an implementation TA200A of task TA200 may be used, for example, in any of tasks T220A, T220B, and T220C.

The value of the gain factor may also be based on an estimated intensity of the source component in one or more other directions. For example, the gain factor value may be based on estimated filter responses at two or more source sidelobes (e.g., relative to the source main lobe level). In such case, the two or more sidelobes may be selected as the highest sidelobes, the sidelobes having estimated intensities not less than (alternatively, greater than) a threshold value, and/or the sidelobes that are closest in direction to the main lobe. The gain factor value (which may be precalculated, or calculated at run-time by task TA210) may be based on an average of the estimated responses at the two or more sidelobes.

Task T200 may be implemented to produce the masking signal based on a level of the source signal in the time domain. FIG. 19B, for example, shows a flowchart of task T220B in which task TA100 is arranged to calculate the estimated intensity of the source component based on a level (e.g., a frame energy level, which may be calculated as a sum or average of the squared sample magnitudes) of the source signal. In such case, a corresponding implementation of task TA210 may be implemented to calculate the gain factor value based on a local maximum of the estimated intensity in a direction other than the source direction, or a maximum of the estimated intensity in a direction that is at least a minimum distance (e.g., ten or twenty degrees) from the source direction. It may be desirable to implement task TA100 to calculate the source signal level according to a loudness weighting function or other perceptual response function, such as an A-weighting curve (e.g., as specified in a standard, such as IEC (International Electrotechnical Commission, Geneva, CH) 61672:2003 or ITU (International Telecommunications Union, Geneva, CH) document ITU-R 468).

It may be desirable to implement task T200 to vary the gain of the masking signal over time (e.g., to implement task TA210 to vary the gain of the noise signal over time), based on a level of the source signal over time. For example, it may be desirable to implement task T200 to control a gain of the noise signal based on a temporally smoothed level of the source signal. Such control may help to avoid annoying mimicking of speech sparsity (e.g., in a phone-call masking scenario). For applications in which a signal that indicates a voice activity state of the source signal is available, task T200 may be configured to maintain a high level of the masking signal for a hangover period (e.g., several frames) after the voice activity state changes from active to inactive.

It may be desirable to use a temporally sparse signal to mask a similarly sparse source signal, such as a far-end voice communications signal, and to use a temporally continuous signal to mask a less sparse source signal, such as a music signal. In such case, task T200 may be implemented to produce a masking signal that is active only when the source signal is active. Such implementations of task T200 may produce a masking signal whose energy changes over time in a manner similar to that of the source signal (e.g., a masking signal whose energy over time is proportional to that of the source signal).

As described above, the estimated intensity of the source component may be based on an estimated response of the source spatially directive filter in one or more directions. The estimated intensity of the source component may also be based on a level of the source signal. In such case, task TA210 may be implemented to calculate the gain factor value as a combination (e.g., as a product in the linear domain or as a sum in the decibel domain) of a value based on the estimated filter response, which may be precalculated, and a value based on the estimated source signal level. A corresponding implementation of task T220 may be configured, for example, to produce the masking signal by applying a gain factor to each frame of the noise signal, where the value of the gain factor is based on a level (e.g., an energy level) of a corresponding frame of the source signal. In one such case, the value of the gain factor is higher when the energy of the source signal within the frame is high and lower when the energy of the source signal within the frame is low.

If the source signal is sparse over time (e.g., as for a speech signal), a masking signal whose level strictly mimics the sparse behavior of the source speech signal over time may be distracting to nearby persons by emphasizing the speech sparsity. It may be desirable, therefore, to implement task T200 to produce the masking signal to have a more gradual attack and/or decay over time than the source signal. For example, task TA200 may be implemented to control the level of the masking signal based on a temporally smoothed level of the source signal and/or to perform a temporal smoothing operation on the gain factor of the masking signal.

In one example, such a temporal smoothing operation is implemented by using a first-order infinite-impulse-response filter (also called a leaky integrator) to apply a smoothing factor to a sequence in time of values of the gain factor (e.g., to the gain factor values for a consecutive sequence of frames). The value of the smoothing factor may be fixed. Alternatively, the smoothing factor may be adapted to provide less smoothing during onset of the source signal and/or more smoothing during offset of the source signal. For example, the smoothing factor value may be based on an activity state and/or an activity state transition of the source signal. Such smoothing may help to reduce the temporal sparsity of the combined sound field as experienced by a bystander.

Additionally or alternatively, task T200 may be implemented to produce the masking signal to have a similar onset as the source signal but a prolonged offset. For example, it may be desirable to implement task TA200 to apply a hangover period to the gain factor such that the gain factor value remains high for several frames after the source signal becomes inactive. Such a hangover may help to reduce the temporal sparsity of the combined sound field as experienced by a bystander and may also help to obscure the source component via a psychoacoustic effect called “backward masking” (or pre-masking). For applications in which a signal that indicates a voice activity state of the source signal is available, task T200 may be configured to maintain a high level of the masking signal for a hangover period (e.g., several frames) after the voice activity state changes from active to inactive. Additionally or alternatively, for a case in which it is acceptable to delay the source signal, task T200 may be implemented to generate the masking signal to have an earlier onset than the source signal to support a psychoacoustic effect called “forward masking” (or post-masking).

Instead of being configured to produce a masking signal whose energy is similar (e.g., proportional) over time to the energy of the source signal, task T200 may be implemented to produce the masking signal such that the combined sound field has a substantially constant level over time in the direction of the masking component. In one such example, task TA210 is configured to calculate the gain factor value such that the expected energy of the combined sound field in the direction of the masking component for each frame is based on a long-term energy level of the source signal (e.g., the energy of the source signal averaged over the most recent ten, twenty, or fifty frames).

Such an implementation of task TA210 may be configured to calculate a gain factor value for each frame of the masking signal based on both the energy of the corresponding frame of the source signal and the long-term energy level of the source signal. For example, task TA210 may be implemented to produce the masking signal such that a change in the value of the gain factor from a first frame to a second frame is opposite in direction to a change in the level of the source signal from the first frame to the second frame (e.g., is complementary, with respect to the long-term energy level, to a corresponding change in the level of the source signal).

A masking signal whose energy changes over time in a manner similar to that of the energy of the source signal may provide better privacy. Consequently, such a configuration of task T200 may be suitable for a communications use case. Alternatively, a combined sound field having a substantially constant level over time in the direction of the masking component may be expected to have a reduced environmental impact and may be suitable for an entertainment use case. It may be desirable to implement task T200 to produce the masking signal according to a detected use case (e.g., as indicated by a current mode of operation of the device and/or by the nature of the module from which the source signal is received).

In a further example, task T200 may be implemented to modulate the level of the masking signal over time according to a rhythmic pattern. For example, task T200 may be implemented to modulate the level of the masking signal over time at a frequency of from 0.1 Hz to 3 Hz. Such modulation has been shown to provide effective masking at reduced masking power levels. The modulation frequency may be fixed or may be adaptive. For example, the modulation frequency may be based on a detected variation in the level of the source signal over time (e.g., a rhythm of a music signal), and the frequency of this variation may change over time. In such cases, task TA200 may be implemented to apply such modulation by modulating the value of the gain factor.

In addition to an estimated intensity of the source component, task TA210 may be implemented to calculate the value of the gain factor based on one or more other component factors as well. In one such example, task TA210 is implemented to calculate the value of the gain factor based on the type of noise signal used to produce the masking signal (e.g., white noise or pink noise). Additionally or alternatively, task TA210 may be implemented to calculate the value of the gain factor based on the identity of a current application. For example, it may be desirable for the masking component to have a higher intensity during a voice communications or other privacy-sensitive application (e.g., a telephone call) than during a media application (e.g., watching a movie). In such case, task TA210 may be implemented to scale the gain factor according to a detected use case (as indicated, for example, by a current mode of operation of the device and/or by the nature of the module from which the source signal is received). Other examples of such component factors include a ratio between the peak responses of the source and masking spatially directive filters. Task TA210 may be implemented to multiply (e.g., in a linear domain) and/or to add (e.g., in a decibel domain) such component factors to obtain the gain factor value. It may be desirable to implement task TA210 to calculate the gain factor value according to a loudness weighting function or other perceptual response function, such as an A-weighting curve.

It may be desirable to implement task T200 to produce the masking signal based on a frequency profile of the source signal (a “source frequency profile”). The source frequency profile indicates a corresponding level (e.g., an energy level) of the source signal at each of a plurality of different frequencies (e.g., subbands). In such case, it may be desirable to calculate and apply values of the gain factor to corresponding subbands of the noise signal.

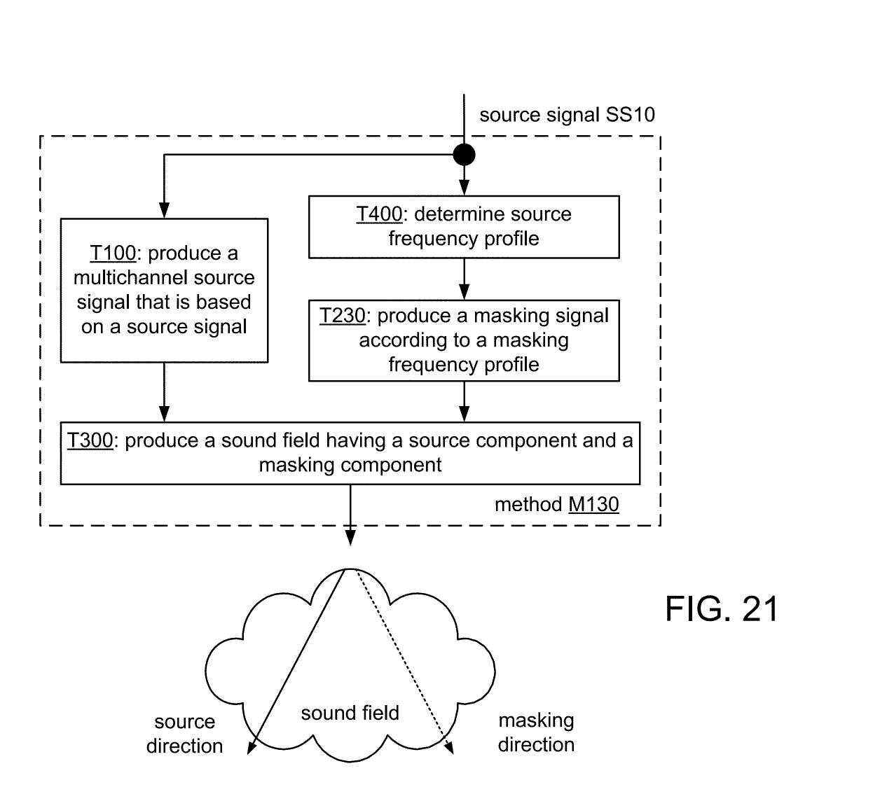

FIG. 21 shows a flowchart of an implementation M130 of method M100 that includes a task T400 and an implementation T230 of task T200. Task T400 determines a frequency profile of source signal SS10. Based on this source frequency profile, task T230 produces the masking signal according to a masking frequency profile that is different than the source frequency profile. The masking frequency profile indicates a corresponding masking target level for each of the plurality of different frequencies (e.g., subbands). FIG. 21 also illustrates an application of method M130.

Task T400 may be implemented to determine the source frequency profile according to a current use of the device (e.g., as indicated by a current mode of operation of the device and/or by the nature of the module from which the source signal is received). If the device is engaged in voice communications (for example, the source signal is a far-end telephone call), task T400 may determine that the source signal has a frequency profile that indicates a decrease in energy level as frequency increases. If the device is engaged in media playback (for example, the source signal is a music signal), task T400 may determine that the source frequency profile is flatter with respect to frequency, such as a white or pink noise profile.

Additionally or alternatively, task T400 may be implemented to determine the source frequency profile by calculating levels of the source signal at different frequencies. For example, task T400 may be implemented to determine the source frequency profile by calculating a first level of the source signal at a first frequency and a second level of the source signal at a second frequency. Such calculation may include a spectral or subband analysis of the source signal in a frequency domain or in the time domain. Such calculation may be performed for each frame of the source signal or at another interval. Typical frame lengths include five, ten, twenty, forty, and fifty milliseconds. It may be desirable to implement task T400 to calculate the source frequency profile according to a loudness weighting function or other perceptual response function, such as an A-weighting curve.

For time-domain analysis, task T400 may be implemented to determine the source frequency profile by calculating an average energy level for each of a plurality of subbands of the source signal. Such an analysis may include applying a subband filter bank to the source signal, such that the frame energy of the output of each filter (e.g., a sum of squared samples of the output for the frame or other interval, which may be normalized to a per-sample value) indicates the level of the source signal at a corresponding frequency, such as a center or peak frequency of the filter passband.

The subband division scheme may be uniform, such that each subband has substantially the same width (e.g., within about ten percent). Alternatively, the subband division scheme may be nonuniform, such as a transcendental scheme (e.g., a scheme based on the Bark scale) or a logarithmic scheme (e.g., a scheme based on the Mel scale). In one example, the edges of a set of seven Bark scale subbands correspond to the frequencies 20, 300, 630, 1080, 1720, 2700, 4400, and 7700 Hz. Such an arrangement of subbands may be used in a wideband speech processing system that has a sampling rate of 16 kHz. In other examples of such a division scheme, the lower subband is omitted to obtain a six-subband arrangement and/or the high-frequency limit is increased from 7700 Hz to 8000 Hz. Another example of a subband division scheme is the four-band quasi-Bark scheme 300-510 Hz, 510-920 Hz, 920-1480 Hz, and 1480-4000 Hz. Such an arrangement of subbands may be used in a narrowband speech processing system that has a sampling rate of 8 kHz. Other examples of perceptually relevant subband division schemes that may be used to implement a subband filter bank for analysis of the source signal include octave band, third-octave band, critical band, and equivalent rectangular bandwidth (ERB) scales.

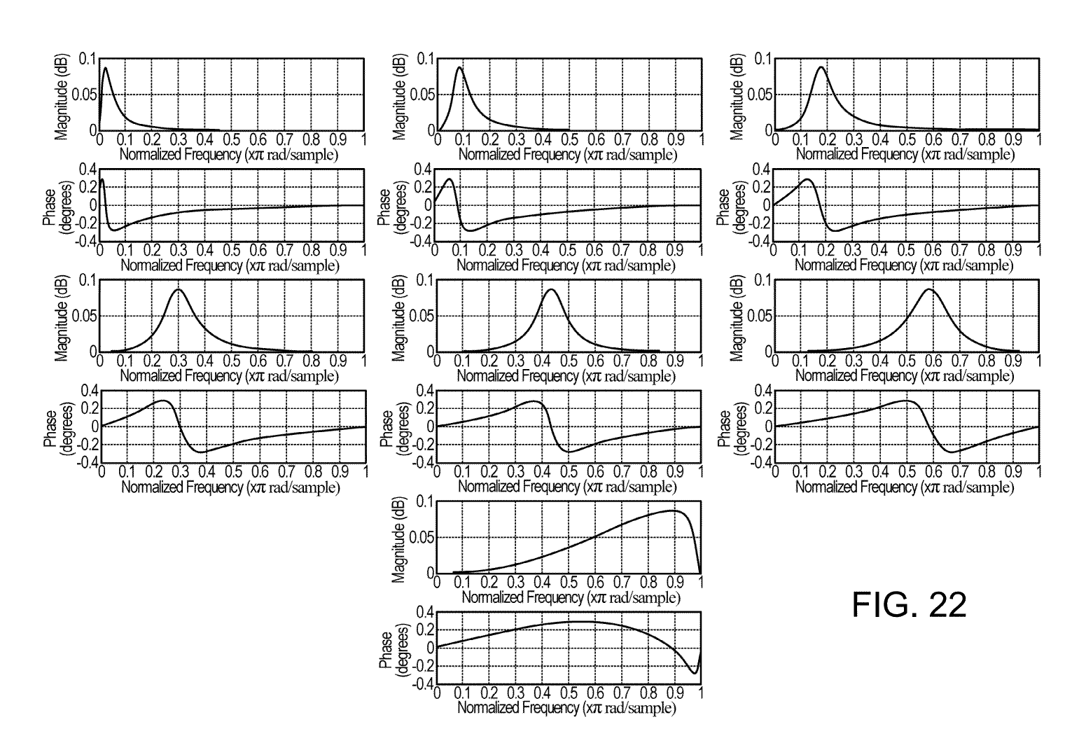

In one example, task T400 applies a subband filter bank that is implemented as a bank of second-order recursive (i.e., infinite-impulse-response) filters. Such filters are also called “biquad filters.” FIG. 22 shows a normalized frequency response for one example of a set of seven biquad filters. Other examples that may use a set of biquad filters to implement a perceptually relevant subband division scheme include four-, six-, seventeen-, and twenty-three-subband filter banks.

For frequency-domain analysis, task T400 may be implemented to determine the source frequency profile by calculating a frame energy level for each of a plurality of frequency bins of the source signal or by calculating an average frame energy level for each of a plurality of groups of frequency bins of the source signal. Such a grouping may be configured according to a perceptually relevant subband division scheme, such as one of the examples listed above.

In another example, task T400 is implemented to determine the source frequency profile from a set of linear prediction coding (LPC) parameters, such as LPC filter coefficients. Such an implementation may be especially suitable for a case in which the source signal is provided in a form that includes LPC parameters (e.g., the source signal is provided as an encoded speech signal). In such case, the source frequency profile may be implemented to include a location and level for each of one or more spectral peaks (e.g., formants) and/or valleys of the source signal. It may be desirable, for example, to implement task T230 to filter the noise signal to have a low level at source formant peaks and a higher level in source spectral valleys. Alternatively or additionally, task T230 may be implemented to filter the noise signal to have a notch at one or more of the source pitch harmonics. Alternatively or additionally, task T230 may be implemented to filter the noise signal to have a spectral tilt that is based on (e.g., is inverse in direction to) a source spectral tilt, as indicated, e.g., by the first reflection coefficient.

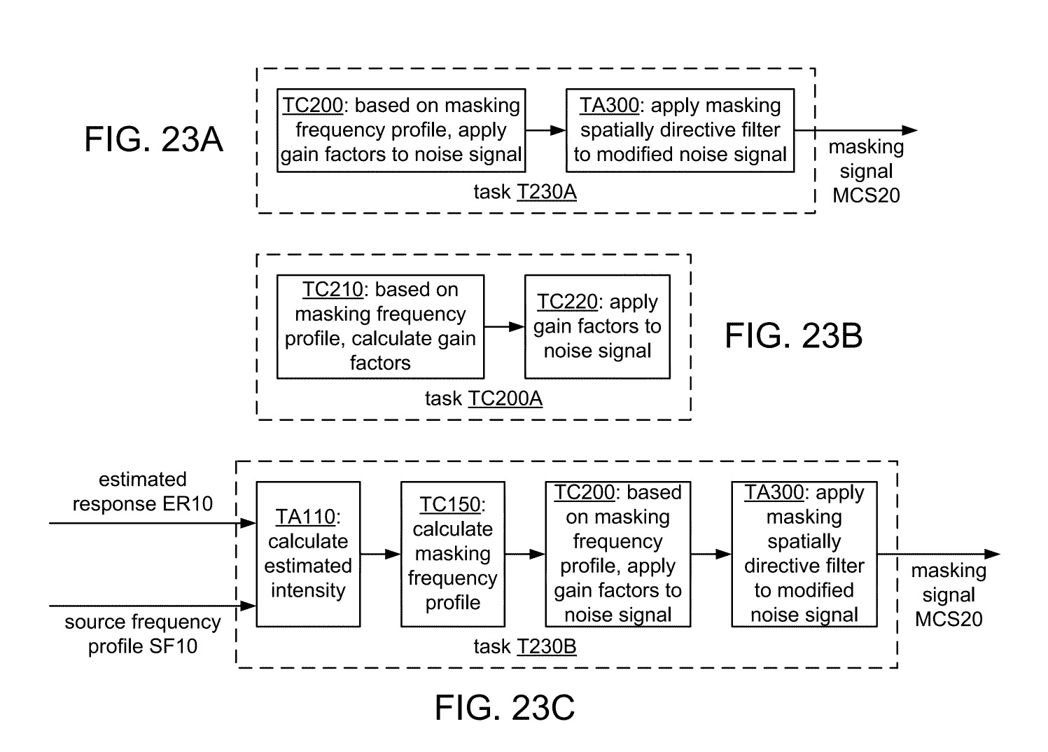

Task T230 produces the masking signal based on the noise signal and according to the masking frequency profile. The masking frequency profile may indicate a distribution of energy that is more concentrated or less concentrated in particular bands (e.g., speech bands), or a frequency profile that is flat or is tilted up or down. FIG. 23A shows a flowchart of an implementation T230A of tasks T210 and T230 that includes subtask TC200 and an instance of task TA300. Task TC200 applies gain factors to the noise signal to produce a modified noise signal, where the values of the gain factors are based on the masking frequency profile.

Based on the source frequency profile, task T230 may be implemented to select the masking frequency profile from a database. Alternatively, task T230 may be implemented to calculate the masking frequency profile, based on the source frequency profile. FIG. 23B shows a flowchart of an implementation TC200A of task TC200 that includes subtasks TC210 and TC220. Based on the masking frequency profile, task TC210 calculates a value of the gain factor for each subband. Task TC210 may be implemented, for example, to calculate each gain factor value to obtain, in that subband, the same intensity for the masking component in the leakage direction as for the source component or to obtain a different relation between these intensities (e.g., as described below). Task TC210 may be implemented to compensate for a difference between the levels of the source and noise signals in each of one or more subbands and/or to compensate for a difference between the responses of the source and masking spatially directive filters in one or more subbands. Task TC220 applies the gain factor values to the noise signal to produce the modified noise signal. Such an implementation TC200A of task TC200 may be used, for example, in any of tasks T230A and T230B as described herein.

FIG. 23C shows a flowchart of an implementation T230B of task T230A that includes subtasks TA110 and TC150. Task TA110 is an implementation of task TA100 that calculates the estimated intensity of the source component, based on the source frequency profile and on an estimated response ER10 of the source spatially directive filter (e.g., in the leakage direction). Task TC150 calculates the masking frequency profile based on the estimated intensity.

It may be desirable to implement task TA110 to calculate the estimated intensity of the source component with respect to frequency, based on the source frequency profile. Such calculation may also take into account variations of the estimated response of the source spatially directive filter with respect to frequency (alternatively, it may be decided for some applications that calculation of the response at a single value of frequency f, such as frequency f₁, is sufficient).

The response of the source spatially directive filter may be estimated and stored before run-time, such as during design and/or manufacture, to be accessed by task T230 (e.g., by task TA110) at run-time. Such precalculation may be appropriate for a case in which the source component is oriented in a fixed direction or in a selected one of a few (e.g., ten or fewer) fixed directions (e.g. as described above with reference to examples 1, 2, 3, and 5 of task T100). Alternatively, task T230 may be implemented to estimate the filter response at run-time.

Task TA110 may be implemented to calculate the estimated intensity for each subband as a product of the estimated response and level for the subband in the linear domain, or as a sum of the estimated response and level for the subband in the decibel domain. Task TA110 may also be implemented to apply temporal smoothing and/or a hangover period as described above to each of one or more (possibly all) of the subband levels of the source signal.

The masking frequency profile may be implemented as a plurality of masking target levels, each corresponding to one of the plurality of different frequencies (e.g., subbands). In such case, task T230 may be implemented to produce the masking signal according to the masking target levels.

Task TC150 may be implemented to calculate each of one or more of the masking target levels as a corresponding masking threshold that is based on a value of the source frequency profile in the subband and indicates a minimum masking level. Such a threshold may also be based on estimates of psychoacoustic factors such as, for example, tonality of the source signal (and/or of the noise signal) in the subband, masking effect of the noise signal on adjacent subbands, and a threshold of hearing in the subband. Calculation of a subband masking threshold may be performed, for example, as described in Psychoacoustic Model 1 or 2 of the MPEG-1 standard (ISO/IEC, JTC1/SC29/WG11MPEG, “Information technology-Coding of moving pictures and associated audio for digital storage media at up to about 1.5 Mbit/s-Part 3: Audio,” IS11172-3 1992). Additionally or alternatively, it may be desirable to implement task TC150 to calculate the masking target levels according to a loudness weighting function or other perceptual response function, such as an A-weighting curve.

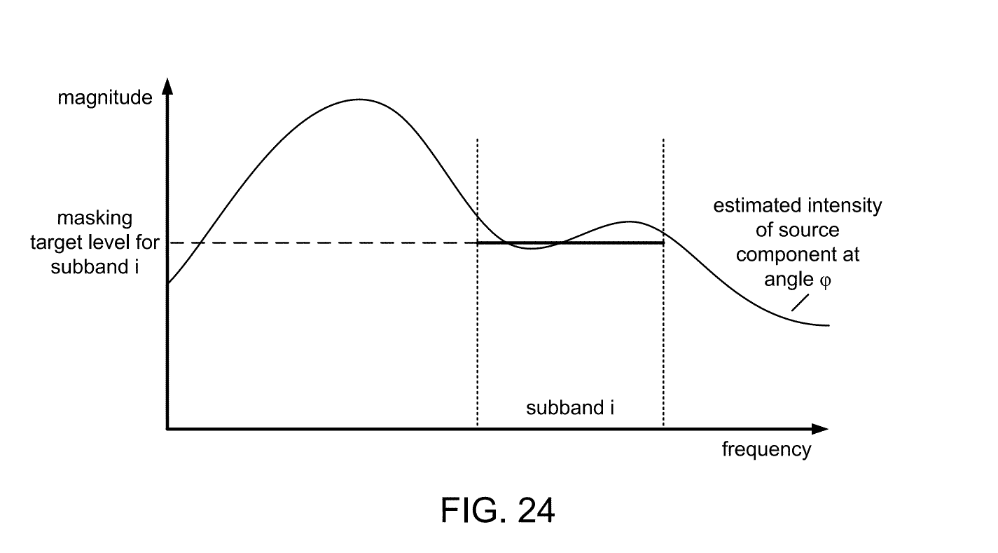

FIG. 24 shows an example of a plot of estimated intensity of the source component in a non-source direction φ (e.g., in the leakage direction) with respect to frequency. In this example, task TC150 is implemented to calculate a masking target level for subband i according to the estimated intensity in subband i (e.g., as a masking threshold as described above).

It may be desirable for method M100 to produce the sound field to have a spectrum that is noise-like in one or more directions outside the privacy zone (e.g., in one or more directions other than the user's direction, such as a leakage direction). For example, it may be desirable for these regions of the combined sound field to have a white-noise distribution (i.e., equal energy per frequency), a pink-noise distribution (i.e., equal energy per octave), or another noise distribution, such as a perceptually weighted noise distribution. In such cases, task TC150 may be implemented to calculate, for at least some of the plurality of frequencies, a masking target level that is based on a masking target level for at least one other frequency.

For a combined sound field that is noise-like in a leakage direction, task T200 may be implemented to select or filter the noise signal to have a spectrum that is complementary to that of the source signal with respect to a desired intensity of the combined sound field. For example, task T200 may be implemented to produce the masking signal such that a change in the level of the noise signal from a first frequency to a second frequency is opposite in direction (e.g., is inverse) to a change in the level of the source signal from the first frequency to the second frequency (e.g., as indicated by the source frequency profile).

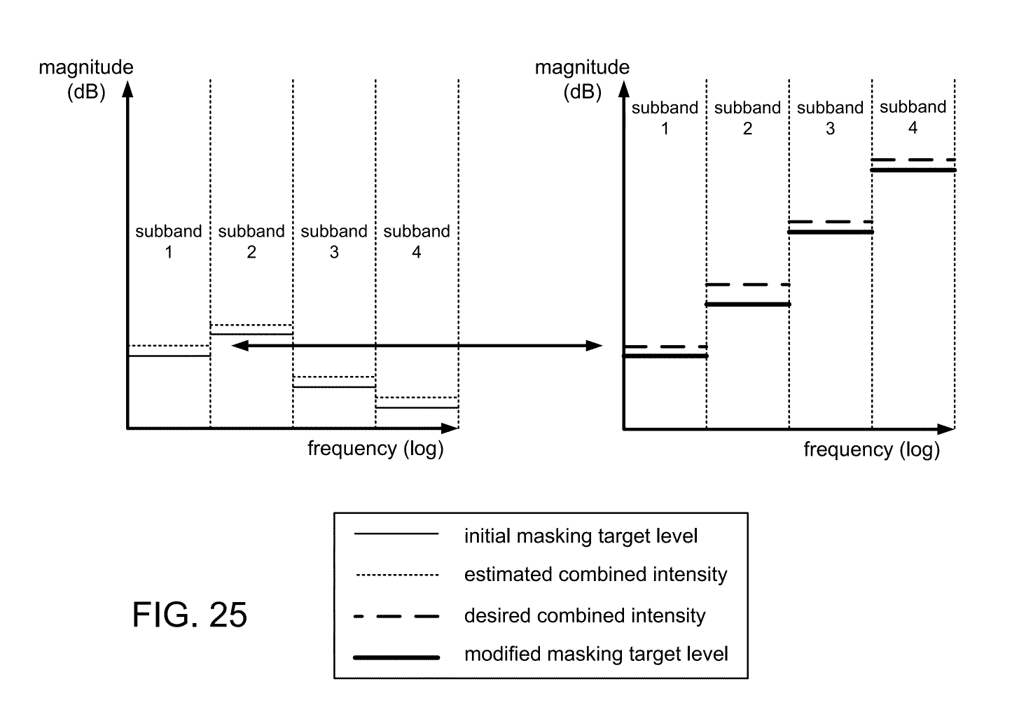

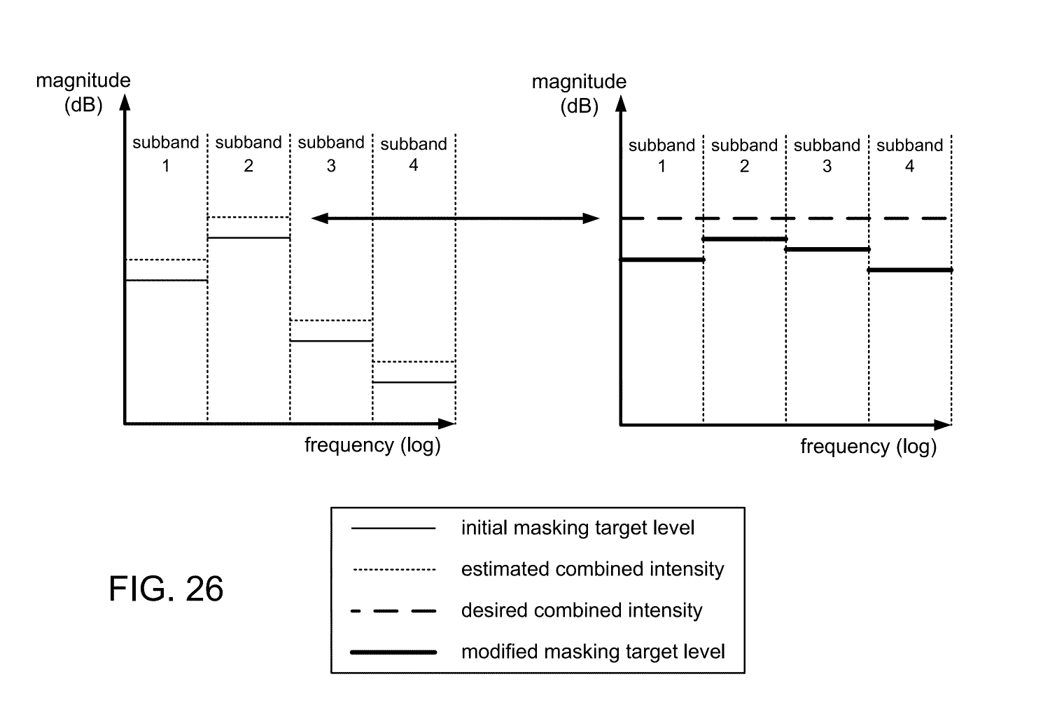

FIGS. 25 and 26 show two such examples for a four-subband octave-band configuration and an implementation of task T230 in which the source frequency profile indicates a level of the source signal at each subband and the masking frequency profile includes a masking target level for each subband. In the example of FIG. 25, the masking target levels are modified to produce a sound field having a white noise profile (e.g., equal energy per frequency) in the leakage direction. The plot on the left shows the initial values of the masking target levels for each subband, which may be based on corresponding masking thresholds. As noted above, these masking levels or masking thresholds may be based in turn on levels of the source signal in corresponding subbands, as indicated by the source frequency profile. This plot also shows an estimated combined intensity for each subband, which may be calculated as a sum of the corresponding masking target level and the corresponding estimated intensity of the source component in the leakage direction (e.g., both in dB).

In this case, task TC150 may be implemented to calculate a desired combined intensity of the sound field in the leakage direction for subband i as a product of (A) the bandwidth of subband i and (B) the maximum, over all subbands j, of the estimated combined intensity of subband j as normalized by the bandwidth of subband j. Such a calculation may be performed, for example, according to an expression such as

$${DCI}_{i} = [ {max}_{j} ( \frac{{ECI}_{j}}{{BW}_{j}} ) ] \times {BW}_{i} ,$$

where DCIᵢ denotes the desired combined intensity for subband i, ECIⱼ denotes the estimated combined intensity for subband j, and BWᵢ and BWⱼ, denote the bandwidths of subbands i and j, respectively. In the particular example of FIG. 25, the maximum is established by the level in subband 1. Such an implementation of TC150 also calculates a modified masking target level for each subband i as a product of the desired combined intensity, as normalized by the corresponding bandwidth, and the bandwidth of subband i. The plot on the right of FIG. 25 shows the desired combined intensity and the modified masking target level for each subband.

In the example of FIG. 26, the masking target levels are modified to produce a sound field having a pink noise profile (e.g., equal energy per octave) in the leakage direction. The plot on the left shows the initial values of the masking target levels for each subband, which may be based on corresponding masking thresholds. This plot also shows an estimated combined intensity for each subband, which may be calculated as a sum of the corresponding masking target level and the corresponding estimated intensity of the source component in the leakage direction (e.g., both in dB).

In this case, task TC150 may be implemented to determine the desired combined intensity of the sound field in the leakage direction for each subband as a maximum of the estimated combined intensities, as shown in the plot on the right, and to calculate a modified masking target level for each subband (for example, as the difference between the corresponding desired combined intensity and the corresponding estimated intensity of the source component in the leakage direction). For other subband division schemes (e.g., a third-octave scheme or a critical-band scheme), calculation of a desired combined intensity for each subband, and calculation of a modified masking target level for each subband, may include a suitable bandwidth compensation.

As shown in the examples of FIGS. 25 and 26, it may be desirable to implement task TC150 to calculate the masking target levels to be just high enough to achieve the desired sound-field profile, although implementations that use higher masking target levels to achieve the desired sound-field profile are also within the scope of this description.

It may be desirable to configure task T200 according to a detected use case (e.g., as indicated by a current mode of operation of the device and/or by the nature of the module from which the source signal is received). For example, a combined sound field that resembles white noise in a leakage direction may be more effective at concealing speech within the source signal, so for a communications use (e.g., when the device is engaged in a telephone call), it may be desirable for task T230 to use a white-noise spectral profile (e.g., as shown in FIG. 25) for better privacy. A combined sound field that resembles pink noise may be more pleasant to bystanders, so for entertainment uses (e.g., when the device is engaged in media playback), it may be desirable for task T230 to use a pink-noise spectral profile (e.g., as shown in FIG. 26) to reduce the impact on the ambient environment. In another example, method M130 is implemented to perform a voice activity detection (VAD) operation on the source signal (e.g., based on zero crossing rate) to distinguish speech signals from non-speech (e.g., music) signals and to use this information to select a corresponding masking frequency profile.

In a further example, it may be desirable to implement task TC150 to calculate the desired combined intensities according to a noise profile that varies over time. Such alternative noise profiles include babble noise, street noise, and car interior noise. For example, it may be desirable to select a noise profile according to (e.g., to match) a detected ambient noise profile.

Based on the masking frequency profile, task TC210 calculates a corresponding gain factor value for each subband. For example, it may be desirable to calculate the gain factor value to be high enough for the intensity of the masking component in the subband to meet the corresponding masking target level in the leakage direction. It may be desirable to implement task TC210 to calculate the gain factor values according to a loudness weighting function or other perceptual response function, such as an A-weighting curve.

Tasks TC150 and/or TC210 may be implemented to account for a dependence of the source frequency profile on the source direction, a dependence of the masking frequency profile on the masking direction, and/or a frequency dependence in a response of the audio output path (e.g., in a response of the loudspeaker array). In another example, task TC210 is implemented to modulate the values of the gain factor for one or more (possibly all) of the subbands over time according to a rhythmic pattern (e.g., at a frequency of from 0.1 Hz to 3 Hz, which modulation frequency may be fixed or may be adaptive) as described above.

Task TC200 may be configured to produce the masking signal by applying corresponding gain factor values to different frequency components of the noise signal. Task TC200 may be configured to produce the masking signal by using a subband filter bank to shape the noise signal according to the masking frequency profile. In one example, such a subband filter bank is implemented as a cascade of biquad peaking filters. The desired gain at each subband may be obtained in this case by modifying the filter transfer function with an offset that is based on the corresponding gain factor. Such a modified transfer function for each subband i may be expressed as follows:

$${H}_{i} ( z ) = \frac{( {b}_{0} ( i ) + {g}_{i} ) + {b}_{1} ( i ) {z}^{- 1} + ( {b}_{2} ( i ) - {g}_{i} ) {z}^{- 2}}{1 + {a}_{1} ( i ) {z}^{- 1} + {a}_{2} ( i ) {z}^{- 2}}$$

where the values of a₁(i) and a₂(i) are selected to define subband i, b₀(i) is equal to one, the values of a₁(i) and b₁(i) are equal, the values of a₂(i) and b₂(i) are equal, and g, denotes the corresponding offset.

Offset g, may be calculated from the corresponding gain factor (e.g., based on a masking target level mᵢ for subband i, as described above with reference to FIGS. 25 and 26) according to an expression such as:

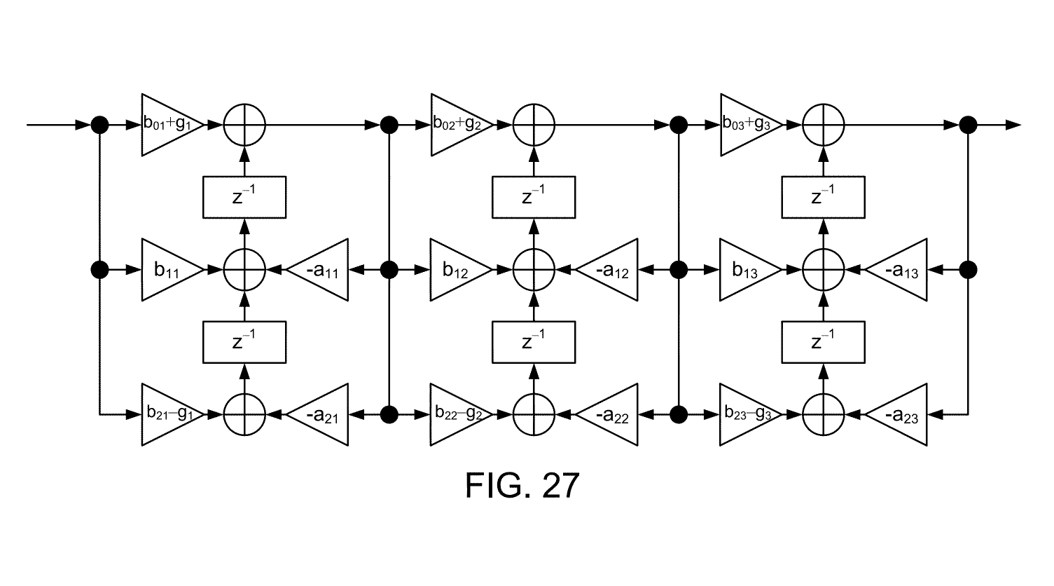

gᵢ=(1−a₂(i))(10^{m}^{ᵢ}²⁰−1)/2 or gᵢ=(1−a₂(i))(10^{m}^{ᵢ}²⁰−1)cᵢ,

where mᵢ is the masking signal level for subband i (in decibels) and cᵢ is a normalization factor having a value less than one. Factor cᵢ may be tuned such that the desired gain is achieved, for example, at the center of the subband. FIG. 27 shows an example of a cascade of three biquad peaking filters, in which each filter is configured to apply a current value of a respective gain factor to the corresponding subband.

The subband division scheme used in task TC200 may be any of the schemes described above with reference to task T400 (e.g., uniform or nonuniform; transcendental or logarithmic; octave, third-octave, or critical band or ERB; with four, six, seven, or more subbands, such as seventeen or twenty-three subbands). Typically the same subband division scheme is used for noise synthesis in task TC200 as for source analysis in T400, and the same filters may even be used for the two tasks, although for analysis the filters are typically arranged in parallel rather than in serial cascade.

It may be desirable to implement task T200 to generate the masking signal such that levels of each of a time-domain characteristic and a frequency-domain characteristic are based on levels of a corresponding characteristic of the source signal (e.g., as described herein with reference to implementations of task T230). Other implementations of task T200 may use results from analysis of the source signal in another domain, such as an LPC domain, a wavelet domain, and/or a cepstral domain. For example, task T200 may be implemented to perform a multiresolution analysis (MRA), a mel-frequency cepstral coefficient (MFCC) analysis, a cascade time-frequency linear prediction (CTFLP) analysis, and/or an analysis based on other psychoacoustic principles, on the source signal for use in generating an appropriate masking signal. Task T200 may perform voice activity detection (VAD) such that the source characteristics include an indication of presence or absence of voice activity (e.g., for each frame of the source signal).

In another example, task T200 is implemented to generate the masking signal based on at least one entry that is selected from a database of noise signals or noise patterns according to one or more characteristics of the source signal. For example, task T200 may be implemented to use such a source characteristic to select configuration parameters for a noise signal from a noise pattern database. Such configuration parameters may include a frequency profile and/or a temporal profile. Characteristics that may be used in addition to or in the alternative to those source characteristics noted herein include one or more of: sharpness (center frequency and bandwidth), roughness and/or fluctuation strength (modulation frequency and depth), impulsiveness, tonality (proportion of loudness that is due to tonal components), tonal audibility, tonal multiplicity (number of tones), bandwidth, and N percent exceedance level. In this example, task T200 may be implemented to generate the noise signal using an entry from a database of stored PCM samples by performing a technique such as, for example, wavetable synthesis, granular synthesis, or graintable synthesis. In such cases, task TC210 may be implemented to calculate the gain factors based on one or more characteristics (e.g., energy) of the selected or generated noise signal.

In a further example, task T200 is implemented to generate the noise signal from the source signal. Such an implementation of task T200 may generate the noise signal by rearranging frames of the source signal into a different sequence in time, by calculating an average frame from multiple frames of the source signal, and/or by generating frames from parameter values extracted from frames of the source signal (e.g., pitch frequency and/or LP filter coefficients).

The source component may have a frequency distribution that differs from one direction to another. Such variations may arise from task T100 (e.g., from the operation of applying a source spatially directive filter to generate the source component). Such variations may also arise from the response of the audio output stage and/or loudspeaker array. It may be desirable to produce the masking component according to an estimation of frequency- and direction-dependent variations in the source component.

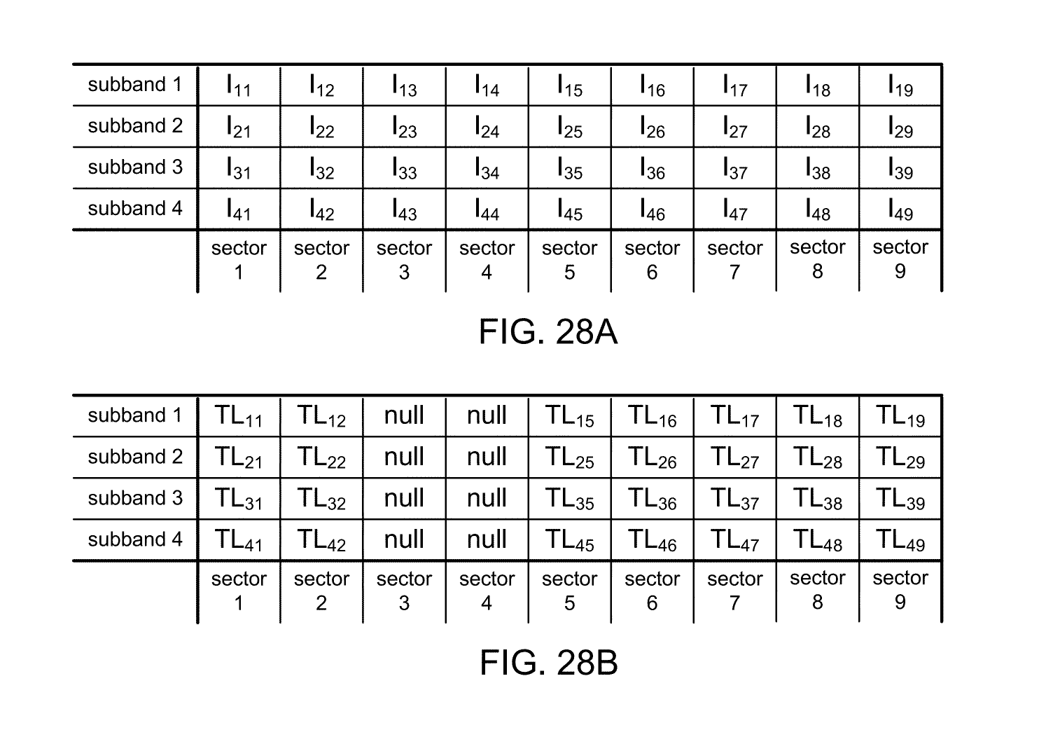

Task T200 may be implemented to produce a map of estimated intensity of the source component across a range of spatial directions relative to the array, and to produce the masking signal based on this map. It may also be desirable for the map to indicate changes in the estimated intensity across a range of frequencies. Such a map may be implemented to have a desired resolution in the frequency and direction domains. In the direction domain, for example, the map may have a resolution of five, ten, twenty, or thirty degrees over a 180-degree range. In the frequency domain, the map may have a set of direction-dependent values for each subband. FIG. 28A shows an example of such a map of estimated intensity that includes a value Iᵢⱼ for each pair of one of four subbands i and one of nine twenty-degree sectors j.

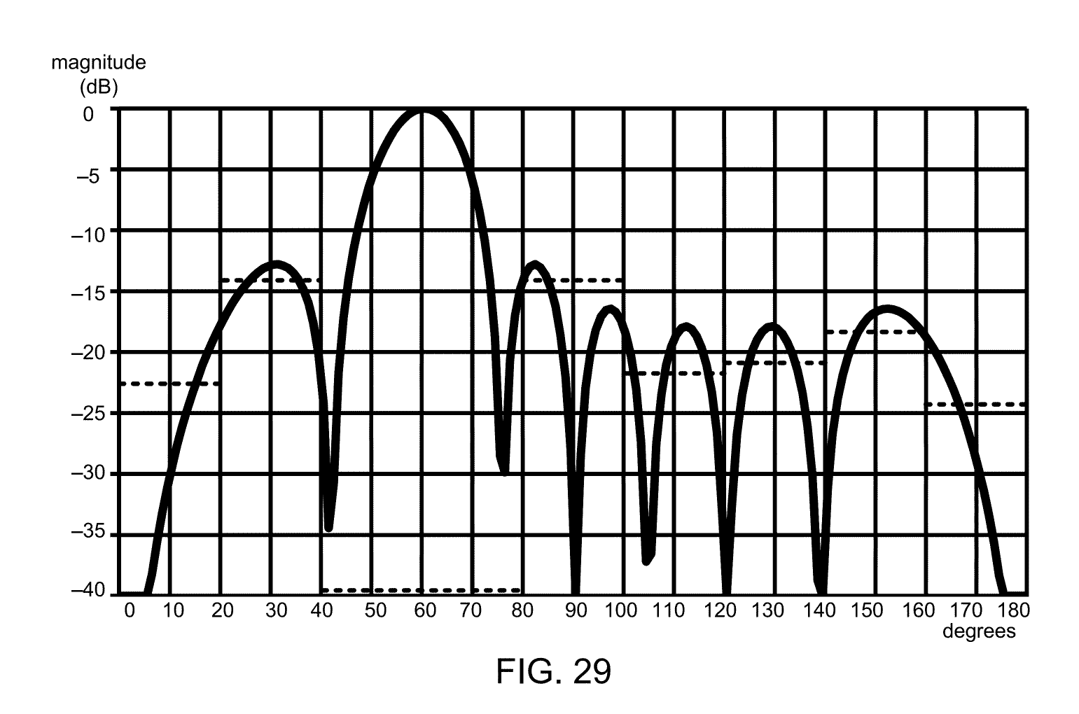

Task TC150 may be implemented to calculate the masking target levels according to such a map of estimated intensity of the source component. FIG. 28B shows one example of a table produced by such an implementation of task TC150, based on the map of FIG. 28A, that indicates a masking target level for each frequency and direction. FIG. 29 shows a plot of the estimated intensity of the source component in one of the subbands for this example (i.e., corresponding to source data for one row of the table in FIG. 28A), where the source direction is sixty degrees relative to the array axis and the dashed lines indicate the corresponding masking target levels for each twenty-degree sector (i.e., from the corresponding row of FIG. 28B). For sectors 3 and 4, the masking target levels in this example indicate a null for all subbands.

Task TC200 may be implemented to use the masking target levels to select and/or to shape the noise signal. In a frequency-domain implementation, task TC200 may select a different noise signal for each of two or more (possibly all) of the subbands. For example, such an implementation of task TC200 may select, from among a plurality of noise signals or patterns, the signal or pattern that best matches the masking target levels for the subband (e.g., in a least-squares-error sense). In a time-domain implementation, task TC200 may select the masking spatially directive filter from among two or more different pre-calculated filters. For example, such an implementation of task TC200 may use the masking target levels to select a suitable masking spatially directive filter, and then to select and/or filter the noise signal to reduce remaining differences between the masking target levels and the response of the selected filter. In either domain, task TC200 may also be implemented to select a different masking spatially selective filter for each of two or more (possibly all) of the subbands, based on a best match (e.g., in a least-squares-error sense) between an estimated response of the filter and the masking target levels for the corresponding subband or subbands.

Method M100 may be used in any of a wide variety of different applications. For example, method M100 may be used to reproduce the far-end communications signal in a two-way voice communication, such as a telephone call. In such a case, a primary concern may be to protect the privacy of the user (e.g., by obscuring the sidelobes of the source component).

It may be desirable for the device to activate a privacy masking mode in response to an incoming and/or an outgoing telephone call. Such a device may be implemented such that when the user is in a private phone call, the input source signal is assumed to be a sparse speech signal (e.g., sparse in time and frequency) carrying an important message. In such case, task T200 may be configured to generate a masking signal whose spectrum is complementary to the spectrum of the input source signal (e.g., just enough noise to fill in spectral valleys of the speech itself), so that nearby people in the dark zone hear a “white” spectrum of sound, and the privacy of the user is protected. In an alternative phone-call scenario, task T200 generates the masking signal as babble noise whose level just enough to satisfy the masking frequency profile (e.g., the subband masking thresholds).

In another use case, the device is used to reproduce a recorded or streamed media signal, such as a music file, a broadcast audio or video presentation (e.g., radio or television), or a movie or video clip streamed over the Internet. In this case, privacy may be less important, and it may be desirable for the device to operate in a polite masking mode. For example, it may be desirable to configure task T200 such that the combined sound field will be less distracting to a bystander than the unmasked source component by itself (e.g., by having a substantially constant level over time in the direction of the masking component). A media signal may have a greater dynamic range and/or may be less sparse over time than a voice communications signal. Processing delays may also be less problematic for a media signal than for a voice communications signal.

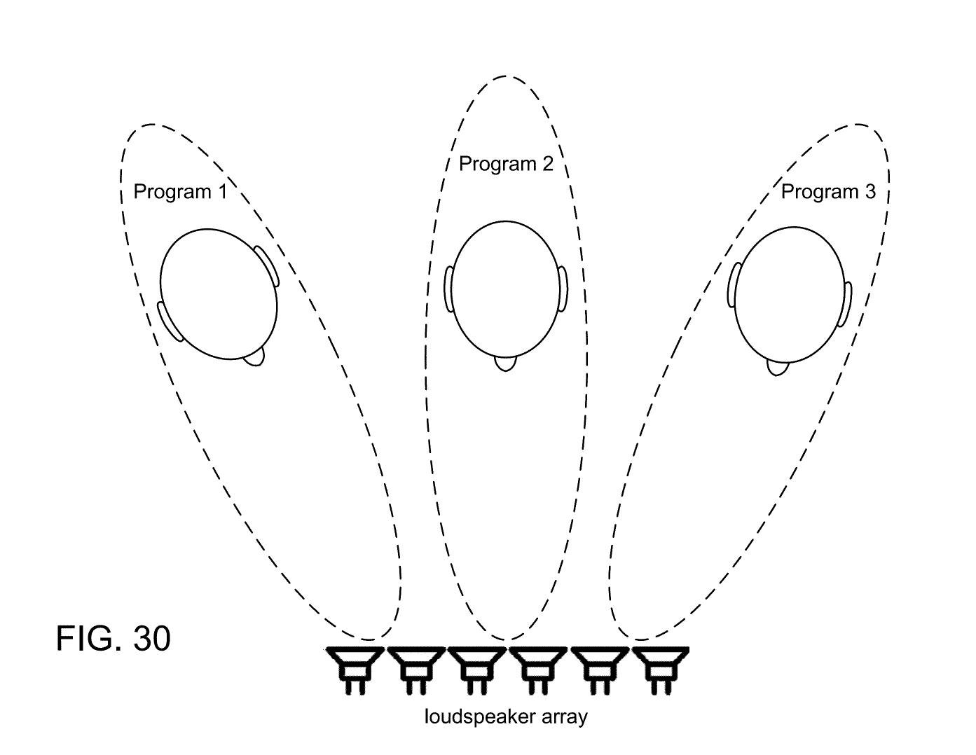

Method M100 may also be implemented to drive a loudspeaker array to generate a sound field that includes more than one source component. FIG. 30 shows an example of such a multi-source use case in which a loudspeaker array (e.g., array LA100) is driven to generate several source components simultaneously. In this case, each of the source components is based on a different source signal and is directed in a different respective direction.

In one example of a multi-source use case, method M100 is implemented to generate source components that include the same audio content in different natural (e.g., spoken) languages. Typical applications for such a system include public address and/or video billboard installations in public spaces, such as an airport or railway station or another situation in which a multilingual presentation may be desired. For example, such a case may be implemented so that the same video content on a display screen is visible to each of two or more users, with the loudspeaker array being driven to provide the same accompanying audio content in different languages (e.g., two or more of English, Spanish, Chinese, Korean, French, etc.) at different respective viewing angles. Presentation of a video program with simultaneous presentation of the accompanying audio content in two or more languages may also be desirable in smaller settings, such as a home or office.

In another example of a multi-source use case, method M100 is implemented to generate source components having unrelated audio content into different respective directions. For example, each of two or more of the source components may carry far-end audio content for a different voice communication (e.g., telephone call). Alternatively or additionally, each of two or more of the source components may include an audio track for a different respective media reproduction (e.g., music, video program, etc.).

For a case in which different source components are associated with different video content, it may be desirable to display such content on multiple display screens and/or with a multiview-capable display screen. One example of a multiview-capable display screen is configured to display each of the video programs using a different light polarization (e.g., orthogonal linear polarizations, or circular polarizations of opposite handedness), and each viewer wears a set of goggles that is configured to pass light having the polarization of the desired video program and to block light having other polarizations. In another example of a multiview-capable display screen, a different video program is visible at least of two or more viewing angles. In such a case, method M100 may be implemented to direct the source component for each of the different video programs in the direction of the corresponding viewing angle.

In a further example of a multi-source use case, method M100 is implemented to generate two or more source components that include the same audio content in different natural (e.g., spoken) languages and at least one additional source component having unrelated audio content (e.g., for another media reproduction and/or for a voice communication).

For a case in which multiple source signals are supported, each source component may be oriented in a respective direction that is fixed (e.g., selected, by a user or automatically, from among two or more fixed options), as described herein with reference to task T100. Alternatively, each of at least one (possibly all) of the source components may be oriented in a respective direction that may vary over time in response to changes in an estimated direction of a corresponding user. Typically it is desirable to implement independent direction control for each source, such that each source component or beam is steered independently of the other(s) (e.g., by a corresponding instance of task T100).

In a typical multi-source application, it may be desirable to provide about thirty or forty to sixty degrees of separation between the directions of orientation of adjacent source components. One typical application is to provide different respective source components to each of two or more users who are seated shoulder-to-shoulder (e.g., on a couch) in front of the loudspeaker array. At a typical viewing distance of 1.5 to 2.5 meters, the span occupied by a viewer is about thirty degrees. With an array of four microphones, a resolution of about fifteen degrees may be possible. With an array having more microphones, a more narrow beam may be obtained.

As for a single-source case, privacy may be a concern for multi-source cases, especially if at least one of the source signals is a far-end voice communication (e.g., a telephone call). For a typical multiple-source case, however, leakage of one source component to another may be a greater concern, as each source component is potentially an interferer to other source components being produced at the same time. Accordingly, it may be desirable to generate a source component to have a null in the direction of another source component. For example, each source beam may be directed to a respective user, with a corresponding null being generated in the direction of each of one or more other users. Such design will typically cope with a “waterbed” effect, as the energy suppressed by creating a null on one side of a beam is likely to re-emerge as a sidelobe on the other side. The beam and null (or nulls) of a source component may be designed together or separately. It may be desirable to direct two or more narrow nulls of a source component next to each other to obtain a broader null.

In a multiple-source application, it may be desirable for the system to treat any source component as a masker to other source components being generated at the same time. In one example, the levels and/or spectral equalizations of each source signal are dynamically adjusted according to the signal contents, so that the corresponding source component functions as a good masker to other source components.

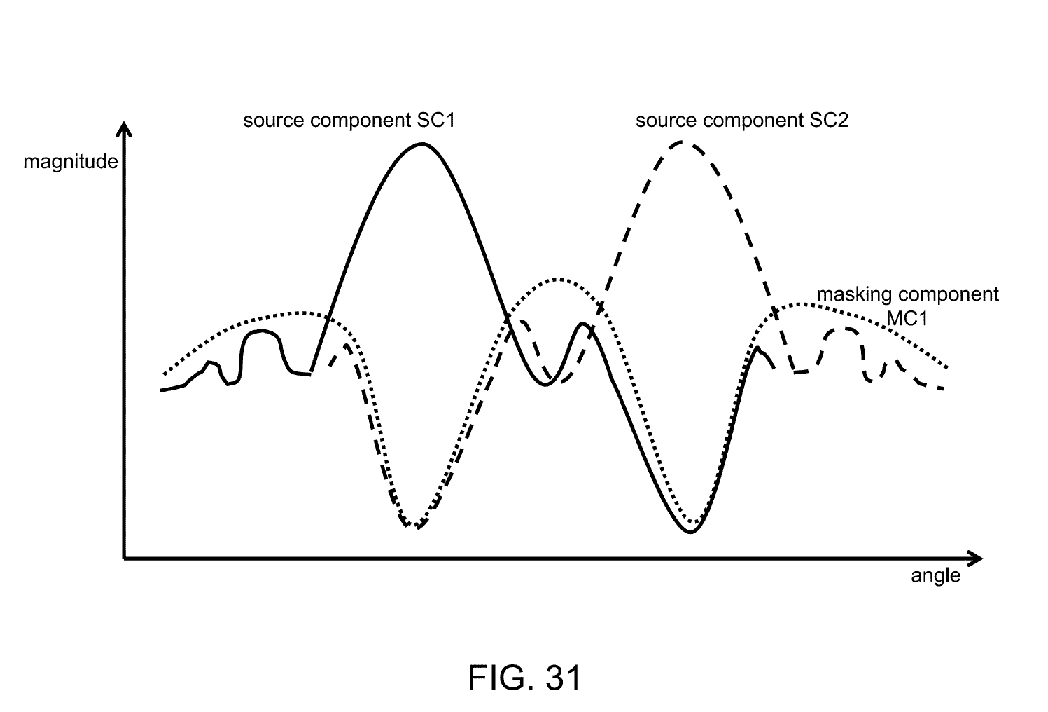

In a multi-source case, method M100 may be implemented to combine beamforming (and possibly nullforming) of the source signals with generation of one or more masking components. Such a masking component may be designed according to the spatial distributions of the source component or components to be masked, and it may be desirable to design the masking component or components to minimize disturbance to bystanders and/or users enjoying other source components at adjacent locations. FIG. 31 shows a plot of an example of a combination of a source component SC1 oriented in the direction of a first user (solid line) and having a null in the direction of a second user, a source component SC2 oriented in the direction of the second user (dashed line) and having a null in the direction of the first user, and a masking component MC1 (dotted line) having a beam between the source components and at each side and a null in the direction of each user. Such a combination may be implemented to provide a privacy zone for each respective user (e.g., within the limitations of the loudspeaker array).

As shown in FIG. 31, a masking component may be directed between and/or outside of the main lobes of the source components. Method M100 may be implemented to generate such a masking component based on a spatial distribution of more than one source component. Depending on such factors as the available degrees of freedom (as determined, e.g., by the number of loudspeakers in the array), method M100 may also be implemented to generate two or more masking components. In such case, each masking component may be based on a different source component.

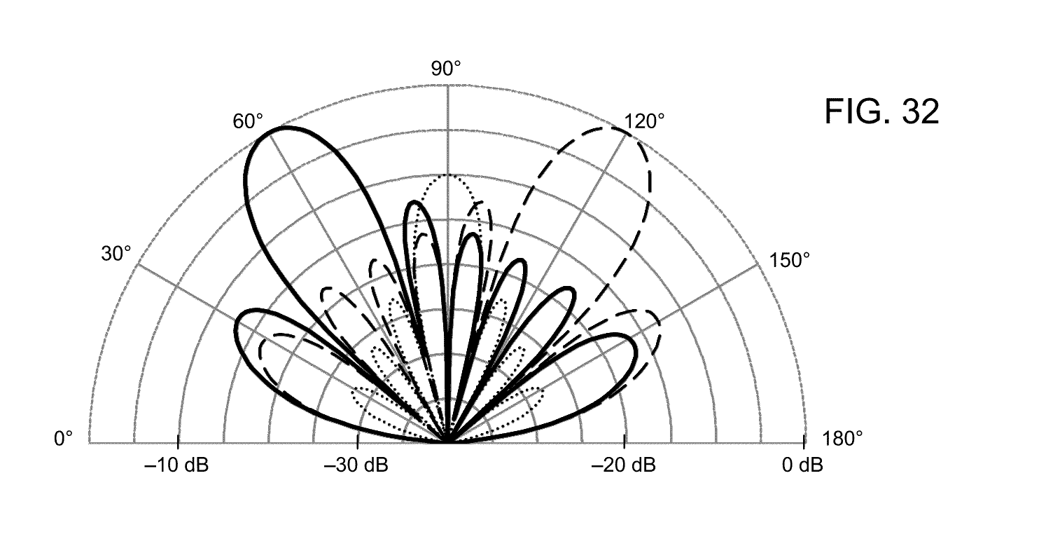

FIG. 32 shows an example of a beam pattern of a DSB filter (solid line) for driving an eight-element array to produce a first source component. In this example, the orientation angle of the filter (i.e., angle φₛ₁) is sixty degrees. FIG. 32 also shows an example of a beam pattern of a DSB filter (dashed line) for driving the eight-element array to produce a second source component. In this example, the orientation angle of the filter (i.e., angle φₛ₂) is 120 degrees. FIG. 32 also shows an example of a beam pattern of a DSB filter (dotted line) for driving the eight-element array to produce a masking component. In this example, the orientation angle of the filter (i.e., angle φₘ) is 90 degrees, and the peak level of the masking component is ten decibels less than the peak levels of the source components.

It may be desirable to implement method M100 to adapt the direction of the source component, and/or the direction of the masking component, in response to changes in the location of the user. For a multiple-user case, it may be desirable to implement method M100 to perform such adaptation individually for each of two or more users. In order to determine the respective source and/or masking directions, such a method may be implemented to perform user tracking.

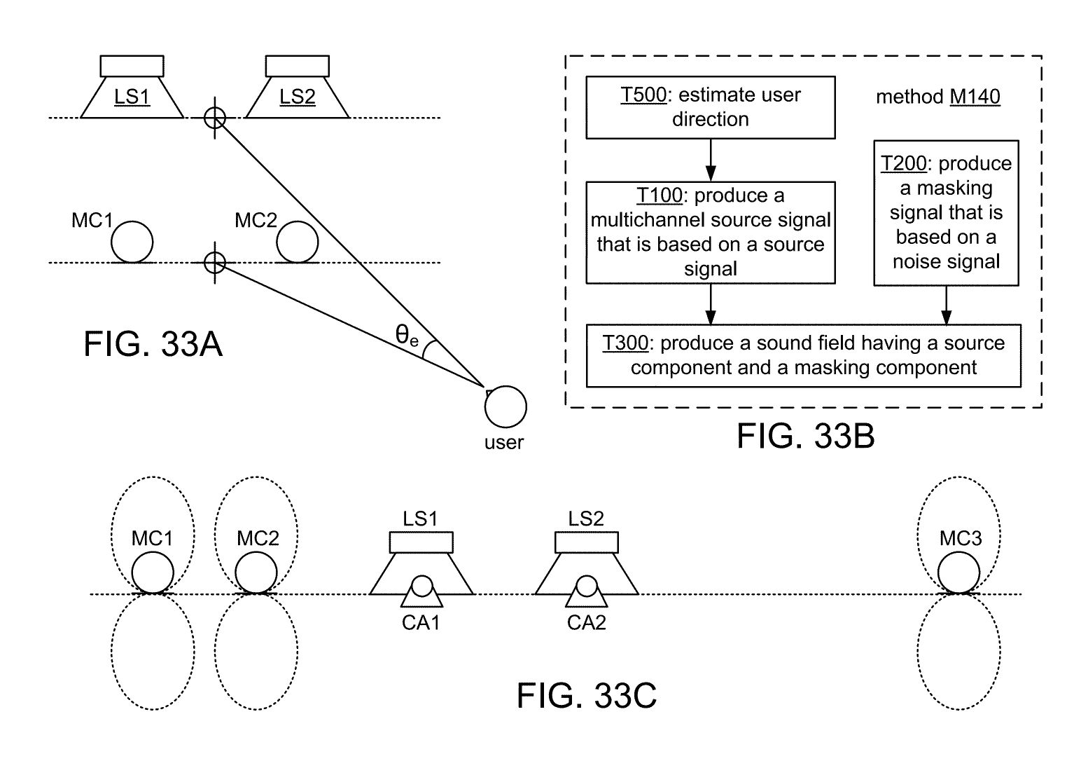

FIG. 33B shows a flowchart of an implementation M140 of method M100 that includes a task T500, which estimates a direction of each of one or more users (e.g., relative to the loudspeaker array). Any among methods A110, M120, and M130 may be realized as an implementation of method M140 (e.g., including an instance of task T500 as described herein). Task T500 may be configured to perform active user tracking by using, for example, radar and/or ultrasound. Additionally or alternatively, such a task may be configured to perform passive user tracking based on images from a camera (e.g., an optical, infrared, and/or stereoscopic camera). For example, such a task may include face tracking and/or user recognition.

Additionally or in the alternative, task T500 may be configured to perform passive tracking by applying a multi-microphone speech tracking algorithm to a multichannel sound signal produced by a microphone array (e.g., in response to sound emitted by the user or users). Examples of multi-microphone approaches to localization of one or more sound sources include directionally selective filtering operations, such as beamforming (e.g., filtering a sensed multichannel signal in parallel with several beamforming filters that are each fixed in a different direction, and comparing the filter outputs to identify the direction of arrival of the speech), blind source separation (e.g., independent component analysis, independent vector analysis, and/or a constrained implementation of such a technique), and estimating direction-of-arrival by comparing differences in level and/or phase between a pair of channels of the multichannel microphone signal. Such a task may include performing an echo cancellation operation on the multichannel microphone signal to block sound components that were produced by the loudspeaker array and/or performing a voice recognition operation on at least one channel of the multichannel microphone signal.

For accurate tracking results, it may be desirable for the microphone array (or other sensing device) to be aligned in space with the loudspeaker array in a reciprocal arrangement. In an ideally reciprocal arrangement, the direction to a point source P as indicated by a sensing device (e.g., a microphone array and associated tracking logic) is the same as the source direction used to direct a beam from the loudspeaker array to the point source P. A reciprocal arrangement may be used to create the privacy zones (e.g., by beamforming and nullforming) at the actual locations of the users. If the sensing and emitting arrays are not arranged reciprocally, the accuracy of creating a beam or null for designated source locations may be unacceptable. The quality of the null especially may suffer from such a mismatch, as a nullforming operation typically requires a higher level of accuracy than a comparable beamforming operation.

FIG. 33A shows a top view of a misaligned arrangement of a sensing array of microphones MC1, MC2 and an emitting array of loudspeakers LS1, LS2. For each array, the crosshair indicates the reference point with respect to which the angle between source direction and array axis is defined. In this example, error angle θₑ should be equal to zero for perfect reciprocity. To be reciprocal, the axis of at least one microphone pair should be aligned with and close enough to the axis of the loudspeaker array.

FIG. 33C shows an example of a multi-sensory reciprocal arrangement of transducers that may be used for beamforming and nullforming. In this example, the array of microphones MC1, MC2, MC3 is arranged along the same axis as the array of loudspeakers LS1, LS2. Feedback (e.g., echo) may arise if the microphones and loudspeakers are in close proximity, and it may be desirable for each microphone to have a minimal response in a side direction and to be located at some distance from the loudspeakers (e.g., within a far-field assumption). In this example, each microphone has a figure-eight gain response pattern that is concentrated in a direction perpendicular to the axis. The subarray of closely spaced microphones MC1 and MC2 has directional capability at high frequencies, due to a high spatial aliasing frequency. The subarrays of microphones MC1, MC3 and MC2, MC3 have directional capability at lower frequencies, due to a larger microphone spacing. This example also includes stereoscopic cameras CA1, CA2 in the same locations as the loudspeakers, because of the much shorter wavelength of light. Such close placement is possible with the cameras because echo is not a problem between the loudspeakers and cameras.

With an array of many microphones, a narrow beam may be produced. With a four-microphone array, for example, a resolution of about fifteen degrees is possible. For a typical television viewing distance of two meters, a span of fifteen degrees corresponds to a shoulder-to-shoulder width, and a span of thirty degrees corresponds to a typical angle between the directions of adjacent users seated on a couch. A typical application is to provide forty to sixty degrees between the directions of adjacent source beams.

It may be desirable to direct two or more narrow nulls together to obtain a broad null. The beam and nulls may be designed together or separately. Such design will typically cope with a “waterbed” effect, as creating a null on one side is likely to create a sidelobe on the other side.

As described above, it may be desirable to implement method M100 to support privacy zones for multiple listeners. In such an implementation of method M140, task T500 may be implemented to track multiple users. Multiple source beams may be directed to respective users, with corresponding nulls being generated in other user directions.

Any beamforming method may be used to estimate the direction of each of one or more users as described above. For example, a reciprocal implementation of a method used to generate the source and/or masking components may be applied.

For a one-dimensional (1-D) array of microphones, a direction of arrival (DOA) for a source may be easily defined in a range of, for example, −90° to 90°. For an array that includes more than two microphones at arbitrary relative locations (e.g., a non-coaxial array), it may be desirable to use a straightforward extension of one-dimensional principles as described above, e.g. (θ1, θ2) in a two-pair case in two dimensions; (θ1, θ2, θ3) in a three-pair case in three dimensions, etc. A key problem is how to apply spatial filtering to such a combination of paired 1-D DOA estimates.

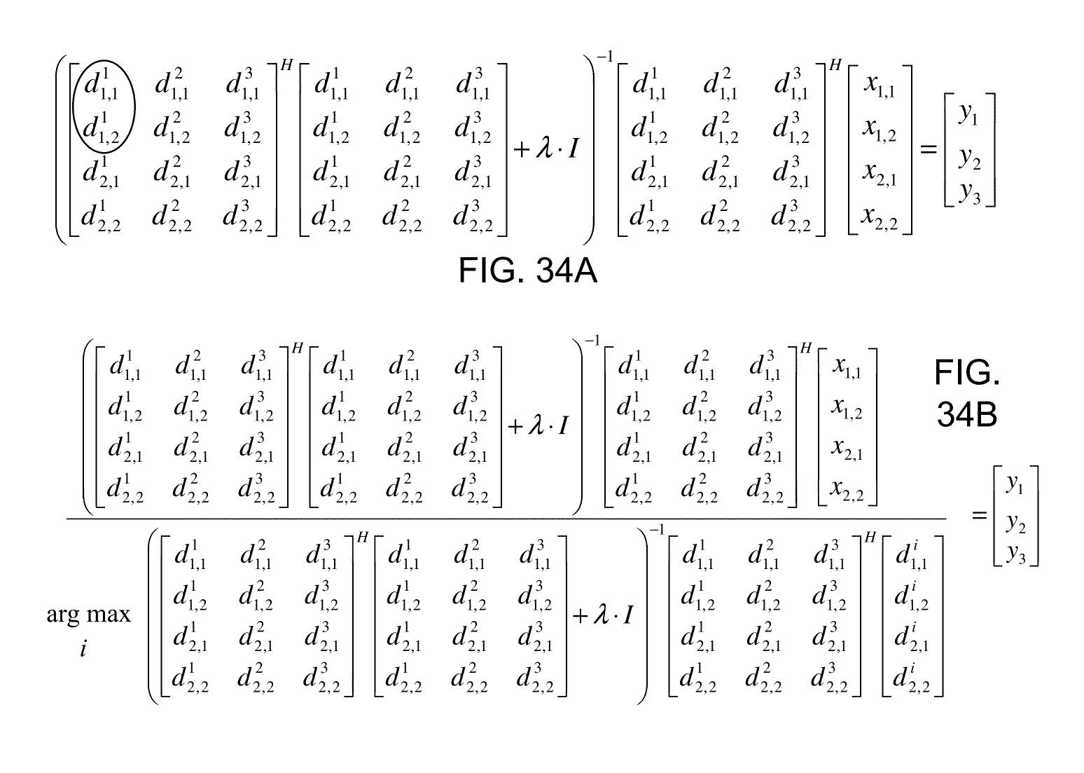

FIG. 34A shows an example of a straightforward one-dimensional (1-D) pairwise beamforming-nullforming (BFNF) configuration that is based on robust 1-D DOA estimation. In this example, the notation d_{i,j}^{k} denotes microphone pair number i, microphone number j within the pair, and source number k, such that each pair [d_{i,1}^{k} d_{i,2}^{k}]^{T} represents a steering vector for the respective source and microphone pair (the ellipse indicates the steering vector for source 1 and microphone pair 1), and λ denotes a regularization factor. The number of sources is not greater than the number of microphone pairs. Such a configuration avoids a need to use all of the microphones at once to define a DOA.

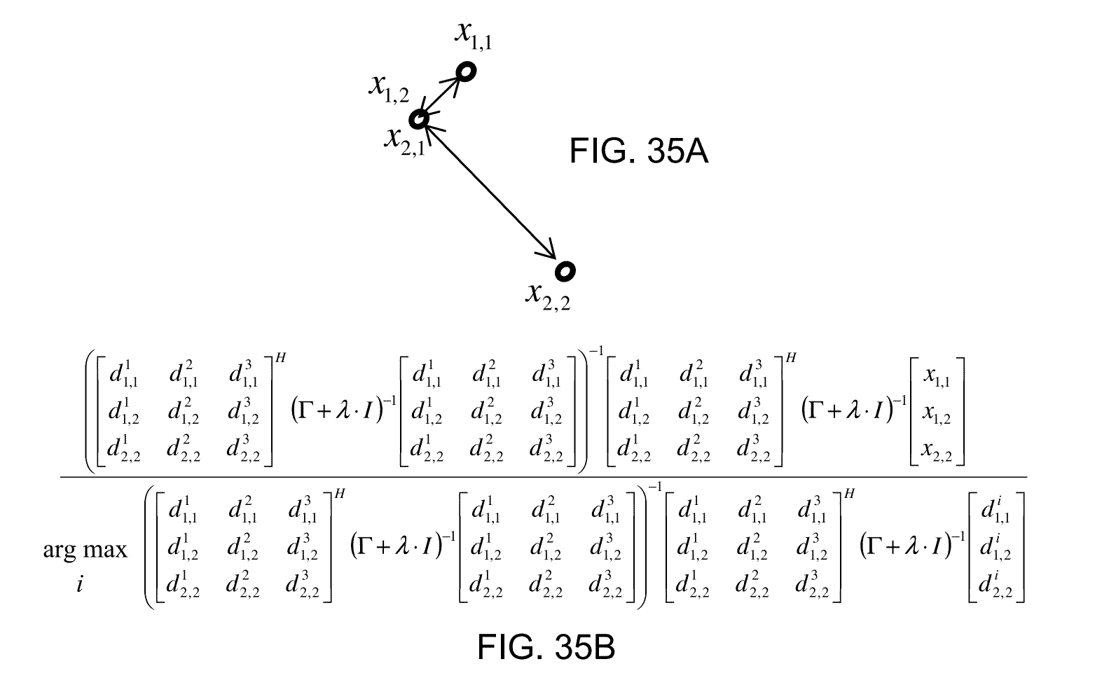

We may apply a beamformer/null beamformer (BFNF) as shown in FIG. 34A by augmenting the steering vector for each pair. In this figure, A^{H} denotes the conjugate transpose of A, x denotes the microphone channels, and y denotes the spatially filtered channels. Using a pseudo-inverse operation A⁺=(A^{H}A)⁻¹A^{H} as shown in FIG. 34A allows the use of a non-square matrix. For a three-microphone case (i.e., two microphone pairs) as illustrated in FIG. 35A, for example, the number of rows 2×2=4 instead of 3, such that the additional row makes the matrix non-square.

As the approach shown in FIG. 34A is based on robust 1-D DOA estimation, complete knowledge of the microphone geometry is not required, and DOA estimation using all microphones at the same time is also not required. FIG. 34B shows an example of the BFNF of FIG. 34A that also includes a normalization (i.e., by the denominator) to prevent an ill-conditioned inversion at the spatial aliasing frequency (i.e., the wavelength that is twice the distance between the microphones).

FIG. 35B shows an example of a pair-wise normalized MVDR (minimum variance distortionless response) BFNF, in which the manner in which the steering vector (array manifold vector) is obtained differs from the conventional approach. In this case, a common channel is eliminated due to sharing of a microphone between the two pairs (e.g., the microphone labeled as x_{1,2} and x_{2,1} in FIG. 35A). The noise coherence matrix Γ may be obtained either by measurement or by theoretical calculation using a sinc function. It is noted that the examples of FIGS. 34A, 34B, and 35B may be generalized to an arbitrary number of sources N such that N<=M, where M is the number of microphones (or, reciprocally, the number of loudspeakers).

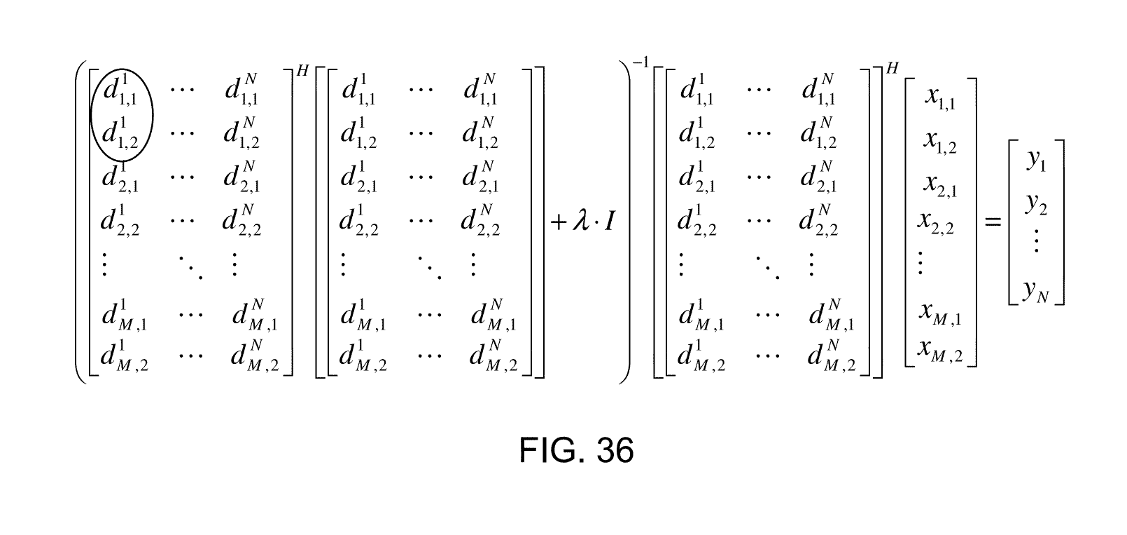

FIG. 36 shows another example that may be used if the matrix A^{H}A is not ill-conditioned, which may be determined using a condition number or determinant of the matrix. In this example, the notation is as in FIG. 34A, and the number of sources N is not greater than the number of microphone pairs M. If the matrix is ill-conditioned, it may be desirable to bypass one microphone signal for that frequency bin for use as the source channel, while continuing to apply the method to spatially filter other frequency bins in which the matrix A^{H}A is not ill-conditioned. This option saves computation for calculating a denominator for normalization. The methods in FIGS. 34A-36 demonstrate BFNF techniques that may be applied independently at each frequency bin. The steering vectors are constructed using the DOA estimates for each frequency and microphone pair as described herein. For example, each element of the steering vector for pair p and source n for DOA θᵢ, frequency f, and microphone number m (1 or 2) may be calculated as

$${d}_{p , m}^{n} = exp ( \frac{- j ω {f}_{s} ( m - 1 ) {l}_{p}}{c} cos {θ}_{i} ) ,$$

where lₚ indicates the distance between the microphones of pair p (reciprocally, between a pair of loudspeakers), w indicates the frequency bin number, and fₛ indicates the sampling frequency.

A method as described herein (e.g., method M100) may be combined with automatic speech recognition (ASR) for system control. Such a control may support different functions (e.g., control of television and/or telephone functions) for different users. The method may be configured, for example, to use an embedded speech recognition engine create a privacy zone whenever an activation code is uttered (e.g., a particular phrase, such as “Qualcomm voice”).

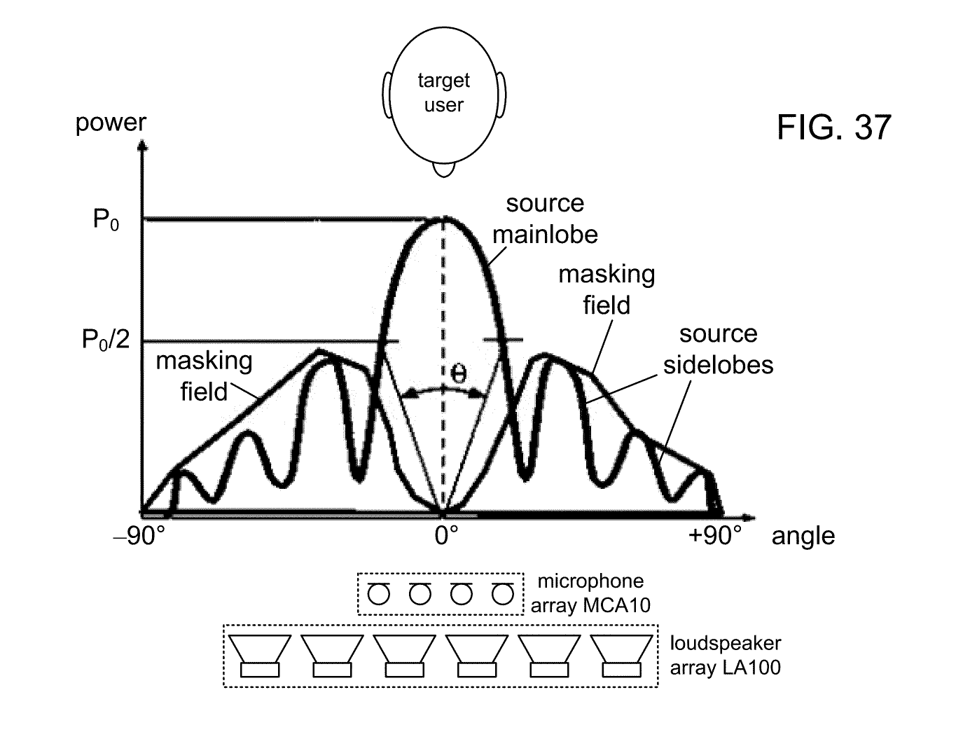

In a typical use scenario as shown in FIG. 37, a user speaks a voice code (e.g. “Qualcomm voice”) that prompts the system to create a privacy zone. Additionally, the device may recognize words spoken after the activation code as command and/or payload parameters. Examples of such parameters include a command for a simple function (e.g., volume up and down, channel up and down), a command to select a particular channel (e.g., “channel nine”), and a command to initiate a telephone call to a particular person (e.g., “call Mom”). In one example, a user instructs the system to select a particular television channel as the source signal by saying “Qualcomm voice, channel five please!” For a case in which the additional parameters indicate a request for playback of a particular content selection, the device may deliver the requested content through the loudspeaker array.

In a similar manner, the system may be configured to enter a masking mode in response to a corresponding activation code. It may be desirable to implement the system to adapt its masking behavior to the current operating mode (e.g., to perform privacy zone generation for phone functions, and to perform environmentally-friendly masking for media functions). In a multiuser case, the system may create the source and masking components in response to the activation code and the direction from which the code is received, as in the following three-user example:

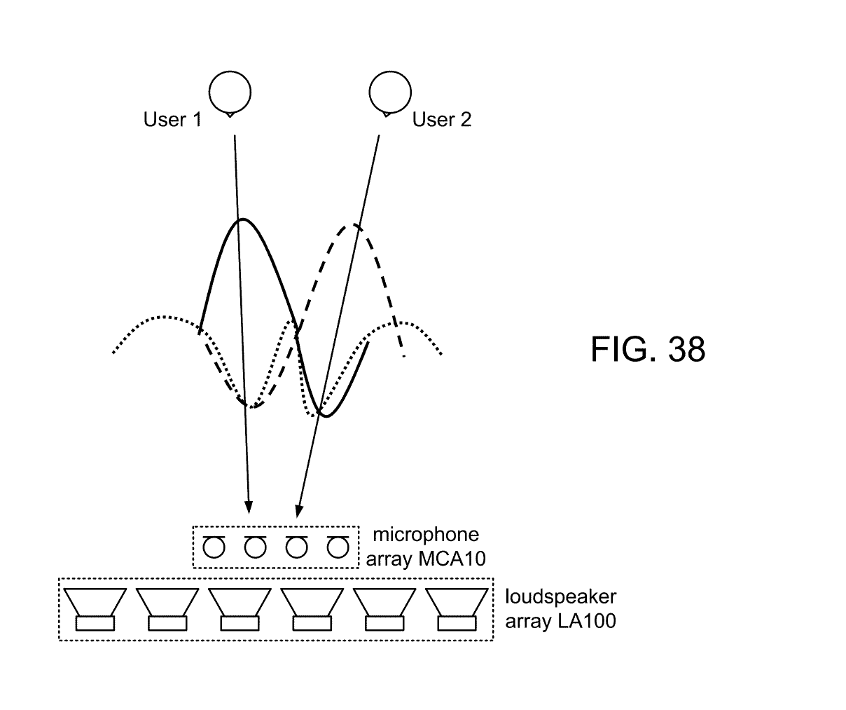

During generation of the privacy zone for user 1, a second user may prompt the system to create a second privacy zone as shown in FIG. 38. For example, the second user may instruct the system to select a particular television channel as the source signal for that user with a command such as “Qualcomm voice, channel one please!” In another example, the source signals for users 1 and 2 are different language channels (e.g., English and Spanish) for the same video program. In FIG. 38, the solid curve indicates the intensity with respect to angle of the source component for user 1, the dashed curve indicates the intensity with respect to angle of the source component for user 2, and the dotted curve indicates the intensity with respect to angle of the masking component. In this case, the source component for each user is produced to have a null in the direction of the other user, and the masking component is produced to have nulls in the user directions. It is also possible to implement such a system using a screen that provides a different video program to each user.

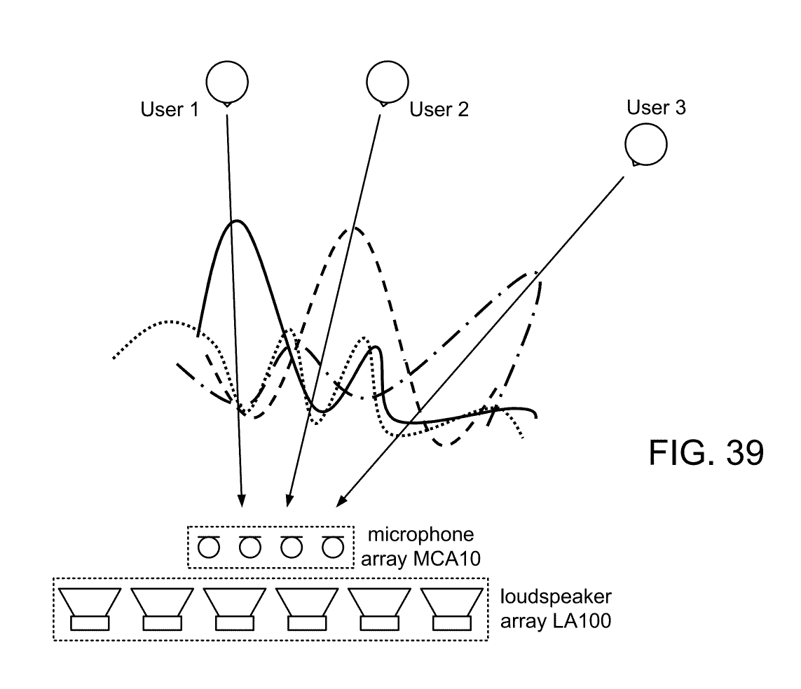

During generation of the privacy zones for users 1 and 2, a third user may prompt the system to create another privacy zone as shown in FIG. 39. For example, the third user may instruct the system to initiate a telephone call as the source signal for that user with a command such as “Qualcomm voice, call Julie please!” In this figure, the dot-dash curve indicates the intensity with respect to angle of the source component for user 3. In this case, the source component for each user is produced to have nulls in the directions of each other user, and the masking component is produced to have nulls in the user directions.

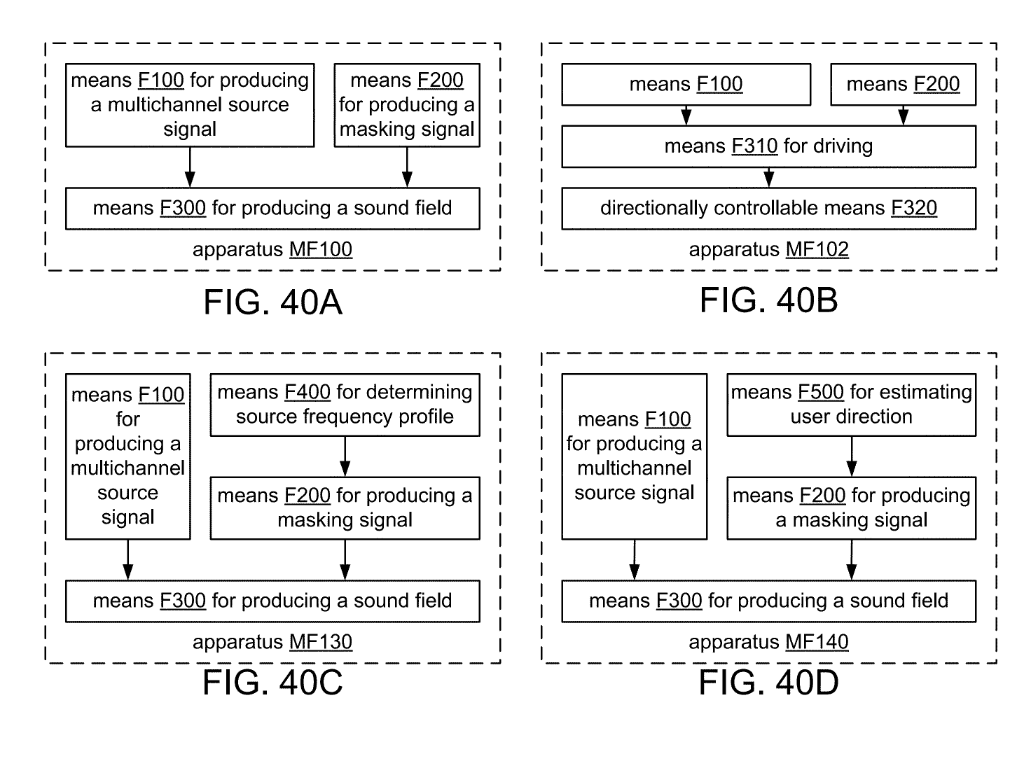

FIG. 40A shows a block diagram of an apparatus for signal processing MF100 according to a general configuration that includes means F100 for producing a multichannel source signal that is based on a source signal (e.g., as described herein with reference to task T100). Apparatus MF100 also includes means F200 for producing a masking signal that is based on a noise signal (e.g., as described herein with reference to task T200). Apparatus MF100 also includes means F300 for producing a sound field that includes a source component based on the multichannel source signal and a masking component based on the masking signal (e.g., as described herein with reference to task T300).

FIG. 40B shows a block diagram of an implementation MF102 of apparatus MF100 that includes directionally controllable transducer means F320 and an implementation F310 of means F300 that is for driving directionally controllable transducer means F320 to produce the sound field (e.g., as described herein with reference to task T300). FIG. 40C shows a block diagram of an implementation MF130 of apparatus MF100 that includes means F400 for determining a source frequency profile of the source signal (e.g., as described herein with reference to task T400). FIG. 40D shows a block diagram of an implementation MF140 of apparatus MF100 that includes means F500 for estimating a direction of a user (e.g., as described herein with reference to task T500). Apparatus MF130 and MF140 may also be realized as implementations of apparatus MF102 (e.g., such that means F300 is implemented as means F310). Additionally or alternatively, apparatus MF140 may be realized as an implementation of apparatus MF130 (e.g., including an instance of means F400).

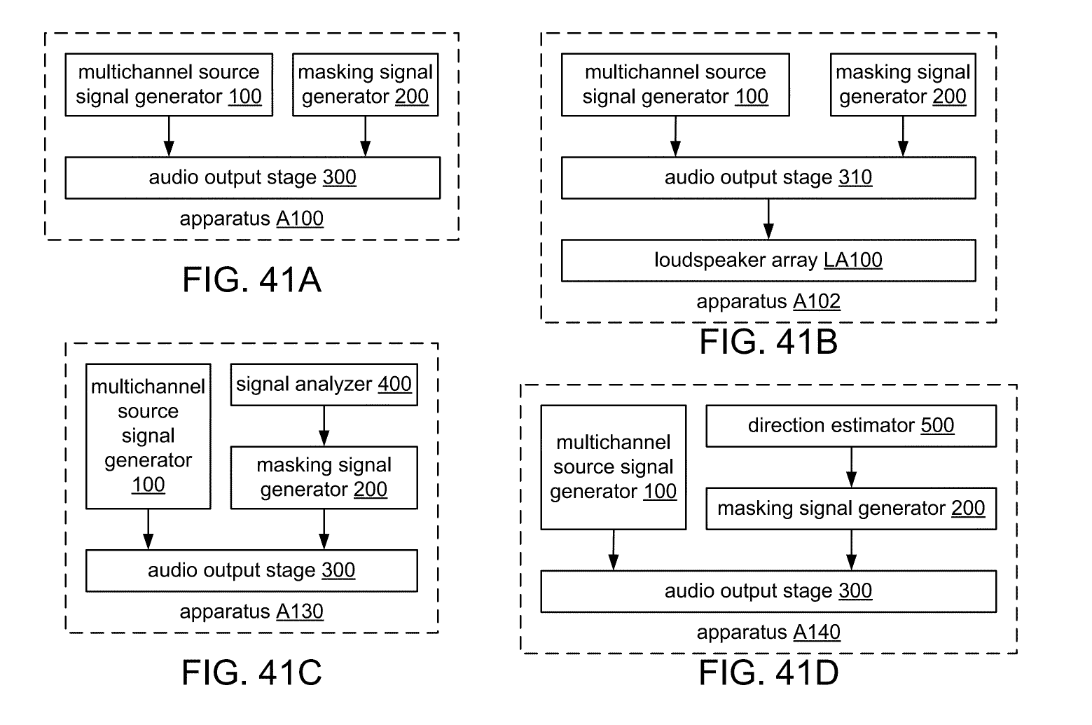

FIG. 41A shows a block diagram of an apparatus for signal processing A100 according to a general configuration that includes a multichannel source signal generator 100, a masking signal generator 200, and an audio output stage 300. Multichannel source signal generator 100 is configured to produce a multichannel source signal that is based on a source signal (e.g., as described herein with reference to task T100). Masking signal generator 200 is configured to produce a masking signal that is based on a noise signal (e.g., as described herein with reference to task T200). Audio output stage 300 is configured to produce a set of driving signals that describe a sound field including a source component based on the multichannel source signal and a masking component based on the masking signal (e.g., as described herein with reference to task T300). Audio output stage 300 may also be implemented to perform other audio processing operations on the multichannel source signal, on the masking signal, and/or on the mixed channels to produce the driving signals.

FIG. 41B shows a block diagram of an implementation A102 of apparatus A100 that includes an instance of loudspeaker array LA100 arranged to produce the sound field in response to the driving signals as produced by an implementation 310 of audio output stage 300. FIG. 41C shows a block diagram of an implementation A130 of apparatus A100 that includes a signal analyzer 400 configured to determine a source frequency profile of the source signal (e.g., as described herein with reference to task T400). FIG. 41D shows a block diagram of an implementation A140 of apparatus A100 that includes a direction estimator 500 configured to estimate a direction of a user relative to the apparatus (e.g., as described herein with reference to task T500).

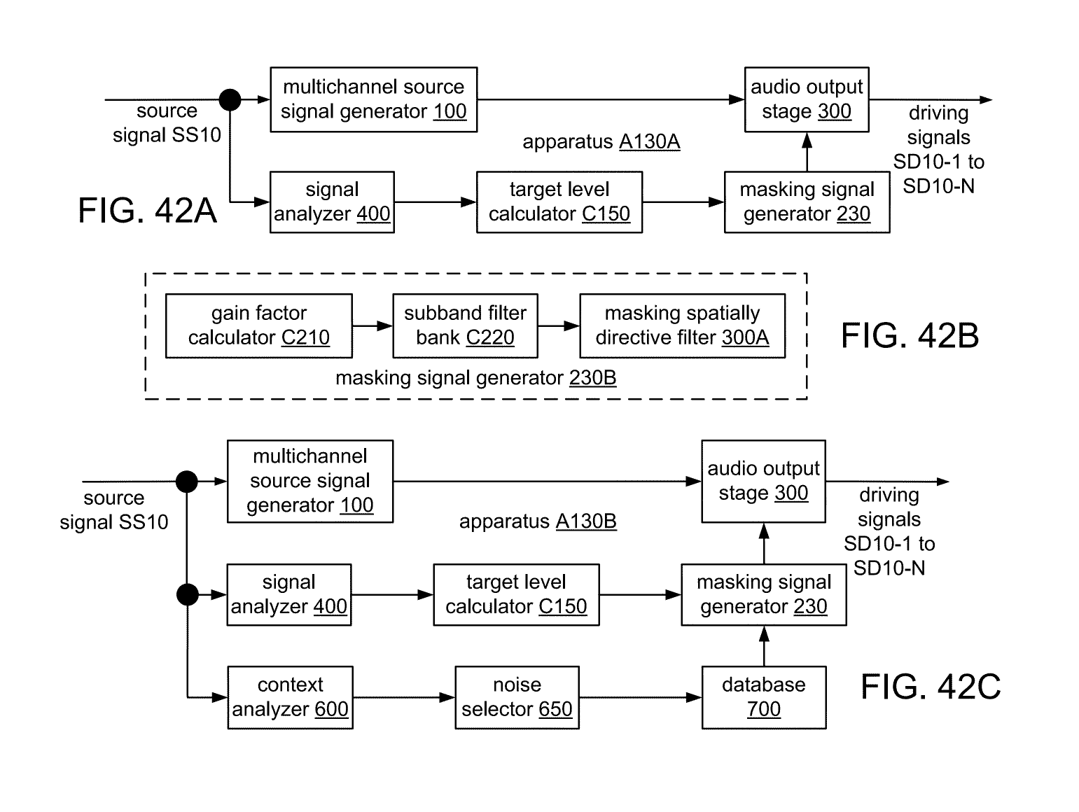

FIG. 42A shows a diagram of an implementation A130A of apparatus A130 that may be used to perform automatic masker design and control (e.g., as described herein with reference to method M130). Multichannel source signal generator 100 receives a desired audio source signal, such as a voice communication or media playback signal (e.g., from a local device or via a network, such as from a cloud), and produces a corresponding multichannel source signal that is directed toward a user (e.g., as described herein with reference to task T100). Multichannel source signal generator 100 may be implemented to select a filter, from among two or more source spatially directive filters, according to a direction as indicated by direction estimator 500, and to indicate parameter values determined by that selection (e.g., an estimated response of the filter over direction and/or frequency) to one or more modules, such as signal analyzer 400.

Signal analyzer 400 calculates an estimated intensity of the source component. Signal analyzer 400 may be implemented (e.g., as described herein with reference to tasks T400 and TA110) to calculate the estimated intensity in different directions, and in different frequency subbands, to produce a frequency-dependent spatial intensity map (e.g., as shown in FIG. 28A). For example, signal analyzer 400 may be implemented to calculate such a map based on an estimated response of the source spatially directive filter (which may be based on offline recording information OR10) and information from source signal SS10 (e.g., current and/or average signal subband levels). Signal analyzer 400 may also be configured to indicate a timbre (e.g., a distribution of harmonic content over frequency) of the source signal.

Apparatus A130A also includes a target level calculator C150 configured to calculate a masking target level (e.g., an effective masking threshold) for each of a plurality of frequency bins or subbands over a desired masking frequency range, based on the estimated intensity of the source component (e.g., as described herein with reference to task TC150). Calculator C150 may be implemented, for example, to produce a reference map that indicates a desired masking level for each direction and frequency (e.g., as shown in FIG. 28B). Additionally or alternatively, target level calculator TC150 may also be implemented to modify one or more of the target levels according to a desired intensity of the sound field (e.g., as described herein with reference to FIGS. 25 and 26). For at least one spatial sector, for example, target level calculator C150 may be implemented to modify a subband target level based on target levels for each of one or more other subbands. Target level calculator C150 may also be implemented to calculate the masking target levels according to the responses of the loudspeakers of an array to be used to produce the sound field (e.g., array LA100).

Apparatus A130A also includes an implementation 230 of masking signal generator 200. Generator 230 is configured to generate a directional masking signal, based on the masking target levels produced by target level calculator C150, that includes a null beam in the source direction (e.g., as described herein with reference to tasks TC200 and TA300). FIG. 42B shows a block diagram of an implementation 230B of masking signal generator 230 that includes a gain factor calculator C210, a subband filter bank C220, and a masking spatially directive filter 300A. Gain factor calculator C210 is configured to calculate values for a plurality of subband gain factors, based on the masking target levels (e.g., as described herein with reference to task TC210). Subband filter bank C220 is configured to apply the gain factor values to corresponding subbands of a noise signal to produce a modified noise signal (e.g., as described herein with reference to task TC220).

Masking spatially directive filter 300A is configured to filter the modified noise signal to produce a multichannel masking signal that has a null in the source direction (e.g., as described herein with reference to task TA300). Masking signal generator 230 (e.g., generator 230B) may be implemented to select filter 300A from among two or more spatially directive filters according to the desired null direction (e.g., the source direction). Additionally or alternatively, such a generator may be implemented to select a different masking spatially selective filter for each of two or more (possibly all) of the subbands, based on a best match (e.g., in a least-squares-error sense) between an estimated response of the filter and the masking target levels for the corresponding subband or subbands.

Audio output stage 300 is configured to mix the multichannel source and masking signals to produce a plurality of driving signals SD10-1 to SD10-N (e.g., as described herein with reference to tasks T300 and T310). Audio output stage 300 may be implemented to perform such mixing in the digital domain or in the analog domain. For example, audio output stage 300 may be configured to produce a driving signal for each loudspeaker channel by converting digital source and masking signals to analog, or by converting a digital mixed signal to analog. Audio output stage 300 may also be configured to amplify, apply a gain to, and/or control a gain of the source signal; to filter the source and/or masking signals; to provide impedance matching to the loudspeakers of the array; and/or to perform any other desired audio processing operation.

FIG. 42C shows a block diagram of an implementation A130B of apparatus A130A that includes a context analyzer 600, a noise selector 650, and a database 700. Context analyzer 600 analyzes the input source signal, in frequency and/or in time, to determine values for each of one or more source characteristics (e.g., as described above with reference to task T200). Examples of analysis techniques that may be performed by context analyzer 600 include multiresolution analysis (MRA), mel-frequency cepstral coefficient (MFCC) analysis, and cascade time-frequency linear prediction (CTFLP) analysis. Additionally or alternatively, context analyzer 600 may include a voice activity detector (VAD) such that the source characteristics include an indication of presence or absence of voice activity (e.g., for each frame of the input signal). Context analyzer 600 may be implemented to classify the input source signal according to its content and/or context (e.g., as speech, music, news, game commentary, etc.).

Noise selector 650 is configured to select an appropriate type of noise signal or pattern (e.g., speech, music, babble noise, street noise, car interior noise, white noise) based on the source characteristics. For example, noise selector 650 may be implemented to select, from among a plurality of noise signals or patterns in database 700, the signal or pattern that best matches the source characteristics (e.g., in a least-squares-error sense). Database 700 is configured to produce (e.g., to synthesize or reproduce) a noise signal according to the selected noise signal or pattern indicated by noise selector 650.

In this case, it may be desirable to configure target level calculator C150 to calculate the masking target levels based on information about the selected noise signal or pattern (e.g., the energy spectrum of the selected noise signal). For example, target level calculator C150 may be configured to produce the target levels according to characteristics, such as changes over time in the energy spectrum of the selected masking signal (e.g., over several frames) and/or harmonicity of the selected masking signal, that distinguish the selected noise signal from one or more other entries in database 700 having similar time-average energy spectra. In apparatus A130B, masking signal generator 230 (e.g., generator 230B) is arranged to produce the directional masking signal by modifying, according to the masking target levels, the noise signal produced by database 700.

Any among apparatus A130, A130A, A130B, and A140 may also be realized as an implementation of apparatus A102 (e.g., such that audio output stage 300 is implemented as audio output stage 310 to drive array LA100). Additionally or alternatively, any among apparatus A130, A130A, and A130B may be realized as an implementation of apparatus A140 (e.g., including an instance of direction estimator 500).

Each of the microphones for direction estimation as discussed herein (e.g., with reference to location and tracking of one or more users) may have a response that is omnidirectional, bidirectional, or unidirectional (e.g., cardioid). The various types of microphones that may be used include (without limitation) piezoelectric microphones, dynamic microphones, and electret microphones. It is expressly noted that the microphones may be implemented more generally as transducers sensitive to radiations or emissions other than sound. In one such example, the microphone array is implemented to include one or more ultrasonic transducers (e.g., transducers sensitive to acoustic frequencies greater than fifteen, twenty, twenty-five, thirty, forty, or fifty kilohertz or more).

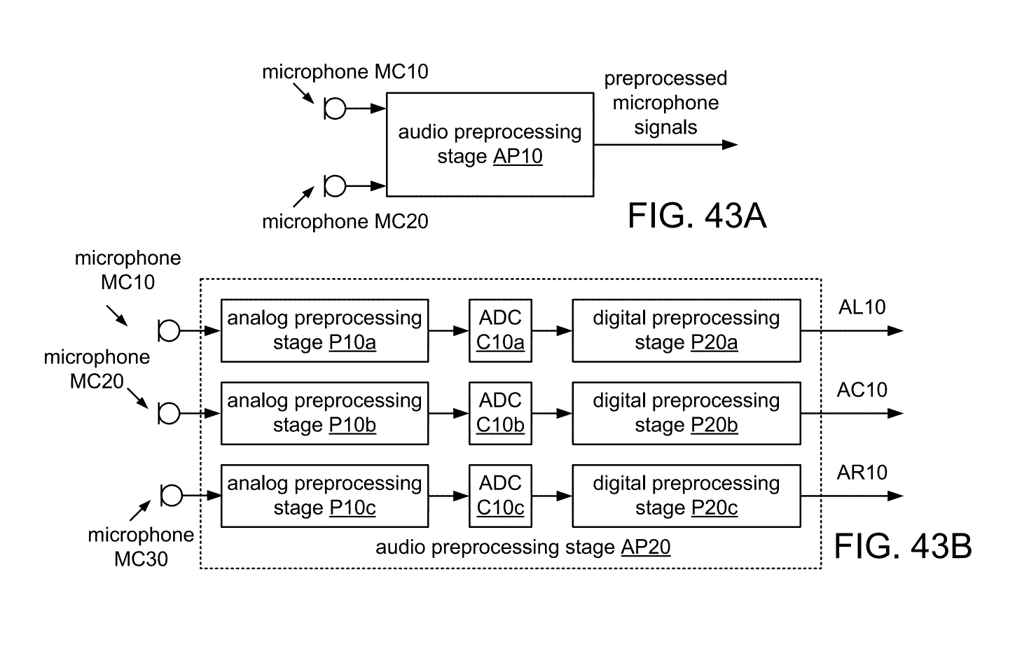

Apparatus A100 and apparatus MF100 may be implemented as a combination of hardware (e.g., a processor) with software and/or with firmware. Such apparatus may also include an audio preprocessing stage AP10 as shown in FIG. 43A that performs one or more preprocessing operations on signals produced by each of the microphones MC10 and MC20 (e.g., of an implementation of microphone array MCA10) to produce preprocessed microphone signals (e.g., a corresponding one of a left microphone signal and a right microphone signal) for input to task T500 or direction estimator 500. Such preprocessing operations may include (without limitation) impedance matching, analog-to-digital conversion, gain control, and/or filtering in the analog and/or digital domains.

FIG. 43B shows a block diagram of a three-channel implementation AP20 of audio preprocessing stage AP10 that includes analog preprocessing stages P10a, P10b, and P10c. In one example, stages P10a, P10b, and P10c are each configured to perform a highpass filtering operation (e.g., with a cutoff frequency of 50, 100, or 200 Hz) on the corresponding microphone signal. Typically, stages P10a, P10b, and P10c will be configured to perform the same functions on each signal.

It may be desirable for audio preprocessing stage AP10 to produce each microphone signal as a digital signal, that is to say, as a sequence of samples. Audio preprocessing stage AP20, for example, includes analog-to-digital converters (ADCs) C10a, C10b, and C10c that are each arranged to sample the corresponding analog signal. Typical sampling rates for acoustic applications include 8 kHz, 12 kHz, 16 kHz, and other frequencies in the range of from about 8 to about 16 kHz, although sampling rates as high as about 44.1, 48, or 192 kHz may also be used. Typically, converters C10a, C10b, and C10c will be configured to sample each signal at the same rate.

In this example, audio preprocessing stage AP20 also includes digital preprocessing stages P20a, P20b, and P20c that are each configured to perform one or more preprocessing operations (e.g., spectral shaping) on the corresponding digitized channel to produce a corresponding one of a left microphone signal AL10, a center microphone signal AC10, and a right microphone signal AR10 for input to task T500 or direction estimator 500. Typically, stages P20a, P20b, and P20c will be configured to perform the same functions on each signal. It is also noted that preprocessing stage AP10 may be configured to produce a different version of a signal from at least one of the microphones (e.g., at a different sampling rate and/or with different spectral shaping) for content use, such as to provide a near-end speech signal in a voice communication (e.g., a telephone call). Although FIGS. 43A and 43B show two-channel and three-channel implementations, respectively, it will be understood that the same principles may be extended to an arbitrary number of microphones.

Loudspeaker array LA100 may include cone-type and/or rectangular loudspeakers. The spacings between adjacent loudspeakers may be uniform or nonuniform, and the array may be linear or nonlinear. As noted above, techniques for generating the multichannel signals for driving the array may include pairwise BFNF and MVDR.

When beamforming techniques are used to produce spatial patterns for broadband signals, selection of the transducer array geometry involves a trade-off between low and high frequencies. To enhance the direct handling of low frequencies by the beamformer, a larger loudspeaker spacing is preferred. At the same time, if the spacing between loudspeakers is too large, the ability of the array to reproduce the desired effects at high frequencies will be limited by a lower aliasing threshold. To avoid spatial aliasing, the wavelength of the highest frequency component to be reproduced by the array should be greater than twice the distance between adjacent loudspeakers.

As consumer devices become smaller and smaller, the form factor may constrain the placement of loudspeaker arrays. For example, it may be desirable for a laptop, netbook, or tablet computer or a high-definition video display to have a built-in loudspeaker array. Due to the size constraints, the loudspeakers may be small and unable to reproduce a desired bass region. Alternatively, the loudspeakers may be large enough to reproduce the bass region but spaced too closely to support beamforming or other acoustic imaging. Thus it may be desirable to provide the processing to produce a bass signal in a closely spaced loudspeaker array in which beamforming is employed.

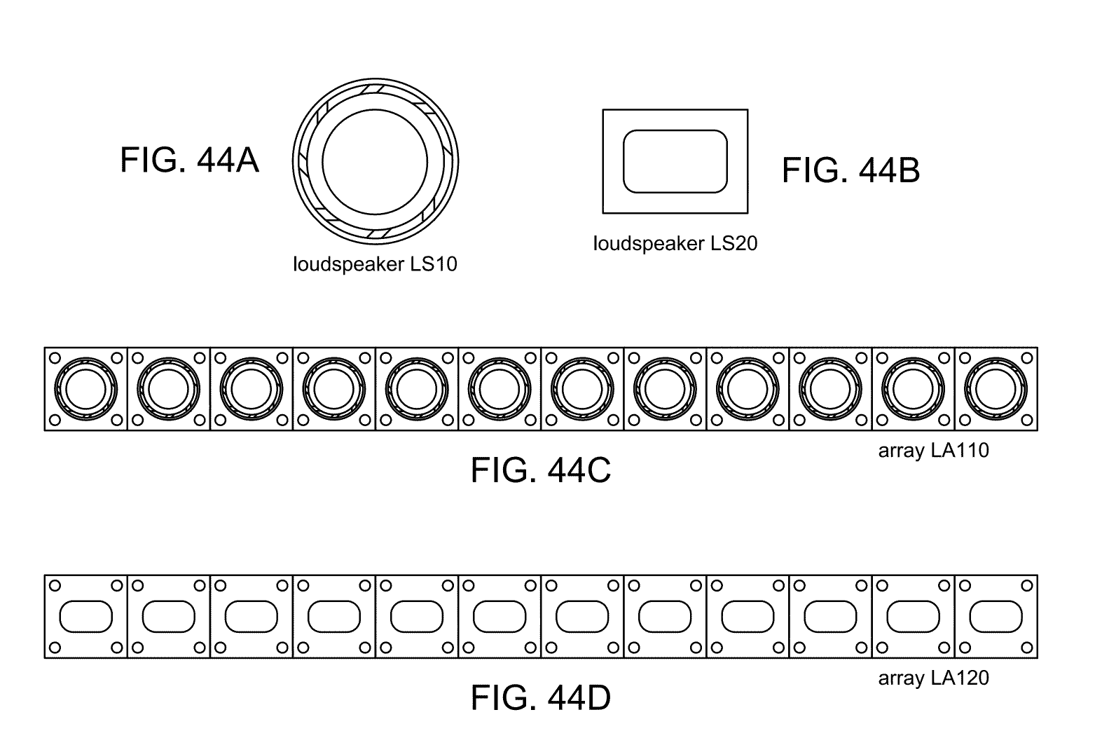

FIG. 44A shows an example LS10 of a cone-type loudspeaker, and FIG. 44B shows an example LS20 of a rectangular loudspeaker (e.g., RA11×15×3.5, NXP Semiconductors, Eindhoven, NL). FIG. 44C shows an implementation LA110 of array LA100 as an array of twelve loudspeakers as shown in FIG. 44A, and FIG. 44D shows an implementation LA120 of array LA100 as an array of twelve loudspeakers as shown in FIG. 44B. In the examples of FIGS. 44C and 44D, the inter-loudspeaker distance is 2.6 cm, and the length of the array (31.2 cm) is approximately equal to the width of a typical laptop computer.

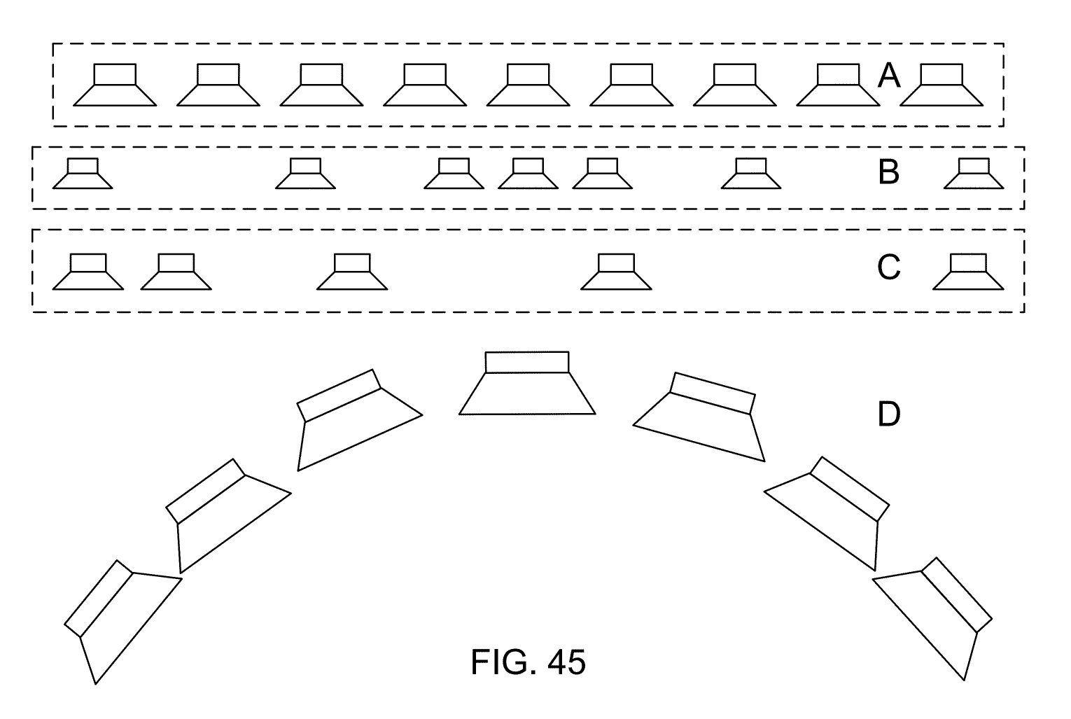

It is expressly noted that the principles described herein are not limited to use with a uniform linear array of loudspeakers (e.g., as shown in FIG. 45A). For example, directional masking may also be used with a linear array having a nonuniform spacing between adjacent loudspeakers. FIG. 45B shows one example of such an implementation of array LA100 having symmetrical octave spacing between the loudspeakers, and FIG. 45C shows another example of such an implementation having asymmetrical octave spacing. Additionally, such principles are not limited to use with linear arrays and may also be used with implementations of array LA100 whose elements are arranged along a simple curve, whether with uniform spacing (e.g., as shown in FIG. 45D) or with nonuniform (e.g., octave) spacing. The same principles stated herein also apply separably to each array in applications having multiple arrays along the same or different (e.g., orthogonal) straight or curved axes.

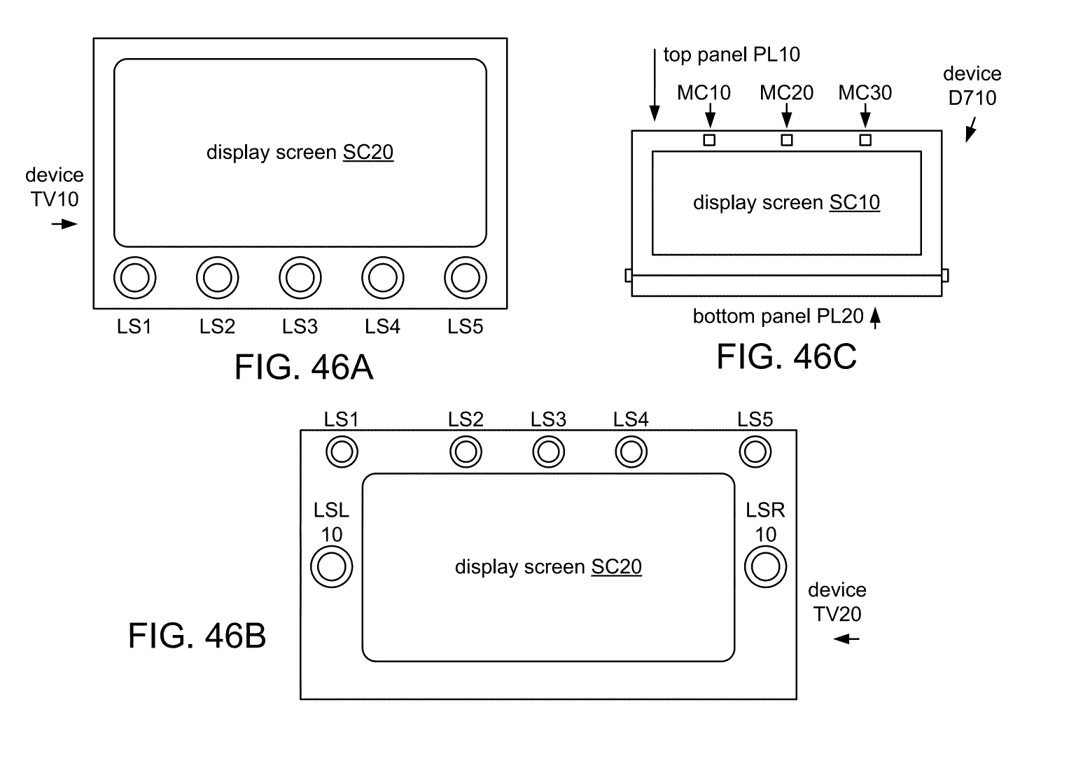

FIG. 46A shows an implementation of array LA100 to be driven by an implementation of apparatus A100. In this example, the array is a linear arrangement of five uniformly spaced loudspeakers LS1 to LS5 that are arranged below a display screen SC20 in a display device TV10 (e.g., a television or computer monitor). FIG. 46B shows another implementation of array LA100 in such a display device TV20 to be driven by an implementation of apparatus A100. In this case, loudspeakers LS1 to LS5 are arranged linearly with non-uniform spacing, and the array also includes larger loudspeakers LSL10 and LSR10 on either side of display screen SC20. A laptop computer D710 as shown in FIG. 46C may also be configured to include such an array (e.g., in behind and/or beside a keyboard in bottom panel PL20 and/or in the margin of display screen SC10 in top panel PL10). Device D710 also includes three microphones MC10, MC20, and MC30 that may be used for direction estimation as described herein. Devices TV10 and TV20 may also be implemented to include such a microphone array (e.g., arranged horizontally among the loudspeakers and/or in a different margin of the bezel). Loudspeaker array LA100 may also be enclosed in one or more separate cabinets or installed in the interior of a vehicle such as an automobile.

In the example of FIG. 4, it may be expected that the main beam directed at zero degrees in the frontal direction will also be audible in the back direction (e.g., at 180 degrees). Such a phenomenon, which is common in the context of a linear array of loudspeakers or microphones, is also referred to as a “cone of confusion” problem. It may be desirable to extend direction control into a front-back direction and/or into an up-down direction.

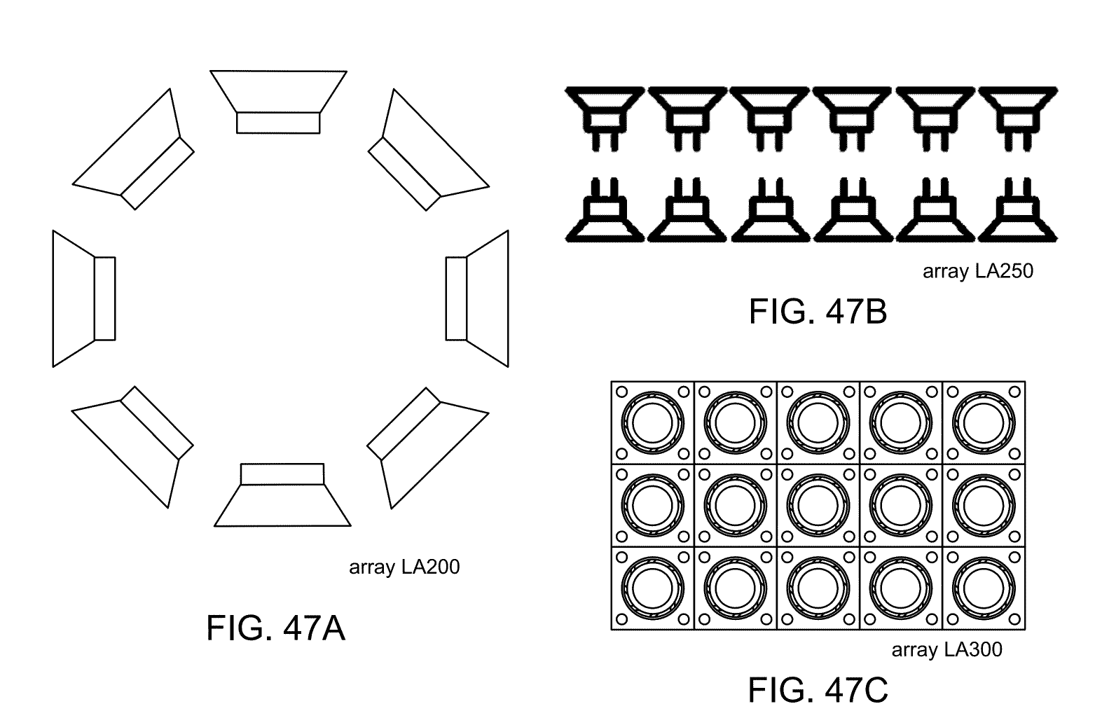

Although particular examples of directional masking in a range of 180 degrees are shown, the principles described herein may be extended to provide directional masking across any desired angular range in a plane (e.g., a two-dimensional range). Such extension may include the addition of appropriately placed loudspeakers to the array. For example, FIG. 4 shows an example of directional masking in a left-right direction. It may be desirable to add loudspeakers to array LA100 as shown in FIG. 4 to provide a front-back array for masking in a front-back direction as well. FIGS. 47A and 47B show top views of two examples LA200, LA250 of such an expanded implementation of array LA100.

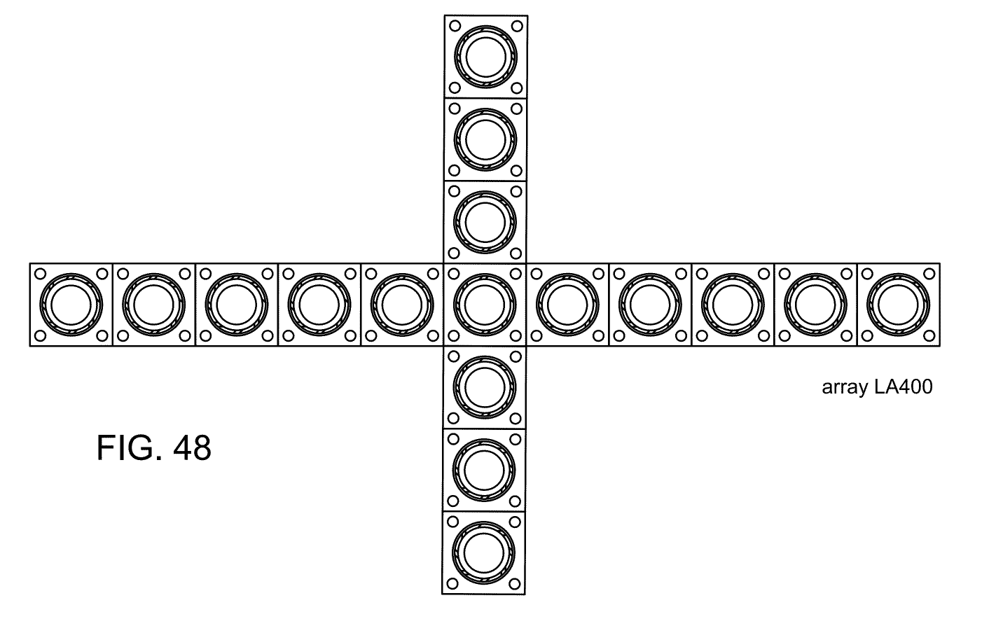

Such principles may also be extended to provide directional masking across any desired angular range in space (3D). FIGS. 47C and 48 show front views of two implementations LA300, LA400 of array LA100 that may be used to provide directional masking in both left-right and up-down directions. Further examples include spherical or other 3D arrays for directional masking in a range up to 360 degrees (e.g., for a complete privacy zone of 4×pi radians).

A psychoacoustic phenomenon exists that listening to higher harmonics of a signal may create a perceptual illusion of hearing the missing fundamentals. Thus, one way to achieve a sensation of bass components from small loudspeakers is to generate higher harmonics from the bass components and play back the harmonics instead of the actual bass components. Descriptions of algorithms for substituting higher harmonics to achieve a psychoacoustic sensation of bass without an actual low-frequency signal presence (also called “psychoacoustic bass enhancement” or PBE) may be found, for example, in U.S. Pat. No. 5,930,373 (Shashoua et al., issued Jul. 27, 1999) and U.S. Publ. Pat. Appls. Nos. 2006/0159283 A1 (Mathew et al., published Jul. 20, 2006), 2009/0147963 A1 (Smith, published Jun. 11, 2009), and 2010/0158272 A1 (Vickers, published Jun. 24, 2010). Such enhancement may be particularly useful for reproducing low-frequency sounds with devices that have form factors which restrict the integrated loudspeaker or loudspeakers to be physically small. For example, task T300 may be implemented to perform PBE to produce the driving signals that drive the array of loudspeakers to produce the combined sound field.

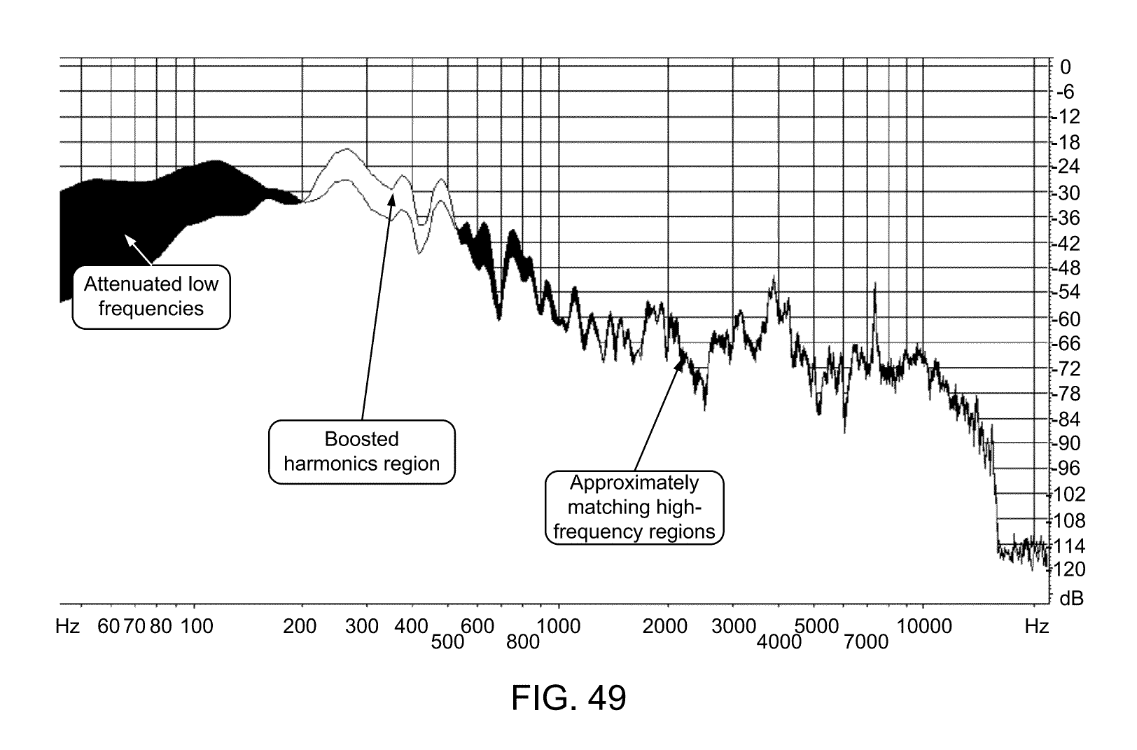

FIG. 49 shows an example of a frequency spectrum of a music signal before and after PBE processing. In this figure, the background (black) region and the line visible at about 200 to 500 Hz indicates the original signal, and the foreground (white) region indicates the enhanced signal. It may be seen that in the low-frequency band (e.g., below 200 Hz), the PBE operation attenuates around 10 dB of the actual bass. Because of the enhanced higher harmonics from about 200 Hz to 600 Hz, however, when the enhanced music signal is reproduced using a small speaker, it is perceived to have more bass than the original signal.

It may be desirable to apply PBE not only to reduce the effect of low-frequency reproducibility limits, but also to reduce the effect of directivity loss at low frequencies. For example, it may be desirable to combine PBE with spatially directive filtering (e.g., beamforming) to create the perception of low-frequency content in a range that is steerable by a beamformer. In one example, any of the implementations of task T100 as described herein is modified to perform PBE on the source signal and to produce the multichannel source signal from the PBE-processed source signal. In the same example or in an alternative example, any of the implementations of task T200 as described herein is modified to perform PBE on the masking signal and to produce the multichannel masking signal from the PBE-processed masking signal.

The use of a loudspeaker array to produce directional beams from an enhanced signal results in an output that has a much lower perceived frequency range than an output from the audio signal without such enhancement. Additionally, it becomes possible to use a more relaxed beamformer design to steer the enhanced signal, which may support a reduction of artifacts and/or computational complexity and allow more efficient steering of bass components with arrays of small loudspeakers. At the same time, such a system can protect small loudspeakers from damage by low-frequency signals (e.g., rumble). Additional description of such enhancement techniques, which may be combined with directional masking as described herein, may be found in, e.g., U.S. patent application Ser. No. 13/190,464, entitled “SYSTEMS, METHODS, AND APPARATUS FOR ENHANCED ACOUSTIC IMAGING” (filed Jul. 25, 2011).

The methods and apparatus disclosed herein may be applied generally in any transceiving and/or audio sensing application, including mobile or otherwise portable instances of such applications and/or sensing of signal components from far-field sources. For example, the range of configurations disclosed herein includes communications devices that reside in a wireless telephony communication system configured to employ a code-division multiple-access (CDMA) over-the-air interface. Nevertheless, it would be understood by those skilled in the art that a method and apparatus having features as described herein may reside in any of the various communication systems employing a wide range of technologies known to those of skill in the art, such as systems employing Voice over IP (VoIP) over wired and/or wireless (e.g., CDMA, TDMA, FDMA, and/or TD-SCDMA) transmission channels.

It is expressly contemplated and hereby disclosed that communications devices disclosed herein may be adapted for use in networks that are packet-switched (for example, wired and/or wireless networks arranged to carry audio transmissions according to protocols such as VoIP) and/or circuit-switched. It is also expressly contemplated and hereby disclosed that communications devices disclosed herein may be adapted for use in narrowband coding systems (e.g., systems that encode an audio frequency range of about four or five kilohertz) and/or for use in wideband coding systems (e.g., systems that encode audio frequencies greater than five kilohertz), including whole-band wideband coding systems and split-band wideband coding systems.

The foregoing presentation of the described configurations is provided to enable any person skilled in the art to make or use the methods and other structures disclosed herein. The flowcharts, block diagrams, and other structures shown and described herein are examples only, and other variants of these structures are also within the scope of the disclosure. Various modifications to these configurations are possible, and the generic principles presented herein may be applied to other configurations as well. Thus, the present disclosure is not intended to be limited to the configurations shown above but rather is to be accorded the widest scope consistent with the principles and novel features disclosed in any fashion herein, including in the attached claims as filed, which form a part of the original disclosure.

Those of skill in the art will understand that information and signals may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

Important design requirements for implementation of a configuration as disclosed herein may include minimizing processing delay and/or computational complexity (typically measured in millions of instructions per second or MIPS), especially for computation-intensive applications, such as playback of compressed audio or audiovisual information (e.g., a file or stream encoded according to a compression format, such as one of the examples identified herein) or applications for wideband communications (e.g., voice communications at sampling rates higher than eight kilohertz, such as 12, 16, 32, 44.1, 48, or 192 kHz).

Goals of a multi-microphone processing system may include achieving ten to twelve dB in overall noise reduction, preserving voice level and color during movement of a desired speaker, obtaining a perception that the noise has been moved into the background instead of an aggressive noise removal, dereverberation of speech, and/or enabling the option of post-processing for more aggressive noise reduction.

An apparatus as disclosed herein (e.g., any among apparatus A100, A102, A130, A130A, A130B, A140, MF100, MF102, MF130, and MF140) may be implemented in any combination of hardware with software, and/or with firmware, that is deemed suitable for the intended application. For example, the elements of such an apparatus may be fabricated as electronic and/or optical devices residing, for example, on the same chip or among two or more chips in a chipset. One example of such a device is a fixed or programmable array of logic elements, such as transistors or logic gates, and any of these elements may be implemented as one or more such arrays. Any two or more, or even all, of the elements of the apparatus may be implemented within the same array or arrays. Such an array or arrays may be implemented within one or more chips (for example, within a chipset including two or more chips).

One or more elements of the various implementations of the apparatus disclosed herein may also be implemented in whole or in part as one or more sets of instructions arranged to execute on one or more fixed or programmable arrays of logic elements, such as microprocessors, embedded processors, IP cores, digital signal processors, FPGAs (field-programmable gate arrays), ASSPs (application-specific standard products), and ASICs (application-specific integrated circuits). Any of the various elements of an implementation of an apparatus as disclosed herein may also be embodied as one or more computers (e.g., machines including one or more arrays programmed to execute one or more sets or sequences of instructions, also called “processors”), and any two or more, or even all, of these elements may be implemented within the same such computer or computers.

A processor or other means for processing as disclosed herein may be fabricated as one or more electronic and/or optical devices residing, for example, on the same chip or among two or more chips in a chipset. One example of such a device is a fixed or programmable array of logic elements, such as transistors or logic gates, and any of these elements may be implemented as one or more such arrays. Such an array or arrays may be implemented within one or more chips (for example, within a chipset including two or more chips). Examples of such arrays include fixed or programmable arrays of logic elements, such as microprocessors, embedded processors, IP cores, DSPs, FPGAs, ASSPs, and ASICs. A processor or other means for processing as disclosed herein may also be embodied as one or more computers (e.g., machines including one or more arrays programmed to execute one or more sets or sequences of instructions) or other processors. It is possible for a processor as described herein to be used to perform tasks or execute other sets of instructions that are not directly related to a directional sound masking procedure as described herein, such as a task relating to another operation of a device or system in which the processor is embedded (e.g., an audio sensing device). It is also possible for part of a method as disclosed herein to be performed by a processor of the audio sensing device and for another part of the method to be performed under the control of one or more other processors.

Those of skill will appreciate that the various illustrative modules, logical blocks, circuits, and tests and other operations described in connection with the configurations disclosed herein may be implemented as electronic hardware, computer software, or combinations of both. Such modules, logical blocks, circuits, and operations may be implemented or performed with a general purpose processor, a digital signal processor (DSP), an ASIC or ASSP, an FPGA or other programmable logic device, discrete gate or transistor logic, discrete hardware components, or any combination thereof designed to produce the configuration as disclosed herein. For example, such a configuration may be implemented at least in part as a hard-wired circuit, as a circuit configuration fabricated into an application-specific integrated circuit, or as a firmware program loaded into non-volatile storage or a software program loaded from or into a data storage medium as machine-readable code, such code being instructions executable by an array of logic elements such as a general purpose processor or other digital signal processing unit. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. A software module may reside in a non-transitory storage medium such as RAM (random-access memory), ROM (read-only memory), nonvolatile RAM (NVRAM) such as flash RAM, erasable programmable ROM (EPROM), electrically erasable programmable ROM (EEPROM), registers, hard disk, a removable disk, or a CD-ROM; or in any other form of storage medium known in the art. An illustrative storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

It is noted that the various methods disclosed herein (e.g., any among methods M100, M102, M110, M120, M130, M140, and other methods disclosed by way of description of the operation of the various apparatus described herein) may be performed by an array of logic elements such as a processor, and that the various elements of an apparatus as described herein may be implemented as modules designed to execute on such an array. As used herein, the term “module” or “sub-module” can refer to any method, apparatus, device, unit or computer-readable data storage medium that includes computer instructions (e.g., logical expressions) in software, hardware or firmware form. It is to be understood that multiple modules or systems can be combined into one module or system and one module or system can be separated into multiple modules or systems to perform the same functions. When implemented in software or other computer-executable instructions, the elements of a process are essentially the code segments to perform the related tasks, such as with routines, programs, objects, components, data structures, and the like. The term “software” should be understood to include source code, assembly language code, machine code, binary code, firmware, macrocode, microcode, any one or more sets or sequences of instructions executable by an array of logic elements, and any combination of such examples. The program or code segments can be stored in a processor-readable storage medium or transmitted by a computer data signal embodied in a carrier wave over a transmission medium or communication link.

The implementations of methods, schemes, and techniques disclosed herein may also be tangibly embodied (for example, in tangible, computer-readable features of one or more computer-readable storage media as listed herein) as one or more sets of instructions readable and/or executable by a machine including an array of logic elements (e.g., a processor, microprocessor, microcontroller, or other finite state machine). The term “computer-readable medium” may include any medium that can store or transfer information, including volatile, nonvolatile, removable and non-removable media. Examples of a computer-readable medium include an electronic circuit, a semiconductor memory device, a ROM, a flash memory, an erasable ROM (EROM), a floppy diskette or other magnetic storage, a CD-ROM/DVD or other optical storage, a hard disk, a fiber optic medium, a radio frequency (RF) link, or any other medium which can be used to store the desired information and which can be accessed. The computer data signal may include any signal that can propagate over a transmission medium such as electronic network channels, optical fibers, air, electromagnetic, RF links, etc. The code segments may be downloaded via computer networks such as the Internet or an intranet. In any case, the scope of the present disclosure should not be construed as limited by such embodiments.

Each of the tasks of the methods described herein may be embodied directly in hardware, in a software module executed by a processor, or in a combination of the two. In a typical application of an implementation of a method as disclosed herein, an array of logic elements (e.g., logic gates) is configured to perform one, more than one, or even all of the various tasks of the method. One or more (possibly all) of the tasks may also be implemented as code (e.g., one or more sets of instructions), embodied in a computer program product (e.g., one or more data storage media such as disks, flash or other nonvolatile memory cards, semiconductor memory chips, etc.), that is readable and/or executable by a machine (e.g., a computer) including an array of logic elements (e.g., a processor, microprocessor, microcontroller, or other finite state machine). The tasks of an implementation of a method as disclosed herein may also be performed by more than one such array or machine. In these or other implementations, the tasks may be performed within a device for wireless communications such as a cellular telephone or other device having such communications capability. Such a device may be configured to communicate with circuit-switched and/or packet-switched networks (e.g., using one or more protocols such as VoIP). For example, such a device may include RF circuitry configured to receive and/or transmit encoded frames.

It is expressly disclosed that the various methods disclosed herein may be performed by a portable communications device such as a handset, headset, or portable digital assistant (PDA), and that the various apparatus described herein may be included within such a device. A typical real-time (e.g., online) application is a telephone conversation conducted using such a mobile device.

In one or more exemplary embodiments, the operations described herein may be implemented in hardware, software, firmware, or any combination thereof. If implemented in software, such operations may be stored on or transmitted over a computer-readable medium as one or more instructions or code. The term “computer-readable media” includes both computer-readable storage media and communication (e.g., transmission) media. By way of example, and not limitation, computer-readable storage media can comprise an array of storage elements, such as semiconductor memory (which may include without limitation dynamic or static RAM, ROM, EEPROM, and/or flash RAM), or ferroelectric, magnetoresistive, ovonic, polymeric, or phase-change memory; CD-ROM or other optical disk storage; and/or magnetic disk storage or other magnetic storage devices. Such storage media may store information in the form of instructions or data structures that can be accessed by a computer. Communication media can comprise any medium that can be used to carry desired program code in the form of instructions or data structures and that can be accessed by a computer, including any medium that facilitates transfer of a computer program from one place to another. Also, any connection is properly termed a computer-readable medium. For example, if the software is transmitted from a website, server, or other remote source using a coaxial cable, fiber optic cable, twisted pair, digital subscriber line (DSL), or wireless technology such as infrared, radio, and/or microwave, then the coaxial cable, fiber optic cable, twisted pair, DSL, or wireless technology such as infrared, radio, and/or microwave are included in the definition of medium. Disk and disc, as used herein, includes compact disc (CD), laser disc, optical disc, digital versatile disc (DVD), floppy disk and Blu-ray Disc™ (Blu-Ray Disc Association, Universal City, Calif.), where disks usually reproduce data magnetically, while discs reproduce data optically with lasers. Combinations of the above should also be included within the scope of computer-readable media.

An acoustic signal processing apparatus as described herein (e.g., any among apparatus A100, A102, A130, A130A, A130B, A140, MF100, MF102, MF130, and MF140) may be incorporated into an electronic device that accepts speech input in order to control certain operations, or may otherwise benefit from separation of desired noises from background noises, such as communications devices. Many applications may benefit from enhancing or separating clear desired sound from background sounds originating from multiple directions. Such applications may include human-machine interfaces in electronic or computing devices which incorporate capabilities such as voice recognition and detection, speech enhancement and separation, voice-activated control, and the like. It may be desirable to implement such an acoustic signal processing apparatus to be suitable in devices that only provide limited processing capabilities.

The elements of the various implementations of the modules, elements, and devices described herein may be fabricated as electronic and/or optical devices residing, for example, on the same chip or among two or more chips in a chipset. One example of such a device is a fixed or programmable array of logic elements, such as transistors or gates. One or more elements of the various implementations of the apparatus described herein may also be implemented in whole or in part as one or more sets of instructions arranged to execute on one or more fixed or programmable arrays of logic elements such as microprocessors, embedded processors, IP cores, digital signal processors, FPGAs, ASSPs, and ASICs.

It is possible for one or more elements of an implementation of an apparatus as described herein to be used to perform tasks or execute other sets of instructions that are not directly related to an operation of the apparatus, such as a task relating to another operation of a device or system in which the apparatus is embedded. It is also possible for one or more elements of an implementation of such an apparatus to have structure in common (e.g., a processor used to execute portions of code corresponding to different elements at different times, a set of instructions executed to perform tasks corresponding to different elements at different times, or an arrangement of electronic and/or optical devices performing operations for different elements at different times).

What is claimed is:

1. A method of signal processing, said method comprising:
determining a frequency profile of a source signal;
based on said frequency profile of the source signal, producing a masking signal according to a masking frequency profile, wherein the masking frequency profile is different than the frequency profile of the source signal; and
producing a sound field comprising (A) a source component that is based on the source signal and (B) a masking component that is based on the masking signal.

2. The method according to claim 1, wherein said determining the frequency profile of the source signal includes calculating a first level of the source signal at a first frequency and a second level of the source signal at a second frequency, and
wherein said producing the masking signal is based on said calculated first and second levels.

3. The method according to claim 2, wherein said first level is less than said second level, and wherein a level of the masking signal at the first frequency is greater than a level of the masking signal at the second frequency.

4. The method according to claim 1, wherein said masking frequency profile comprises a masking target level for each of a plurality of different frequencies, based on the frequency profile of the source signal, and
wherein the masking signal is based on said masking target levels.

5. The method according to claim 4, wherein at least one of said masking target levels for a frequency among said plurality of different frequencies is based on at least one of said masking target levels for another frequency among said plurality of different frequencies.

6. The method according to claim 1, wherein said producing the masking signal comprises, for each of a plurality of frames of the masking signal, generating the frame based on a frame energy of a corresponding frame of the source signal.

7. The method according to claim 1, wherein said method comprises determining a first frame energy of a first frame of the source signal and a second frame energy of a second frame of the source signal, wherein said first frame energy is less than said second frame energy, and
wherein said producing the masking signal comprises, based on said determined first and second frame energies:
generating a first frame of the masking signal that corresponds in time to said first frame of the source signal and has a third frame energy; and
generating a second frame of the masking signal that corresponds in time to said second frame of the source signal and has a fourth frame energy that is greater than said third frame energy.

8. The method according to claim 1, wherein each of a plurality of frequency subbands of the masking signal is based on a corresponding masking threshold among a plurality of masking thresholds.

9. The method according to claim 1, wherein said source signal is based on a far-end voice communications signal.

10. The method according to claim 1, wherein said producing the sound field comprises driving a directionally controllable transducer to produce the sound field, and
wherein energy of the source component is concentrated along a source direction relative to an axis of the transducer, and
wherein energy of the masking component is concentrated along a leakage direction, relative to the axis, that is different than the source direction.

11. The method according to claim 10, wherein the masking component is based on information from a recording of a second sound field produced by a second directionally controllable transducer.

12. The method according to claim 11, wherein the masking signal is based on an estimated intensity of the source component in the leakage direction, and
wherein said estimated intensity is based on said information from the recording.

13. The method according to claim 11, wherein an intensity of the second sound field is higher in the source direction relative to an axis of the second directionally controllable transducer than in the leakage direction relative to the axis of the second directionally controllable transducer, and
wherein said information from the recording is based on an intensity of the second sound field in the leakage direction.

14. The method according to claim 10, wherein said method comprises applying a spatially directive filter to the source signal to produce a multichannel source signal, and
wherein said source component is based on said multichannel source signal, and
wherein the masking signal is based on an estimated intensity of the source component in the leakage direction, and
wherein said estimated intensity is based on coefficient values of the spatially directive filter.

15. The method according to claim 10, wherein said method comprises estimating a direction of a user relative to the directionally controllable transducer, and
wherein said source direction is based on said estimated user direction.

16. The method according to claim 10, wherein the masking component includes a null in the source direction.

17. The method according to claim 10, wherein said sound field comprises a second source component that is based on a second source signal, and
wherein an intensity of the second source component is higher in a second source direction relative to the axis than in the source direction or the leakage direction.

18. An apparatus for producing a sound field, said apparatus comprising:
means for determining a frequency profile of a source signal;
means for producing a masking signal, based on said frequency profile of the source signal, according to a masking frequency profile, wherein the masking frequency profile is different than the frequency profile of the source signal; and
means for producing the sound field comprising (A) a source component that is based on the source signal and (B) a masking component that is based on the masking signal.

19. The apparatus according to claim 18, wherein said means for determining the frequency profile of the source signal includes means for calculating a first level of the source signal at a first frequency and a second level of the source signal at a second frequency, and
wherein said producing the masking signal is based on said calculated first and second levels.

20. The apparatus according to claim 19, wherein said first level is less than said second level, and wherein a level of the masking signal at the first frequency is greater than a level of the masking signal at the second frequency.

21. The apparatus according to claim 18, wherein said masking frequency profile comprises a masking target level for each of a plurality of different frequencies, based on the frequency profile of the source signal, and
wherein the masking signal is based on said masking target levels.

22. The apparatus according to claim 21, wherein at least one of said masking target levels for a frequency among said plurality of different frequencies is based on at least one of said masking target levels for another frequency among said plurality of different frequencies.

23. The apparatus according to claim 18, wherein said producing the masking signal comprises, for each of a plurality of frames of the masking signal, generating the frame based on a frame energy of a corresponding frame of the source signal.

24. The apparatus according to claim 18, wherein said apparatus comprises means for determining a first frame energy of a first frame of the source signal and a second frame energy of a second frame of the source signal, wherein said first frame energy is less than said second frame energy, and
wherein said producing the masking signal comprises, based on said determined first and second frame energies:
generating a first frame of the masking signal that corresponds in time to said first frame of the source signal and has a third frame energy; and
generating a second frame of the masking signal that corresponds in time to said second frame of the source signal and has a fourth frame energy that is greater than said third frame energy.

25. The apparatus according to claim 18, wherein each of a plurality of frequency subbands of the masking signal is based on a corresponding masking threshold among a plurality of masking thresholds.

26. The apparatus according to claim 18, wherein said source signal is based on a far-end voice communications signal.

27. The apparatus according to claim 18, wherein said means for producing the sound field comprises means for driving a directionally controllable transducer to produce the sound field, and
wherein energy of the source component is concentrated along a source direction relative to an axis of the transducer, and
wherein energy of the masking component is concentrated along a leakage direction, relative to the axis, that is different than the source direction.

28. The apparatus according to claim 27, wherein the masking component is based on information from a recording of a second sound field produced by a second directionally controllable transducer.

29. The apparatus according to claim 28, wherein the masking signal is based on an estimated intensity of the source component in the leakage direction, and
wherein said estimated intensity is based on said information from the recording.

30. The apparatus according to claim 28, wherein an intensity of the second sound field is higher in the source direction relative to an axis of the second directionally controllable transducer than in the leakage direction relative to the axis of the second directionally controllable transducer, and
wherein said information from the recording is based on an intensity of the second sound field in the leakage direction.

31. The apparatus according to claim 27, wherein said apparatus comprises means for applying a spatially directive filter to the source signal to produce a multichannel source signal, and
wherein said source component is based on said multichannel source signal, and
wherein the masking signal is based on an estimated intensity of the source component in the leakage direction, and
wherein said estimated intensity is based on coefficient values of the spatially directive filter.

32. The apparatus according to claim 27, wherein said apparatus comprises means for estimating a direction of a user relative to the directionally controllable transducer, and
wherein said source direction is based on said estimated user direction.

33. The apparatus according to claim 27, wherein the masking component includes a null in the source direction.

34. The apparatus according to claim 27, wherein said sound field comprises a second source component that is based on a second source signal, and
wherein an intensity of the second source component is higher in a second source direction relative to the axis than in the source direction or the leakage direction.

35. An apparatus for producing a sound field, said apparatus comprising:
a signal analyzer configured to determine a frequency profile of a source signal;
a signal generator configured to produce a masking signal, based on said frequency profile of the source signal, according to a masking frequency profile, wherein the masking frequency profile is different than the frequency profile of the source signal; and
an audio output stage configured to drive an array of loudspeakers to produce the sound field, wherein the sound field comprises (A) a source component that is based on the source signal and (B) a masking component that is based on the masking signal.

36. The apparatus according to claim 35, wherein said signal analyzer is configured to calculate a first level of the source signal at a first frequency and a second level of the source signal at a second frequency, and
wherein said signal generator is configured to produce the masking signal based on said calculated first and second levels, and
wherein said first level is less than said second level, and wherein a level of the masking signal at the first frequency is greater than a level of the masking signal at the second frequency.

37. The apparatus according to claim 35, wherein said masking frequency profile comprises a masking target level for each of a plurality of different frequencies, based on the frequency profile of the source signal, and
wherein the masking signal is based on said masking target levels.

38. The apparatus according to claim 37, wherein at least one of said masking target levels for a frequency among said plurality of different frequencies is based on at least one of said masking target levels for another frequency among said plurality of different frequencies.

39. The apparatus according to claim 35, wherein said signal analyzer is configured to determine a first frame energy of a first frame of the source signal and a second frame energy of a second frame of the source signal, wherein said first frame energy is less than said second frame energy, and
wherein said producing the masking signal comprises, based on said determined first and second frame energies:
generating a first frame of the masking signal that corresponds in time to said first frame of the source signal and has a third frame energy; and
generating a second frame of the masking signal that corresponds in time to said second frame of the source signal and has a fourth frame energy that is greater than said third frame energy.

40. The apparatus according to claim 35, wherein said audio output stage is configured to drive a directionally controllable transducer to produce the sound field, and
wherein energy of the source component is concentrated along a source direction relative to an axis of the transducer, and
wherein energy of the masking component is concentrated along a leakage direction, relative to the axis, that is different than the source direction.

41. The apparatus according to claim 40, wherein said apparatus comprises a spatially directive filter configured to filter the source signal to produce a multichannel source signal, and
wherein said source component is based on said multichannel source signal, and
wherein the masking signal is based on an estimated intensity of the source component in the leakage direction, and
wherein said estimated intensity is based on coefficient values of the spatially directive filter.

42. A non-transitory computer-readable data storage medium having tangible features that cause a machine reading the features to:
determine a frequency profile of a source signal;
produce, based on said frequency profile of the source signal, a masking signal according to a masking frequency profile, wherein the masking frequency profile is different than the frequency profile of the source signal; and
produce a sound field comprising (A) a source component that is based on the source signal and (B) a masking component that is based on the masking signal.

43. A method of signal processing, said method comprising:
producing a multichannel source signal that is based on a source signal;
producing a masking signal that is based on a noise signal; and
driving a first directionally controllable transducer, in response to the multichannel source and masking signals, to produce a sound field comprising (A) a source component that is based on the multichannel source signal and (B) a masking component that is based on the masking signal,
wherein said producing the masking signal is based on information from a recording of a second sound field produced by a second directionally controllable transducer.

44. The method according to claim 43, wherein said recording of the second sound field is performed offline.

45. The method according to claim 44, wherein the masking signal is based on an estimated intensity of the source component in a leakage direction relative to an axis of the first directionally controllable transducer, and
wherein said estimated intensity is based on said information from the recording.

46. The method according to claim 45, wherein an intensity of the second sound field is higher in a source direction relative to an axis of the second directionally controllable transducer than in a leakage direction relative to the axis of the second directionally controllable transducer, and
wherein said information from the recording is based on an intensity of the second sound field in the leakage direction relative to the axis of the second directionally controllable transducer.

47. The method according to claim 44, wherein the first directionally controllable transducer comprises a first array of loudspeakers and the second directionally controllable transducer comprises a second array of loudspeakers, and
wherein a total number of loudspeakers in the first array is equal to a total number of loudspeakers in the second array.

48. The method according to claim 43, wherein an intensity of the source component is higher in a source direction relative to an axis of the first directionally controllable transducer than in a leakage direction, relative to the axis, that is different than the source direction.

49. The method according to claim 48, wherein said producing the multichannel source signal comprises applying a spatially directive filter to the source signal, and
wherein the masking signal is based on an estimated intensity of the source component in the leakage direction, and
wherein said estimated intensity is based on coefficient values of the spatially directive filter.

50. The method according to claim 48, wherein said method comprises producing a second multichannel source signal that is based on a second source signal, and
wherein said sound field comprises a second source component that is based on the second multichannel source signal, and
wherein an intensity of the second source component is higher in a second source direction relative to the axis of the first directionally controllable transducer than in the source direction or the leakage direction.

51. The method according to claim 43, wherein said method comprises estimating a direction of a user relative to the first directionally controllable transducer, and
wherein a source direction is based on said estimated user direction.

52. The method according to claim 43, wherein said source signal is based on a far-end voice communications signal.

53. An apparatus for signal processing, said apparatus comprising:
means for producing a multichannel source signal that is based on a source signal;
means for producing a masking signal that is based on a noise signal; and
means for driving a first directionally controllable transducer, in response to the multichannel source and masking signals, to produce the sound field comprising (A) a source component that is based on the multichannel source signal and (B) a masking component that is based on the masking signal,
wherein said producing the masking signal is based on information from a recording of a second sound field produced by a second directionally controllable transducer.

54. An apparatus for signal processing, said apparatus comprising:
a first spatially directive filter configured to produce a multichannel source signal that is based on a source signal;
a second spatially directive filter configured to produce a masking signal that is based on a noise signal; and
an audio output stage configured to drive a first directionally controllable transducer, in response to multichannel source and masking signals, to produce a sound field comprising (A) a source component that is based on the multichannel source signal and (B) a masking component that is based on the masking signal,
wherein said producing the masking signal is based on information from a recording of a second sound field produced by a second directionally controllable transducer.

55. A non-transitory computer-readable data storage medium having tangible features that cause a machine reading the features to:
produce a multichannel source signal that is based on a source signal;
produce a masking signal that is based on a noise signal; and
drive a first directionally controllable transducer, in response to the multichannel source and masking signals, to produce a sound field comprising (A) a source component that is based on the multichannel source signal and (B) a masking component that is based on the masking signal.
